(19) United States
(12) Patent Application Publication
(10) Pub. No.: US 2023/0189308 A1
(43) Pub. Date: Jun. 15, 2023

(54) METHOD, APPARATUS, AND SYSTEM FOR INITIAL CELL ACCESS IN WIRELESS COMMUNICATION SYSTEM

(71) Applicant: WILUS INSTITUTE OF STANDARDS AND TECHNOLOGY INC., Gyeonggi-do (KR)

(72) Inventors: Kyungjun CHOI, Gyeonggi-do (KR); Minseok NOH, Seoul (KR); Geunyoung SEOK, Seoul (KR); Jinsam KWAK, Gyeonggi-do (KR); Juhyung SON, Gyeonggi-do (KR)

(21) Appl. No.: 18/105,812

(22) Filed: Feb. 4, 2023

Related U.S. Application Data
(63) Continuation of application No. PCT/KR2021/010309, filed on Aug. 4, 2021.

(30) Foreign Application Priority Data
Aug. 4, 2020 (KR) 10-2020-0097565
Jan. 13, 2021 (KR) 10-2021-0004712
Feb. 24, 2021 (KR) 10-2021-0025078
May 21, 2021 (KR) 10-2021-0065841

(51) Int. Cl. H04W 72/51; H04W 72/1273

(52) U.S. Cl. CPC H04W 72/51; H04W 72/1273

(57) ABSTRACT

The present specification relates to a method, apparatus, and system for initial cell access in a wireless communication system. The present specification discloses reduced capability user equipment (UE) comprising: a communication module configured to receive configuration information for configuring a first downlink bandwidth part (DL BWP) and a first uplink bandwidth part (BWP) to be used for an initial access procedure, receive an indicator indicating BWP access barring of first user equipment in a second UL BWP and a second DL BWP for legacy-type second user equipment, and perform, on the basis of the indicator, the initial access procedure via at least one of the first DL BWP, the first UL BWP, the second DL BWP, and the second UL BWP; and a processor that controls the reception of the configuration information, the performance of the initial access procedure, and the reception of the indicator. The RedCap user equipment may smoothly perform the initial cell access, may perform a random access procedure without a collision with existing legacy-type user equipment, and may perform communication on the basis of various types of frequency hopping designs.

### TECHNICAL FIELD

The present disclosure relates to a wireless communication system, specifically, an initial cell access method, apparatus, and system in a wireless communication system, and an apparatus using the same.

### BACKGROUND ART

After commercialization of 4th generation (4G) communication system, in order to meet the increasing demand for wireless data traffic, efforts are being made to develop new 5th generation (5G) communication systems. The 5G communication system is called as a beyond 4G network communication system, a post LTE system, or a new radio (NR) system. In order to achieve a high data transfer rate, 5G communication systems include systems operated using the millimeter wave (mmWave) band of 6 GHz or more, and include a communication system operated using a frequency band of 6 GHz or less in terms of ensuring coverage so that implementations in base stations and terminals are under consideration.

A 3rd generation partnership project (3GPP) NR system enhances spectral efficiency of a network and enables a communication provider to provide more data and voice services over a given bandwidth. Accordingly, the 3GPP NR system is designed to meet the demands for high-speed data and media transmission in addition to supports for large volumes of voice. The advantages of the NR system are to have a higher throughput and a lower latency in an identical platform, support for frequency division duplex (FDD) and time division duplex (TDD), and a low operation cost with an enhanced end-user environment and a simple architecture.

For more efficient data processing, dynamic TDD of the NR system may use a method for varying the number of orthogonal frequency division multiplexing (OFDM) symbols that may be used in an uplink and downlink according to data traffic directions of cell users. For example, when the downlink traffic of the cell is larger than the uplink traffic, the base station may allocate a plurality of downlink OFDM symbols to a slot (or subframe). Information about the slot configuration should be transmitted to the terminals.

In order to alleviate the path loss of radio waves and increase the transmission distance of radio waves in the mmWave band, in 5G communication systems, beamforming, massive multiple input/output (massive MIMO), full dimensional MIMO (FD-MIMO), array antenna, analog beam-forming, hybrid beamforming that combines analog beamforming and digital beamforming, and large scale antenna technologies are discussed. In addition, for network improvement of the system, in the 5G communication system, technology developments related to evolved small cells, advanced small cells, cloud radio access network (cloud RAN), ultra-dense network, device to device communication (D2D), vehicle to everything communication (V2X), wireless backhaul, non-terrestrial network communication (NTN), moving network, cooperative communication, coordinated multi-points (CoMP), interference cancellation, and the like are being made. In addition, in the 5G system, hybrid FSK and QAM modulation (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced connectivity technologies, are being developed.

In a human-centric connection network where humans generate and consume information, the Internet has evolved into the Internet of Things (IoT) network, which exchanges information among distributed components such as objects. Internet of Everything (IoE) technology, which combines IoT technology with big data processing technology through connection with cloud servers, is also emerging. In order to implement IoT, technology elements such as sensing technology, wired/wireless communication and network infrastructure, service interface technology, and security technology are required, so that in recent years, technologies such as sensor network, machine to machine (M2M), and machine type communication (MTC) have been studied for connection between objects. In the IoT environment, an intelligent internet technology (IT) service that collects and analyzes data generated from connected objects to create new value in human life can be provided. Through the fusion and mixture of existing information technology (IT) and various industries, IoT can be applied to fields such as smart home, smart building, smart city, smart car or connected car, smart grid, healthcare, smart home appliance, and advanced medical service.

Various attempts have been made to apply 5G communication systems to IoT networks. For example, technologies, such as sensor networks, machine-to-machine (M2M) communication, and machine-type communication (MTC), are implemented by techniques, such as beamforming, MIMO, and array antennas, which are 5G communication technologies. Application of a cloud radio access network (cloud RAN) as the big data processing technology described above may also be considered as an example of convergence of 5G technology and IoT technology. In general, mobile communication systems have been developed to provide voice services while ensuring user activity.

In a 3GPP study on “self-evaluation towards IMT-2020 submission”, it was identified that NB IoT and LTE M satisfy IMT-2020 requirements for mMTC, so that NB IoT and LTE M can be certified as 5G technology. For URLLC support, URLLC functions have been introduced in Rel-15 for both LTE and NR, and URLLC (enhanced URLLC (eURLLC)) improved in Rel-16 and URLLC of NR systems in industrial IoT work items have been further advanced. Rel-16 has also introduced 5G integrated support and time-sensitive networking (TSN) for TSC use.

One of overarching goals of 5G is to enable connected industries. 5G connectivity serves as a catalyst for next generation industrial innovation and digitization so as to improve flexibility, improve productivity and efficiency, reduce maintenance costs, and improve operational safety. For devices in this environment, it is desirable to connect, for example, a pressure sensor, a humidity sensor, a thermometer, a motion sensor, an accelerometer, and an actuator, to 5G radio access and core networks. Use cases and requirements of large-scale industrial wireless sensor networks include URLLC services with very high requirements, as well as relatively inexpensive services with small device format requirements. These services should be available wirelessly for years by using a battery. Examples of the services include industrial wireless sensors, video surveillance and wearable devices, and the like. These services have requirements higher than those of low power wide area (LPWA) (i.e., LTE-M/NB-IoT) but lower than URLLC and eMBB.

### DISCLOSURE OF INVENTION

### Technical Problem

A technical task of the present disclosure is to provide an initial cell access method and device in a wireless communication system, particularly, in a cellular wireless communication system.

Another technical task of the present disclosure is to provide a method and device for frequency hopping for uplink data transmission in a wireless communication system, particularly, in a cellular wireless communication system.

### Solution to Problem

According to an aspect of the present disclosure, a first UE (reduced capability UE) with reduced performance is provided in a wireless communication system. The first UE may include: a communication module configured to receive configuration information for configuration of a first downlink bandwidth part (DL BWP) and a first uplink bandwidth part (uplink BWP) which are used in an initial access procedure, receive an indicator indicating BWP access barring of the first UE in a second UL BWP and a second DL BWP for a second UE of a legacy type, and perform the initial access procedure based on the indicator via at least one of the first DL BWP, the first UL BWP, the second DL BWP, and the second UL BWP; and a processor configured to control the receiving of the configuration information, the performing of the initial access procedure, and the receiving of the indicator, wherein each of the first UL BWP and the second UL BWP is individually configured, the initial access procedure includes a random-access procedure, the first UL BWP includes a first resource for the random-access procedure of the first UE, and the first resource is the same as a second resource for a random-access procedure on the second UL BWP of the second UE.

In an aspect, the communication module may be configured to acquire information on a basic control resource set (CORESET) from a second synchronization signal block (SSB) relating to the second UE.

In another aspect, the communication module may be configured to receive, via a system information block (system information block 1 (SIB1)), information on a CORESET for the first UE, which is defined separately from the CORESET for the second UE.

In another aspect, the communication module may be configured to receive SIB1 for the second UE, wherein the SIB1 includes scheduling information on system information for performing of the initial access procedure of the first UE.

In another aspect, the scheduling information may include information on a starting physical resource block (PRB) of the first DL BWP activated for performing of the initial access procedure of the first UE.

In another aspect, the communication module may be configured to receive SIB1 for the second UE, wherein the SIB1 includes configuration information for the random-access procedure for initial access of the first UE.

In another aspect, the communication module may be configured to acquire information on a CORESET for the first UE via a first SSB defined separately from a second SSB relating to the second UE.

In another aspect, the information on the basic CORESET may include 8 bits, 4 bits of the information on the basic CORESET may indicate information on a frequency domain in which the basic CORESET is configured, and the remaining 4 bits may indicate information on a symbol for monitoring of the basic CORESET.

In another aspect, 8 bits constituting the information on the basic CORESET may be recognized as different information by each of the first UE and the second UE.

In another aspect, the communication module may receive information indicating the first resource for the first UE from a base station.

In another aspect, some of random-access preamble sequences available in a cell provided by a base station may be used for the first UE, and the remaining random-access preamble sequences may be used for the second UE.

In another aspect, the communication module may acquire information on a CORESET for the first UE, based on the information on the basic CORESET.

In another aspect, a first PDCCH candidate for the first UE may be defined separately from a second PDCCH candidate for the second UE in the basic CORESET, and the communication module may be configured to monitor the first PDCCH candidate in the basic CORESET.

According to another aspect of the present disclosure, an operation method of a first UE (reduced capability UE) with reduced performance in a wireless communication system is provided. The method may include: receiving configuration information for configuration of a first downlink bandwidth part (DL BWP) and a first uplink bandwidth part (uplink BWP) which are used in an initial access procedure; receiving an indicator indicating BWP access barring of the first UE in a second UL BWP and a second DL BWP for a second UE of a legacy type; and performing the initial access procedure based on the indicator via at least one of the first DL BWP, the first UL BWP, the second DL BWP, and the second UL BWP. Here, each of the first UL BWP and the second UL BWP may be individually configured, the initial access procedure may include a random-access procedure, the first UL BWP may include a first resource for the random-access procedure of the first UE, and the first resource may be the same as a second resource for a random-access procedure on the second UL BWP of the second UE.

In an aspect, the method may further include acquiring information on a basic control resource set (CORESET) from a second synchronization signal block (SSB) relating to the second UE.

In another aspect, the method may further include receiving, via a system information block (system information block 1 (SIB1)), information on a CORESET for the first UE, which is defined separately from the CORESET for the second UE.

In another aspect, the method may further include receiving SIB1 for the second UE, wherein the SIB1 includes scheduling information on system information for performing of the initial access procedure of the first UE.

In another aspect, the scheduling information may include information on a start physical resource block (PRB) of the first DL BWP activated for performing of the initial access procedure of the first UE.

In another aspect, the method may further include receiving SIB1 for the second UE, wherein the SIB1 includes configuration information for the random-access procedure for initial access of the first UE.

In another aspect, information on a CORESET for the first UE may be acquired via a first SSB defined separately from a second SSB relating to the second UE.

### Advantageous Effects of Invention

According to an embodiment of the present disclosure, a RedCap UE can smoothly perform an initial cell access, perform a random-access procedure without collision with an existing legacy type UE, and perform communication based on various frequency hopping designs.

The effects obtainable in the present disclosure are not limited to the above-mentioned effects, and other effects that are not mentioned may be clearly understood by those skilled in the art to which the present disclosure belongs, from descriptions below.

### BRIEF DESCRIPTION OF DRAWINGS

FIG. 1 illustrates an example of a wireless frame structure used in a wireless communication system.

FIG. 2 illustrates an example of a downlink (DL)/uplink (UL) slot structure in a wireless communication system.

FIG. 3 is a diagram for explaining a physical channel used in a 3GPP system and a typical signal transmission method using the physical channel.

FIGS. 4A and 4B illustrate an SS/PBCH block for initial cell access in a 3GPP NR system.

FIGS. 5A and 5B illustrate a procedure for transmitting control information and a control channel in a 3GPP NR system.

FIG. 6 illustrates a control resource set (CORESET) in which a physical downlink control channel (PUCCH) may be transmitted in a 3GPP NR system.

FIG. 7 illustrates a method for configuring a PDCCH search space in a 3GPP NR system.

FIG. 8 is a conceptual diagram illustrating carrier aggregation.

FIG. 9 is a diagram for explaining single carrier communication and multiple carrier communication.

FIG. 10 is a diagram showing an example in which a cross carrier scheduling technique is applied.

FIG. 11 is a block diagram showing the configurations of a UE and a base station according to an embodiment of the present disclosure.

FIG. 12 illustrates an initial access method according to an example;

FIG. 13 is a diagram illustrating an initial cell access method according to an embodiment of the present disclosure;

FIG. 14 is a diagram illustrating an initial cell access method and a PRACH resource configuration according to an embodiment of the present disclosure;

FIG. 15 is a diagram illustrating an initial cell access method and a PRACH resource configuration according to another embodiment of the present disclosure;

FIG. 16 is a diagram illustrating an initial cell access method and a PRACH resource configuration according to another embodiment of the present disclosure;

FIG. 17 is a diagram illustrating an initial cell access method according to another embodiment of the present disclosure;

FIG. 18 is a diagram illustrating an initial cell access method according to another embodiment of the present disclosure;

FIG. 19 is a diagram illustrating an initial cell access method according to another embodiment of the present disclosure;

FIG. 20 is a diagram illustrating an initial cell access method according to another embodiment of the present disclosure;

FIG. 21 is a diagram illustrating an initial cell access method according to another embodiment of the present disclosure;

FIG. 22 shows diagrams illustrating PRACH resource configurations according to another embodiment of the present disclosure;

FIG. 23 shows diagrams illustrating scheduling of a physical uplink shared channel in the time domain;

FIG. 24 shows diagrams illustrating scheduling of a physical uplink shared channel in the frequency domain;

FIG. 25 shows diagrams illustrating repetitive transmission of a physical uplink shared channel according to an example;

FIG. 26 is a diagram illustrating scheduling of a physical uplink control channel;

FIG. 27 is a diagram illustrating repetitive transmission of a physical uplink control channel;

FIG. 28 is a diagram illustrating frequency hopping;

FIG. 29 is a diagram illustrating wide-band frequency hopping;

FIG. 30 is a diagram illustrating wide-band frequency hopping according to an embodiment of the present disclosure;

FIG. 31 is a diagram illustrating wide-band frequency hopping according to another embodiment of the present disclosure;

FIG. 32 is a diagram illustrating wide-band frequency hopping according to another embodiment of the present disclosure;

FIG. 33 is a diagram illustrating wide-band frequency hopping according to an embodiment of the present disclosure;

FIG. 34 illustrates PUSCH repetition type B according to an example;

FIG. 35 shows diagrams illustrating gap symbols being arranged in preceding nominal repetitions in type-B PUSCH repetition according to an embodiment of the present disclosure;

FIG. 36 shows diagrams illustrating gap symbols being arranged in subsequent nominal repetitions in type-B PUSCH repetition according to an embodiment of the present disclosure;

FIG. 37 is a diagram illustrating gap symbols being distributedly arranged in type-B PUSCH repetition according to an embodiment of the present disclosure;

FIG. 38 shows diagrams illustrating gap symbols being arranged in nominal repetition having a large number of symbols in type-B PUSCH repetition according to an embodiment of the present disclosure;

FIG. 39 shows diagrams illustrating gap symbols being arranged in nominal repetition having a small number of symbols in type-B PUSCH repetition according to an embodiment of the present disclosure;

FIG. 40 shows diagrams illustrating arrangement of gap symbols so that an orphan symbol does not occur in type-B PUSCH repetition according to an embodiment of the present disclosure;

FIG. 41 shows diagrams illustrating adding a gap symbol after nominal repetition in type-B PUSCH repetition according to an embodiment of the present disclosure; and

FIG. 42 shows diagrams illustrating a gap symbol in consideration of an invalid UL symbol and an orphan symbol in type-B PUSCH repetition according to an embodiment of the present disclosure.

### BEST MODE FOR CARRYING OUT THE INVENTION

Terms used in the specification adopt general terms which are currently widely used as possible by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the disclosure. Accordingly, it intends to be revealed that a term used in the specification should be analyzed based on not just a name of the term but a substantial meaning of the term and contents throughout the specification.

Throughout this specification and the claims that follow, when it is described that an element is “connected” to another element, the element may be “directly connected” to the other element or “electrically connected” to the other element through a third element. Further, unless explicitly described to the contrary, the word “comprise” will be understood to imply the inclusion of stated elements but not the exclusion of any other elements unless otherwise stated. Moreover, limitations such as “more than or equal to” or “less than or equal to” based on a specific threshold may be appropriately substituted with “more than” or “less than”, respectively, in some exemplary embodiments.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a wireless technology such as universal terrestrial radio access (UTRA) or CDMA2000. The TDMA may be implemented by a wireless technology such as global system for mobile communications (GSM)/general packet radio service (GPRS)/enhanced data rates for GSM evolution (EDGE). The OFDMA may be implemented by a wireless technology such as IEEE 802.11 (Wi-Fi), IEEE 802.16 (WiMAX), IEEE 802-20, evolved UTRA (E-UTRA), and the like. The UTRA is a part of a universal mobile telecommunication system (UMTS). 3rd generation partnership project (3GPP) long term evolution (LTE) is a part of an evolved UMTS (E-UMTS) using evolved-UMTS terrestrial radio access (E-UTRA) and LTE-advanced (A) is an evolved version of the 3GPP LTE. 3GPP new radio (NR) is a system designed separately from LTE/LTE-A, and is a system for supporting enhanced mobile broadband (eMBB), ultra-reliable and low latency communication (URLLC), and massive machine type communication (mMTC) services, which are requirements of IMT-2020. For the clear description, 3GPP NR is mainly described, but the technical idea of the present disclosure is not limited thereto.

Unless otherwise specified herein, the base station may include a next generation node B (gNB) defined in 3GPP NR. Furthermore, unless otherwise specified, a terminal may include a user equipment (UE).

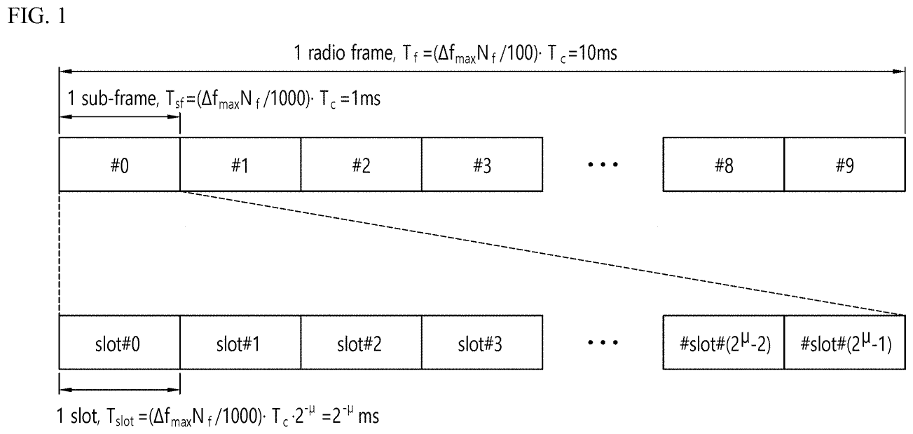

FIG. 1 illustrates an example of a wireless frame structure used in a wireless communication system. Referring to FIG. 1, the wireless frame (or radio frame) used in the 3GPP NR system may have a length of 10 ms (ΔfmaxNf/100)*Tc). In addition, the wireless frame includes 10 subframes (SFs) having equal sizes. Herein, Δfmax=480*103 Hz, Nf=4096, Tc=1/(Δfref*Nf,ref), Δfref=15*103 Hz, and Nf,ref=2048. Numbers from 0 to 9 may be respectively allocated to 10 subframes within one wireless frame. Each subframe has a length of 1 ms and may include one or more slots according to a subcarrier spacing. More specifically, in the 3GPP NR system, the subcarrier spacing that may be used is 15*2μ kHz, and μ can have a value of μ=0, 1, 2, 3, 4 as subcarrier spacing configuration. That is, 15 kHz, 30 kHz, 60 kHz, 120 kHz and 240 kHz may be used for subcarrier spacing. One subframe having a length of 1 ms may include 2μ slots. In this case, the length of each slot is 2-μ, ms. Numbers from 0 to 2μ−1 may be respectively allocated to 2μ slots within one wireless frame. In addition, numbers from 0 to 10*2μ−1 may be respectively allocated to slots within one subframe. The time resource may be distinguished by at least one of a wireless frame number (also referred to as a wireless frame index), a subframe number (also referred to as a subframe index), and a slot number (or a slot index).

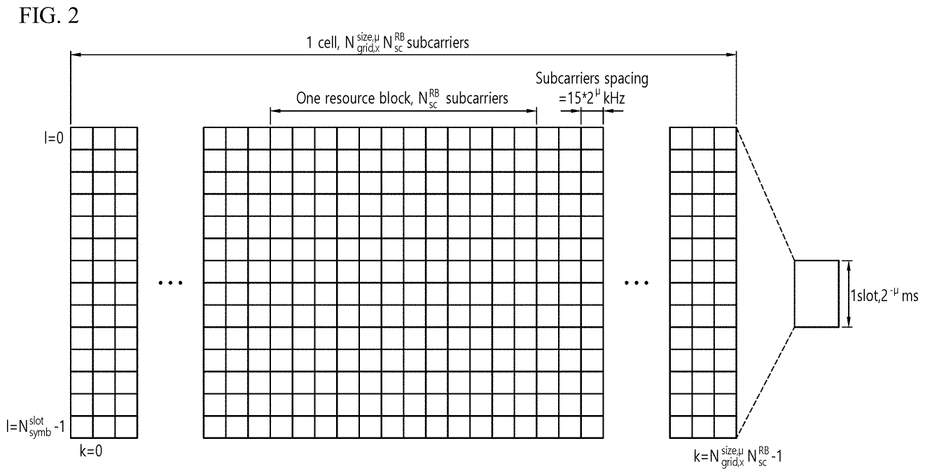

FIG. 2 illustrates an example of a downlink (DL)/uplink (UL) slot structure in a wireless communication system. In particular, FIG. 2 shows the structure of the resource grid of the 3GPP NR system. There is one resource grid per antenna port. Referring to FIG. 2, a slot includes a plurality of orthogonal frequency division multiplexing (OFDM) symbols in a time domain and includes a plurality of resource blocks (RBs) in a frequency domain. An OFDM symbol also means one symbol section. Unless otherwise specified, OFDM symbols may be referred to simply as symbols. One RB includes 12 consecutive subcarriers in the frequency domain. Referring to FIG. 2, a signal transmitted from each slot may be represented by a resource grid including Nsize,μgrid,x*NRBsc subcarriers, and Nslotsymb OFDM symbols. Here, x=DL when the signal is a DL signal, and x=UL when the signal is an UL signal. Nsize,μgrid,x represents the number of resource blocks (RBs) according to the subcarrier spacing constituent μ (x is DL or UL), and Nslotsymb represents the number of OFDM symbols in a slot. NRBsc is the number of subcarriers constituting one RB and NRBsc=12. An OFDM symbol may be referred to as a cyclic shift OFDM (CP-OFDM) symbol or a discrete Fourier transform spread OFDM (DFT-s-OFDM) symbol according to a multiple access scheme.

The number of OFDM symbols included in one slot may vary according to the length of a cyclic prefix (CP). For example, in the case of a normal CP, one slot includes 14 OFDM symbols, but in the case of an extended CP, one slot may include 12 OFDM symbols. In a specific embodiment, the extended CP can only be used at 60 kHz subcarrier spacing. In FIG. 2, for convenience of description, one slot is configured with 14 OFDM symbols by way of example, but embodiments of the present disclosure may be applied in a similar manner to a slot having a different number of OFDM symbols. Referring to FIG. 2, each OFDM symbol includes Nsize,μgrid,x*NRBsc subcarriers in the frequency domain. The type of subcarrier may be divided into a data subcarrier for data transmission, a reference signal subcarrier for transmission of a reference signal, and a guard band. The carrier frequency is also referred to as the center frequency (fc).

One RB may be defined by NRBsc (e. g., 12) consecutive subcarriers in the frequency domain. For reference, a resource configured with one OFDM symbol and one subcarrier may be referred to as a resource element (RE) or a tone. Therefore, one RB can be configured with Nslotsymb*NRBsc resource elements. Each resource element in the resource grid can be uniquely defined by a pair of indexes (k, 1) in one slot. k may be an index assigned from 0 to Nsize,μgrid, x*NRBsc−1 in the frequency domain, and 1 may be an index assigned from 0 to Nslotsymb−1 in the time domain.

In order for the UE to receive a signal from the base station or to transmit a signal to the base station, the time/frequency of the UE may be synchronized with the time/frequency of the base station. This is because when the base station and the UE are synchronized, the UE can determine the time and frequency parameters necessary for demodulating the DL signal and transmitting the UL signal at the correct time.

Each symbol of a radio frame used in a time division duplex (TDD) or an unpaired spectrum may be configured with at least one of a DL symbol, an UL symbol, and a flexible symbol. A radio frame used as a DL carrier in a frequency division duplex (FDD) or a paired spectrum may be configured with a DL symbol or a flexible symbol, and a radio frame used as a UL carrier may be configured with a UL symbol or a flexible symbol. In the DL symbol, DL transmission is possible, but UL transmission is impossible. In the UL symbol, UL transmission is possible, but DL transmission is impossible. The flexible symbol may be determined to be used as a DL or an UL according to a signal.

Information on the type of each symbol, i.e., information representing any one of DL symbols, UL symbols, and flexible symbols, may be configured with a cell-specific or common radio resource control (RRC) signal. In addition, information on the type of each symbol may additionally be configured with a UE-specific or dedicated RRC signal. The base station informs, by using cell-specific RRC signals, i) the period of cell-specific slot configuration, ii) the number of slots with only DL symbols from the beginning of the period of cell-specific slot configuration, iii) the number of DL symbols from the first symbol of the slot immediately following the slot with only DL symbols, iv) the number of slots with only UL symbols from the end of the period of cell specific slot configuration, and v) the number of UL symbols from the last symbol of the slot immediately before the slot with only the UL symbol. Here, symbols not configured with any one of a UL symbol and a DL symbol are flexible symbols.

When the information on the symbol type is configured with the UE-specific RRC signal, the base station may signal whether the flexible symbol is a DL symbol or an UL symbol in the cell-specific RRC signal. In this case, the UE-specific RRC signal can not change a DL symbol or a UL symbol configured with the cell-specific RRC signal into another symbol type. The UE-specific RRC signal may signal the number of DL symbols among the Nslotsymb symbols of the corresponding slot for each slot, and the number of UL symbols among the Nslotsymb symbols of the corresponding slot. In this case, the DL symbol of the slot may be continuously configured with the first symbol to the i-th symbol of the slot. In addition, the UL symbol of the slot may be continuously configured with the j-th symbol to the last symbol of the slot (where i<j). In the slot, symbols not configured with any one of a UL symbol and a DL symbol are flexible symbols.

The type of symbol configured with the above RRC signal may be referred to as a semi-static DL/UL configuration. In the semi-static DL/UL configuration previously configured with RRC signals, the flexible symbol may be indicated as a DL symbol, an UL symbol, or a flexible symbol through dynamic slot format information (SFI) transmitted on a physical DL control channel (PDCCH). In this case, the DL symbol or UL symbol configured with the RRC signal is not changed to another symbol type. Table 1 exemplifies the dynamic SFI that the base station can indicate to the UE.

TABLE 1

| | Symbol number in a slot | | | | | | | | | | | | | | | Symbol number in a slot | | | | | | | | | | | | | |
|---|---|---|---|---|---|---|---|---|---|---|---|---|---|---|---|---|---|---|---|---|---|---|---|---|---|---|---|---|---|
| index | 0 | 1 | 2 | 3 | 4 | 5 | 6 | 7 | 8 | 9 | 10 | 11 | 12 | 13 | index | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D | 28 | D | D | D | D | D | D | D | D | D | D | D | D | X | U |
| 1 | U | U | U | U | U | U | U | U | U | U | U | U | U | U | 29 | D | D | D | D | D | D | D | D | D | D | D | X | X | U |
| 2 | X | X | X | X | X | X | X | X | X | X | X | X | X | X | 30 | D | D | D | D | D | D | D | D | D | D | X | X | X | U |
| 3 | D | D | D | D | D | D | D | D | D | D | D | D | D | X | 31 | D | D | D | D | D | D | D | D | D | D | D | X | U | U |
| 4 | D | D | D | D | D | D | D | D | D | D | D | D | X | X | 32 | D | D | D | D | D | D | D | D | D | D | X | X | U | U |
| 5 | D | D | D | D | D | D | D | D | D | D | D | X | X | X | 33 | D | D | D | D | D | D | D | D | D | X | X | X | U | U |
| 6 | D | D | D | D | D | D | D | D | D | D | X | X | X | X | 34 | D | X | U | U | U | U | U | U | U | U | U | U | U | U |
| 7 | D | D | D | D | D | D | D | D | D | X | X | X | X | X | 35 | D | D | X | U | U | U | U | U | U | U | U | U | U | U |
| 8 | X | X | X | X | X | X | X | X | X | X | X | X | X | U | 36 | D | D | D | X | U | U | U | U | U | U | U | U | U | U |
| 9 | X | X | X | X | X | X | X | X | X | X | X | X | U | U | 37 | D | X | X | U | U | U | U | U | U | U | U | U | U | U |
| 10 | X | U | U | U | U | U | U | U | U | U | U | U | U | U | 38 | D | D | X | X | U | U | U | U | U | U | U | U | U | U |
| 11 | X | X | U | U | U | U | U | U | U | U | U | U | U | U | 39 | D | D | D | X | X | U | U | U | U | U | U | U | U | U |
| 12 | X | X | X | U | U | U | U | U | U | U | U | U | U | U | 40 | D | X | X | X | U | U | U | U | U | U | U | U | U | U |
| 13 | X | X | X | X | U | U | U | U | U | U | U | U | U | U | 41 | D | D | X | X | X | U | U | U | U | U | U | U | U | U |
| 14 | X | X | X | X | X | U | U | U | U | U | U | U | U | U | 42 | D | D | D | X | X | X | U | U | U | U | U | U | U | U |
| 15 | X | X | X | X | X | X | U | U | U | U | U | U | U | U | 43 | D | D | D | D | D | D | D | D | D | X | X | X | X | U |
| 16 | D | X | X | X | X | X | X | X | X | X | X | X | X | X | 44 | D | D | D | D | D | D | X | X | X | X | X | X | U | U |
| 17 | D | D | X | X | X | X | X | X | X | X | X | X | X | X | 45 | D | D | D | D | D | D | X | X | U | U | U | U | U | U |
| 18 | D | D | D | X | X | X | X | X | X | X | X | X | X | X | 46 | D | D | D | D | D | X | U | D | D | D | D | D | X | U |
| 19 | D | X | X | X | X | X | X | X | X | X | X | X | X | U | 47 | D | D | X | U | U | U | U | D | D | X | U | U | U | U |
| 20 | D | D | X | X | X | X | X | X | X | X | X | X | X | U | 48 | D | X | U | U | U | U | U | D | X | U | U | U | U | U |
| 21 | D | D | D | X | X | X | X | X | X | X | X | X | X | U | 49 | D | D | D | D | X | X | U | D | D | D | D | X | X | U |
| 22 | D | X | X | X | X | X | X | X | X | X | X | X | U | U | 50 | D | D | X | X | U | U | U | D | D | X | X | U | U | U |
| 23 | D | D | X | X | X | X | X | X | X | X | X | X | U | U | 51 | D | X | X | U | U | U | U | D | X | X | U | U | U | U |
| 24 | D | D | D | X | X | X | X | X | X | X | X | X | U | U | 52 | D | X | X | X | X | X | U | D | X | X | X | X | X | U |
| 25 | D | X | X | X | X | X | X | X | X | X | X | U | U | U | 53 | D | D | X | X | X | X | U | D | D | X | X | X | X | U |
| 26 | D | D | X | X | X | X | X | X | X | X | X | U | U | U | 54 | X | X | X | X | X | X | X | D | D | D | D | D | D | D |
| 27 | D | D | D | X | X | X | X | X | X | X | X | U | U | U | 55 | D | D | X | X | X | U | U | U | D | D | D | D | D | D |

| | |
|---|---|
| 56~ | Reserved |
| 255 | |

In Table 1, D denotes a DL symbol, U denotes a UL symbol, and X denotes a flexible symbol. As shown in Table 1, up to two DL/UL switching in one slot may be allowed.

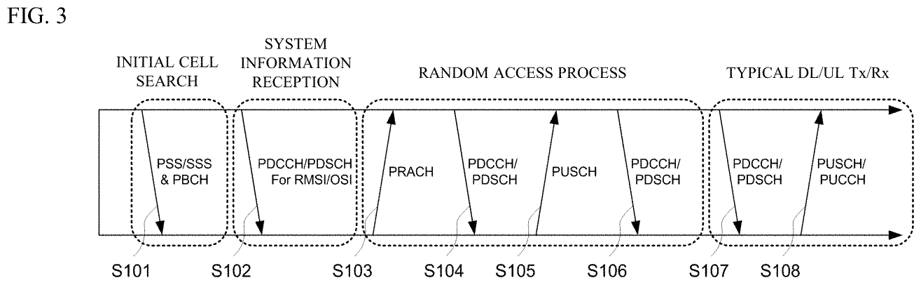

FIG. 3 is a diagram for explaining a physical channel used in a 3GPP system (e.g., NR) and a typical signal transmission method using the physical channel. If the power of the UE is turned on or the UE camps on a new cell, the UE performs an initial cell search (S101). Specifically, the UE may synchronize with the BS in the initial cell search. For this, the UE may receive a primary synchronization signal (PSS) and a secondary synchronization signal (SSS) from the base station to synchronize with the base station, and obtain information such as a cell ID. Thereafter, the UE can receive the physical broadcast channel from the base station and obtain the broadcast information in the cell.

Upon completion of the initial cell search, the UE receives a physical downlink shared channel (PDSCH) according to the physical downlink control channel (PDCCH) and information in the PDCCH, so that the UE can obtain more specific system information than the system information obtained through the initial cell search (S102).

When the UE initially accesses the base station or does not have radio resources for signal transmission (i.e. the UE at RRC IDLE mode), the UE may perform a random access procedure on the base station (operations S103 to S106). First, the UE can transmit a preamble through a physical random access channel (PRACH) (S103) and receive a response message for the preamble from the base station through the PDCCH and the corresponding PDSCH (S104). When a valid random access response message is received by the UE, the UE transmits data including the identifier of the UE and the like to the base station through a physical uplink shared channel (PUSCH) indicated by the UL grant transmitted through the PDCCH from the base station (S105). Next, the UE waits for reception of the PDCCH as an indication of the base station for collision resolution. If the UE successfully receives the PDCCH through the identifier of the UE (S106), the random access process is terminated.

After the above-described procedure, the UE receives PDCCH/PDSCH (S107) and transmits a physical uplink shared channel (PUSCH)/physical uplink control channel (PUCCH) (S108) as a general UL/DL signal transmission procedure. In particular, the UE may receive downlink control information (DCI) through the PDCCH. The DCI may include control information such as resource allocation information for the UE. Also, the format of the DCI may vary depending on the intended use. The uplink control information (UCI) that the UE transmits to the base station through UL includes a DL/UL ACK/NACK signal, a channel quality indicator (CQI), a precoding matrix index (PMI), a rank indicator (RI), and the like. Here, the CQI, PMI, and RI may be included in channel state information (CSI). In the 3GPP NR system, the UE may transmit control information such as HARQ-ACK and CSI described above through the PUSCH and/or PUCCH.

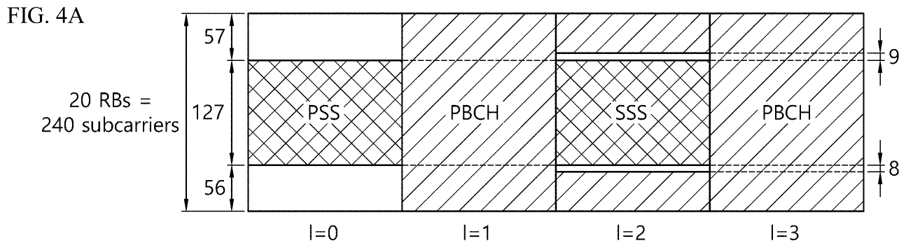

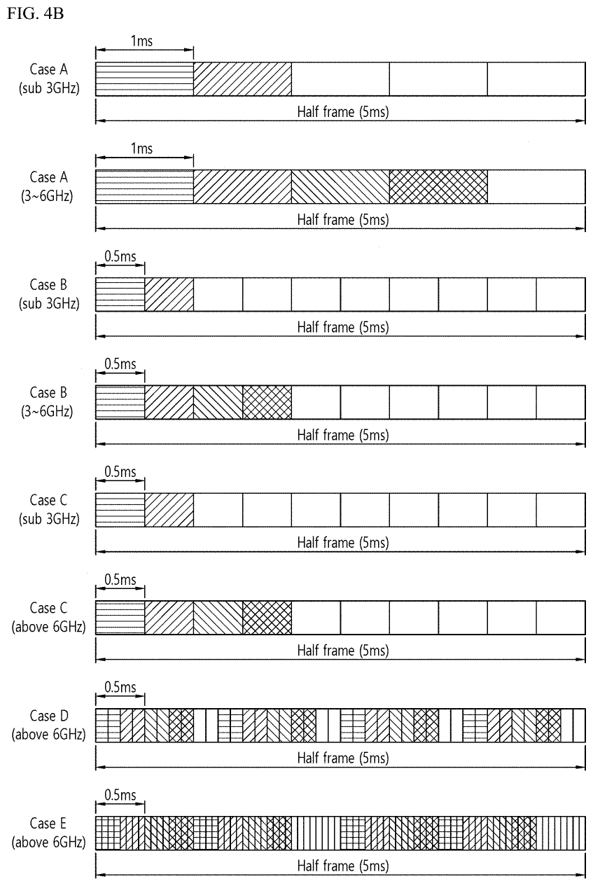

FIG. 4a and FIG. 4b illustrate an SS/PBCH block for initial cell access in a 3GPP NR system. When the power is turned on or wanting to access a new cell, the UE may obtain time and frequency synchronization with the cell and perform an initial cell search procedure. The UE may detect a physical cell identity NceMD of the cell during a cell search procedure. For this, the UE may receive a synchronization signal, for example, a primary synchronization signal (PSS) and a secondary synchronization signal (SSS), from a base station, and synchronize with the base station. In this case, the UE can obtain information such as a cell identity (ID).

FIG. 4a and FIG. 4b, a synchronization signal (SS) will be described in more detail. The synchronization signal can be classified into PSS and SSS. The PSS may be used to obtain time region synchronization and/or frequency region synchronization, such as OFDM symbol synchronization and slot synchronization. The SSS can be used to obtain frame synchronization and cell group ID. Referring to FIG. 4a and Table 2, the SS/PBCH block can be configured with consecutive 20 RBs (=240 subcarriers) in the frequency axis, and can be configured with consecutive 4 OFDM symbols in the time axis. In this case, in the SS/PBCH block, the PSS is transmitted in the first OFDM symbol and the SSS is transmitted in the third OFDM symbol through the 56th to 182th subcarriers. Here, the lowest subcarrier index of the SS/PBCH block is numbered from 0. In the first OFDM symbol in which the PSS is transmitted, the base station does not transmit a signal through the remaining subcarriers, i.e., 0th to 55th and 183th to 239th subcarriers. In addition, in the third OFDM symbol in which the SSS is transmitted, the base station does not transmit a signal through 48th to 55th and 183th to 191th subcarriers. The base station transmits a physical broadcast channel (PBCH) through the remaining RE except for the above signal in the SS/PBCH block.

TABLE 2

| | OFDM symbol number l | Subcarrier number k |
|---|---|---|
| Channel | relative to the start of an | relative to the start of an |
| or signal | SS/PBCH block | SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + ν, 4 + ν, 8 + ν, . . . , 236 + ν |
| for | 2 | 0 + ν, 4 + ν, 8 + ν, . . . , 44 + ν |
| PBCH | | 192 + ν, 196 + ν, . . . , 236 + ν |

The SS identifies a total of 1008 unique physical layer cell IDs to be grouped into 336 physical-layer cell-identifier groups, each group including three unique identifiers, through a combination of three PSSs and SSSs, specifically, such that each physical layer cell ID is to be only a part of one physical-layer cell-identifier group. Therefore, the physical layer cell ID NcellID=3N(1)ID+N(2)ID can be uniquely defined by the index N(1)ID ranging from 0 to 335 indicating a physical-layer cell-identifier group and the index N(2)ID ranging from 0 to 2 indicating a physical-layer identifier in the physical-layer cell-identifier group. The UE may detect the PSS and identify one of the three unique physical-layer identifiers. In addition, the UE can detect the SSS and identify one of the 336 physical layer cell IDs associated with the physical-layer identifier. In this case, the sequence dPSS(n) of the PSS is as follows.

d_{PSS}(n)=1−2x(m) [101]

m=(n+43N_{ID}⁽²⁾)mod 127 [102]

0≤n<127 [103]

Here, x(i+7)=(x(i+4)+x(i))mod 2 and is given as

[x(6) x(5) x(4) x(3) x(2) x(1) x(0)]=[1 1 1 0 1 1 0]

Further, the sequence dSSS(n) of the SSS is as follows.

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] {m}_{0} = 15 ⌊ \frac{{N}_{ID}^{( 1 )}}{112} ⌋ + 5 {N}_{ID}^{( 2 )} {m}_{1} = {N}_{ID}^{( 1 )} mod 112 \; 0 \leq n < 127$$

x₀(i+7)=(x₀(i+4)+x₀(i))mod 2

Here, x₁(i+7)=(x₁(i+1)+x₁(i))mod 2 and is given as

[x₀(6) x₀(5) x₀(4) x₀(3) x₀(2) x₀(1) x₀(0)]=[0 0 0 0 0 0 1]

[x₁(6) x₁(5) x₁(4) x₁(3) x₁(2) x₁(1) x₁(0)]=[0 0 0 0 0 0 1]

A radio frame with a 10 ms length may be divided into two half frames with a 5 ms length. Referring to FIG. 4(b), a description will be made of a slot in which SS/PBCH blocks are transmitted in each half frame. A slot in which the SS/PBCH block is transmitted may be any one of the cases A, B, C, D, and E. In the case A, the subcarrier spacing is 15 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case B, the subcarrier spacing is 30 kHz and the starting time point of the SS/PBCH block is {4, 8, 16, 20}+28*n. In this case, n=0 at a carrier frequency of 3 GHz or less. In addition, it may be n=0, 1 at carrier frequencies above 3 GHz and below 6 GHz. In the case C, the subcarrier spacing is 30 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case D, the subcarrier spacing is 120 kHz and the starting time point of the SS/PBCH block is the ({4, 8, 16, 20}+28*n)-th symbol. In this case, at a carrier frequency of 6 GHz or more, n=0, 1, 2, 3, 5, 6, 7, 8, 10, 11, 12, 13, 15, 16, 17, 18. In the case E, the subcarrier spacing is 240 kHz and the starting time point of the SS/PBCH block is the ({8, 12, 16, 20, 32, 36, 40, 44}+56*n)-th symbol. In this case, at a carrier frequency of 6 GHz or more, n=0, 1, 2, 3, 5, 6, 7, 8.

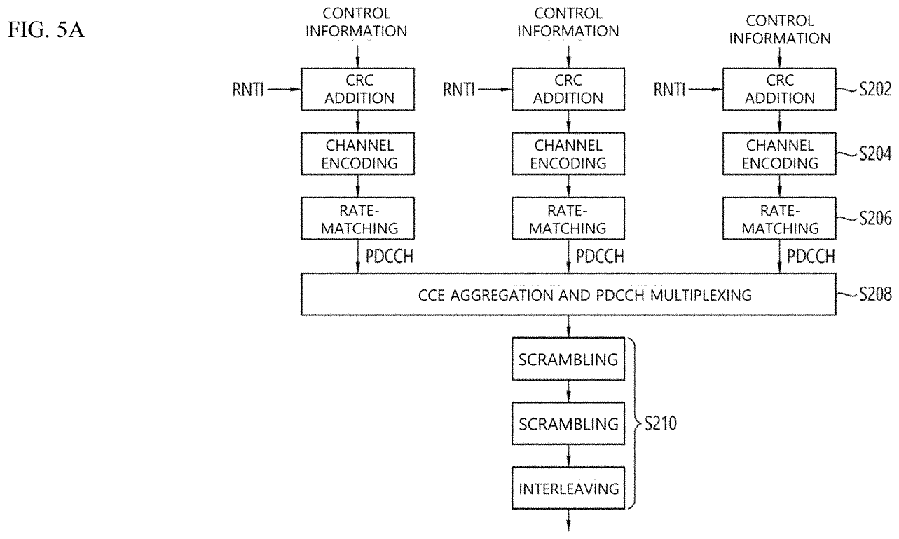

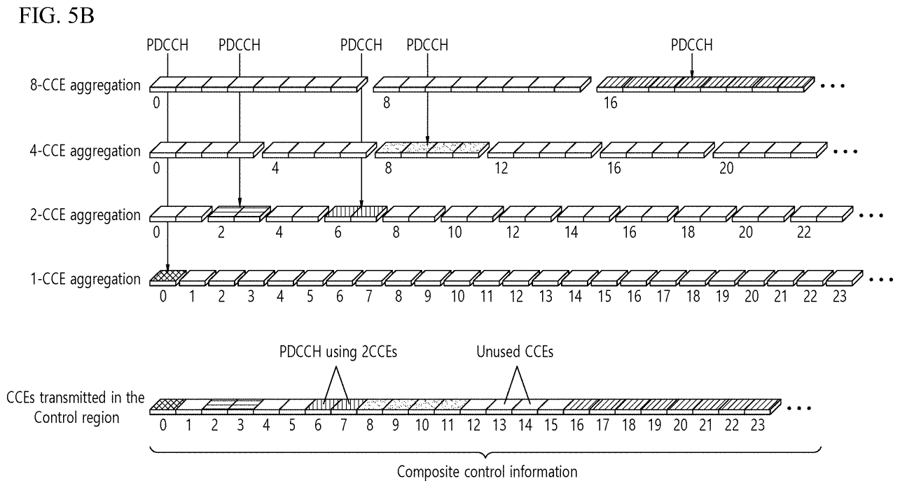

FIG. 5a and FIG. 5b illustrate a procedure for transmitting control information and a control channel in a 3GPP NR system. Referring to FIG. 5a, the base station may add a cyclic redundancy check (CRC) masked (e.g., an XOR operation) with a radio network temporary identifier (RNTI) to control information (e.g., downlink control information (DCI)) (S202). The base station may scramble the CRC with an RNTI value determined according to the purpose/target of each control information. The common RNTI used by one or more UEs can include at least one of a system information RNTI (SI-RNTI), a paging RNTI (P-RNTI), a random access RNTI (RA-RNTI), and a transmit power control RNTI (TPC-RNTI). In addition, the UE-specific RNTI may include at least one of a cell temporary RNTI (C-RNTI), and the CS-RNTI. Thereafter, the base station may perform rate-matching (S206) according to the amount of resource(s) used for PDCCH transmission after performing channel encoding (e.g., polar coding) (S204). Thereafter, the base station may multiplex the DCI(s) based on the control channel element (CCE) based PDCCH structure (S208).

In addition, the base station may apply an additional process (S210) such as scrambling, modulation (e.g., QPSK), interleaving, and the like to the multiplexed DCI(s), and then map the DCI(s) to the resource to be transmitted. The CCE is a basic resource unit for the PDCCH, and one CCE may include a plurality (e.g., six) of resource element groups (REGs). One REG may be configured with a plurality (e.g., 12) of REs. The number of CCEs used for one PDCCH may be defined as an aggregation level. In the 3GPP NR system, an aggregation level of 1, 2, 4, 8, or 16 may be used. FIG. 5b is a diagram related to a CCE aggregation level and the multiplexing of a PDCCH and illustrates the type of a CCE aggregation level used for one PDCCH and CCE(s) transmitted in the control area according thereto.

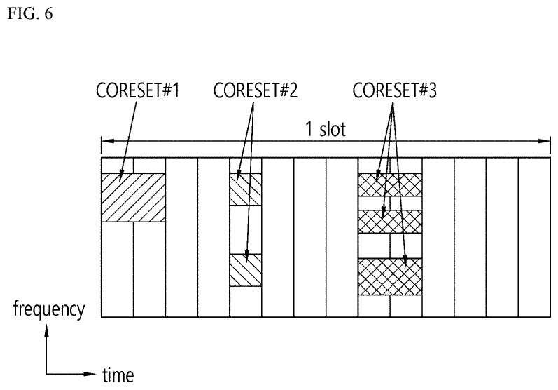

FIG. 6 illustrates a control resource set (CORESET) in which a physical downlink control channel (PUCCH) may be transmitted in a 3GPP NR system. The CORESET is a time-frequency resource in which PDCCH, that is, a control signal for the UE, is transmitted. In addition, a search space to be described later may be mapped to one CORESET. Therefore, the UE may monitor the time-frequency region designated as CORESET instead of monitoring all frequency bands for PDCCH reception, and decode the PDCCH mapped to CORESET. The base station may configure one or more CORESETs for each cell to the UE. The CORESET may be configured with up to three consecutive symbols on the time axis. In addition, the CORESET may be configured in units of six consecutive PRBs on the frequency axis. In the embodiment of FIG. 5, CORESET #1 is configured with consecutive PRBs, and CORESET #2 and CORESET #3 are configured with discontinuous PRBs. The CORESET can be located in any symbol in the slot. For example, in the embodiment of FIG. 5, CORESET #1 starts at the first symbol of the slot, CORESET #2 starts at the fifth symbol of the slot, and CORESET #9 starts at the ninth symbol of the slot.

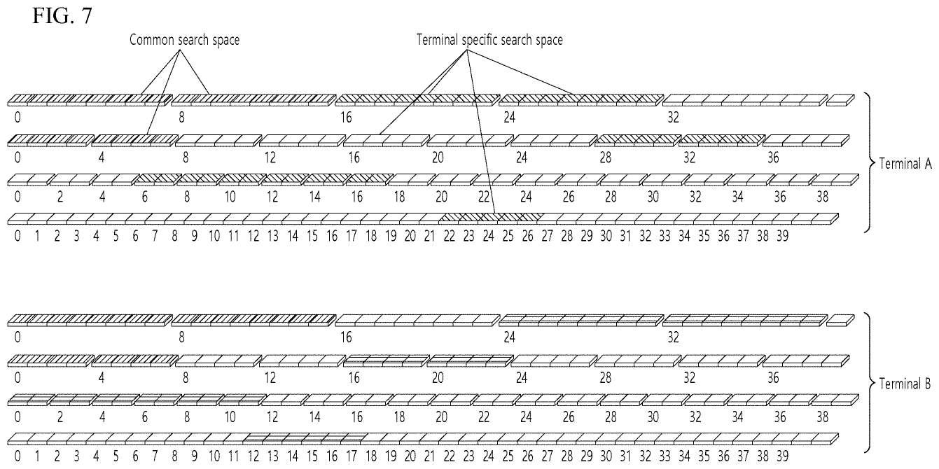

FIG. 7 illustrates a method for setting a PDCCH search space in a 3GPP NR system. In order to transmit the PDCCH to the UE, each CORESET may have at least one search space. In the embodiment of the present disclosure, the search space is a set of all time-frequency resources (hereinafter, PDCCH candidates) through which the PDCCH of the UE is capable of being transmitted. The search space may include a common search space that the UE of the 3GPP NR is required to commonly search and a UE-specific or a UE-specific search space that a specific UE is required to search. In the common search space, UE may monitor the PDCCH that is set so that all UEs in the cell belonging to the same base station commonly search. In addition, the UE-specific search space may be set for each UE so that UEs monitor the PDCCH allocated to each UE at different search space position according to the UE. In the case of the UE-specific search space, the search space between the UEs may be partially overlapped and allocated due to the limited control area in which the PDCCH may be allocated. Monitoring the PDCCH includes blind decoding for PDCCH candidates in the search space. When the blind decoding is successful, it may be expressed that the PDCCH is (successfully) detected/received and when the blind decoding fails, it may be expressed that the PDCCH is not detected/not received, or is not successfully detected/received.

For convenience of explanation, a PDCCH scrambled with a group common (GC) RNTI previously known to one or more UEs so as to transmit DL control information to the one or more UEs is referred to as a group common (GC) PDCCH or a common PDCCH. In addition, a PDCCH scrambled with a specific-terminal RNTI that a specific UE already knows so as to transmit UL scheduling information or DL scheduling information to the specific UE is referred to as a specific-UE PDCCH. The common PDCCH may be included in a common search space, and the UE-specific PDCCH may be included in a common search space or a UE-specific PDCCH.

The base station may signal each UE or UE group through a PDCCH about information (i.e., DL Grant) related to resource allocation of a paging channel (PCH) and a downlink-shared channel (DL-SCH) that are a transmission channel or information (i.e., UL grant) related to resource allocation of a uplink-shared channel (UL-SCH) and a hybrid automatic repeat request (HARD). The base station may transmit the PCH transport block and the DL-SCH transport block through the PDSCH. The base station may transmit data excluding specific control information or specific service data through the PDSCH. In addition, the UE may receive data excluding specific control information or specific service data through the PDSCH.

The base station may include, in the PDCCH, information on to which UE (one or a plurality of UEs) PDSCH data is transmitted and how the PDSCH data is to be received and decoded by the corresponding UE, and transmit the PDCCH. For example, it is assumed that the DCI transmitted on a specific PDCCH is CRC masked with an RNTI of “A”, and the DCI indicates that PDSCH is allocated to a radio resource (e.g., frequency location) of “B” and indicates transmission format information (e.g., transport block size, modulation scheme, coding information, etc.) of “C”. The UE monitors the PDCCH using the RNTI information that the UE has. In this case, if there is a UE which performs blind decoding the PDCCH using the “A” RNTI, the UE receives the PDCCH, and receives the PDSCH indicated by “B” and “C” through the received PDCCH information.

Table 3 shows an embodiment of a physical uplink control channel (PUCCH) used in a wireless communication system.

TABLE 3

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

The PUCCH may be used to transmit the following UL control information (UCI).

Scheduling Request (SR): Information used for requesting a UL UL-SCH resource.

HARQ-ACK: A Response to PDCCH (indicating DL SPS release) and/or a response to DL transport block (TB) on PDSCH. HARQ-ACK indicates whether information transmitted on the PDCCH or PDSCH is received. The HARQ-ACK response includes positive ACK (simply ACK), negative ACK (hereinafter NACK), Discontinuous Transmission (DTX), or NACK/DTX. Here, the term HARQ-ACK is used mixed with HARQ-ACK/NACK and ACK/NACK. In general, ACK may be represented by bit value 1 and NACK may be represented by bit value 0.

Channel State Information (CSI): Feedback information on the DL channel. The UE generates it based on the CSI-Reference Signal (RS) transmitted by the base station. Multiple Input Multiple Output (MIMO)-related feedback information includes a Rank Indicator (RI) and a Precoding Matrix Indicator (PMI). CSI can be divided into CSI part 1 and CSI part 2 according to the information indicated by CSI.

In the 3GPP NR system, five PUCCH formats may be used to support various service scenarios, various channel environments, and frame structures.

PUCCH format 0 is a format capable of delivering 1-bit or 2-bit HARQ-ACK information or SR. PUCCH format 0 can be transmitted through one or two OFDM symbols on the time axis and one PRB on the frequency axis. When PUCCH format 0 is transmitted in two OFDM symbols, the same sequence on the two symbols may be transmitted through different RBs. Through this, the UE may obtain a frequency diversity gain. In more detail, the UE may determine a cyclic shift (CS) value mcs according to Mbit bit UCI (Mbit=1 or 2). In addition, the base sequence having the length of 12 may be transmitted by mapping a cyclic shifted sequence based on a predetermined CS value mcs to one OFDM symbol and 12 REs of one RB. When the number of cyclic shifts available to the UE is 12 and Mbit=1, 1 bit UCI 0 and 1 may be mapped to two cyclic shifted sequences having a difference of 6 in the cyclic shift value, respectively. In addition, when Mbit=2, 2 bit UCI 00, 01, 11, and 10 may be mapped to four cyclic shifted sequences having a difference of 3 in cyclic shift values, respectively.

PUCCH format 1 may deliver 1-bit or 2-bit HARQ-ACK information or SR. PUCCH format 1 maybe transmitted through consecutive OFDM symbols on the time axis and one PRB on the frequency axis. Here, the number of OFDM symbols occupied by PUCCH format 1 may be one of 4 to 14. More specifically, UCI, which is Mbit=1, may be BPSK-modulated. The UE may modulate UCI, which is Mbit=2, with quadrature phase shift keying (QPSK). A signal is obtained by multiplying a modulated complex valued symbol d(0) by a sequence of length 12. In this case, the sequence may be a base sequence used for PUCCH format 0. The UE spreads the even-numbered OFDM symbols to which PUCCH format 1 is allocated through the time axis orthogonal cover code (OCC) to transmit the obtained signal. PUCCH format 1 determines the maximum number of different UEs multiplexed in the one RB according to the length of the OCC to be used. A demodulation reference signal (DMRS) may be spread with OCC and mapped to the odd-numbered OFDM symbols of PUCCH format 1.

PUCCH format 2 may deliver UCI exceeding 2 bits. PUCCH format 2 may be transmitted through one or two OFDM symbols on the time axis and one or a plurality of RBs on the frequency axis. When PUCCH format 2 is transmitted in two OFDM symbols, the sequences which are transmitted in different RBs through the two OFDM symbols may be same each other. Through this, the UE may obtain a frequency diversity gain. More specifically, Mbit bit UCI (Mbit>2) is bit-level scrambled, QPSK modulated, and mapped to RB(s) of one or two OFDM symbol(s). Here, the number of RBs may be one of 1 to 16.

PUCCH format 3 or PUCCH format 4 may deliver UCI exceeding 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14. Specifically, the UE modulates Mbit bits UCI (Mbit>2) with π/2-Binary Phase Shift Keying (BPSK) or QPSK to generate a complex valued symbol d(0) to d(Msymb−1). Here, when using π/2-BPSK, Msymb=Mbit, and when using QPSK, Msymb=Mbit/2. The UE may not apply block-unit spreading to the PUCCH format 3. However, the UE may apply block-unit spreading to one RB (i.e., 12 subcarriers) using PreDFT-OCC of a length of 12 such that PUCCH format 4 may have two or four multiplexing capacities. The UE performs transmit precoding (or DFT-precoding) on the spread signal and maps it to each RE to transmit the spread signal.

In this case, the number of RBs occupied by PUCCH format 2, PUCCH format 3, or PUCCH format 4 may be determined according to the length and maximum code rate of the UCI transmitted by the UE. When the UE uses PUCCH format 2, the UE may transmit HARQ-ACK information and CSI information together through the PUCCH. When the number of RBs that the UE may transmit is greater than the maximum number of RBs that PUCCH format 2, or PUCCH format 3, or PUCCH format 4 may use, the UE may transmit only the remaining UCI information without transmitting some UCI information according to the priority of the UCI information.

PUCCH format 1, PUCCH format 3, or PUCCH format 4 may be configured through the RRC signal to indicate frequency hopping in a slot. When frequency hopping is configured, the index of the RB to be frequency hopped may be configured with an RRC signal. When PUCCH format 1, PUCCH format 3, or PUCCH format 4 is transmitted through N OFDM symbols on the time axis, the first hop may have floor (N/2) OFDM symbols and the second hop may have ceiling(N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal. The repeatedly transmitted PUCCHs must start at an OFDM symbol of the constant position in each slot, and have the constant length. When one OFDM symbol among OFDM symbols of a slot in which a UE should transmit a PUCCH is indicated as a DL symbol by an RRC signal, the UE may not transmit the PUCCH in a corresponding slot and delay the transmission of the PUCCH to the next slot to transmit the PUCCH.

Meanwhile, in the 3GPP NR system, a UE may perform transmission/reception using a bandwidth equal to or less than the bandwidth of a carrier (or cell). For this, the UE may receive the Bandwidth part (BWP) configured with a continuous bandwidth of some of the carrier's bandwidth. A UE operating according to TDD or operating in an unpaired spectrum can receive up to four DL/UL BWP pairs in one carrier (or cell). In addition, the UE may activate one DL/UL BWP pair. A UE operating according to FDD or operating in paired spectrum can receive up to four DL BWPs on a DL carrier (or cell) and up to four UL BWPs on a UL carrier (or cell). The UE may activate one DL BWP and one UL BWP for each carrier (or cell). The UE may not perform reception or transmission in a time-frequency resource other than the activated BWP. The activated BWP may be referred to as an active BWP.

The base station may indicate the activated BWP among the BWPs configured by the UE through downlink control information (DCI). The BWP indicated through the DCI is activated and the other configured BWP(s) are deactivated. In a carrier (or cell) operating in TDD, the base station may include, in the DCI for scheduling PDSCH or PUSCH, a bandwidth part indicator (BPI) indicating the BWP to be activated to change the DL/UL BWP pair of the UE. The UE may receive the DCI for scheduling the PDSCH or PUSCH and may identify the DL/UL BWP pair activated based on the BPI. For a DL carrier (or cell) operating in an FDD, the base station may include a BPI indicating the BWP to be activated in the DCI for scheduling PDSCH so as to change the DL BWP of the UE. For a UL carrier (or cell) operating in an FDD, the base station may include a BPI indicating the BWP to be activated in the DCI for scheduling PUSCH so as to change the UL BWP of the UE.

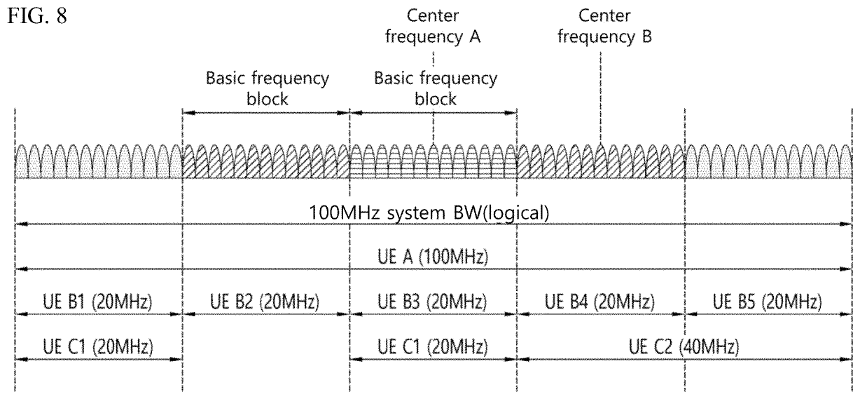

FIG. 8 is a conceptual diagram illustrating carrier aggregation.

The carrier aggregation is a method in which the UE uses a plurality of frequency blocks or cells (in the logical sense) configured with UL resources (or component carriers) and/or DL resources (or component carriers) as one large logical frequency band in order for a wireless communication system to use a wider frequency band. One component carrier may also be referred to as a term called a Primary cell (PCell) or a Secondary cell (SCell), or a Primary SCell (PScell). However, hereinafter, for convenience of description, the term “component carrier” is used.

Referring to FIG. 8, as an example of a 3GPP NR system, the entire system band may include up to 16 component carriers, and each component carrier may have a bandwidth of up to 400 MHz. The component carrier may include one or more physically consecutive subcarriers. Although it is shown in FIG. 8 that each of the component carriers has the same bandwidth, this is merely an example, and each component carrier may have a different bandwidth. Also, although each component carrier is shown as being adjacent to each other in the frequency axis, the drawings are shown in a logical concept, and each component carrier may be physically adjacent to one another, or may be spaced apart.

Different center frequencies may be used for each component carrier. Also, one common center frequency may be used in physically adjacent component carriers. Assuming that all the component carriers are physically adjacent in the embodiment of FIG. 8, center frequency A may be used in all the component carriers. Further, assuming that the respective component carriers are not physically adjacent to each other, center frequency A and the center frequency B can be used in each of the component carriers.

When the total system band is extended by carrier aggregation, the frequency band used for communication with each UE can be defined in units of a component carrier. UE A may use 100 MHz, which is the total system band, and performs communication using all five component carriers. UEs B1˜B5 can use only a 20 MHz bandwidth and perform communication using one component carrier. UEs C1 and C2 may use a 40 MHz bandwidth and perform communication using two component carriers, respectively. The two component carriers may be logically/physically adjacent or non-adjacent. UE C1 represents the case of using two non-adjacent component carriers, and UE C2 represents the case of using two adjacent component carriers.

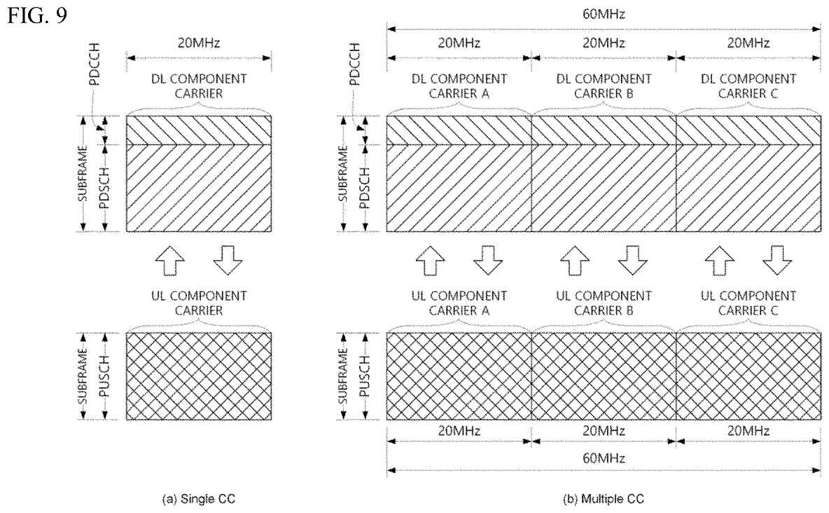

FIG. 9 is a drawing for explaining single carrier communication and multiple carrier communication. Particularly, FIG. 9(a) shows a single carrier subframe structure and FIG. 9(b) shows a multi-carrier subframe structure.

Referring to FIG. 9(a), in an FDD mode, a general wireless communication system may perform data transmission or reception through one DL band and one UL band corresponding thereto. In another specific embodiment, in a TDD mode, the wireless communication system may divide a radio frame into a UL time unit and a DL time unit in a time region, and perform data transmission or reception through a UL/DL time unit. Referring to FIG. 9(b), three 20 MHz component carriers (CCs) can be aggregated into each of UL and DL, so that a bandwidth of 60 MHz can be supported. Each CC may be adjacent or non-adjacent to one another in the frequency region. FIG. 9(b) shows a case where the bandwidth of the UL CC and the bandwidth of the DL CC are the same and symmetric, but the bandwidth of each CC can be determined independently. In addition, asymmetric carrier aggregation with different number of UL CCs and DL CCs is possible. A DL/UL CC allocated/configured to a specific UE through RRC may be called as a serving DL/UL CC of the specific UE.

The base station may perform communication with the UE by activating some or all of the serving CCs of the UE or deactivating some CCs. The base station can change the CC to be activated/deactivated, and change the number of CCs to be activated/deactivated. If the base station allocates a CC available for the UE as to be cell-specific or UE-specific, at least one of the allocated CCs can be deactivated, unless the CC allocation for the UE is completely reconfigured or the UE is handed over. One CC that is not deactivated by the UE is called as a Primary CC (PCC) or a primary cell (PCell), and a CC that the base station can freely activate/deactivate is called as a Secondary CC (SCC) or a secondary cell (SCell).

Meanwhile, 3GPP NR uses the concept of a cell to manage radio resources. A cell is defined as a combination of DL resources and UL resources, that is, a combination of DL CC and UL CC. A cell may be configured with DL resources alone, or a combination of DL resources and UL resources. When the carrier aggregation is supported, the linkage between the carrier frequency of the DL resource (or DL CC) and the carrier frequency of the UL resource (or UL CC) may be indicated by system information. The carrier frequency refers to the center frequency of each cell or CC. A cell corresponding to the PCC is referred to as a PCell, and a cell corresponding to the SCC is referred to as an SCell. The carrier corresponding to the PCell in the DL is the DL PCC, and the carrier corresponding to the PCell in the UL is the UL PCC. Similarly, the carrier corresponding to the SCell in the DL is the DL SCC and the carrier corresponding to the SCell in the UL is the UL SCC. According to UE capability, the serving cell(s) may be configured with one PCell and zero or more SCells. In the case of UEs that are in the RRC CONNECTED state but not configured for carrier aggregation or that do not support carrier aggregation, there is only one serving cell configured only with PCell.

As mentioned above, the term “cell” used in carrier aggregation is distinguished from the term “cell” which refers to a certain geographical area in which a communication service is provided by one base station or one antenna group. That is, one component carrier may also be referred to as a scheduling cell, a scheduled cell, a primary cell (PCell), a secondary cell (SCell), or a primary SCell (PScell). However, in order to distinguish between a cell referring to a certain geographical area and a cell of carrier aggregation, in the present disclosure, a cell of a carrier aggregation is referred to as a CC, and a cell of a geographical area is referred to as a cell.

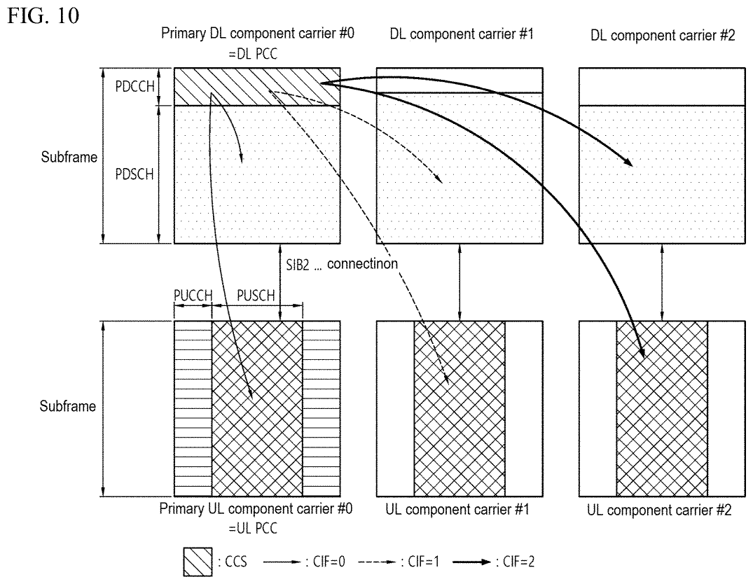

FIG. 10 is a diagram showing an example in which a cross carrier scheduling technique is applied. When cross carrier scheduling is set, the control channel transmitted through the first CC may schedule a data channel transmitted through the first CC or the second CC using a carrier indicator field (CIF). The CIF is included in the DCI. In other words, a scheduling cell is set, and the DL grant/UL grant transmitted in the PDCCH area of the scheduling cell schedules the PDSCH/PUSCH of the scheduled cell. That is, a search area for the plurality of component carriers exists in the PDCCH area of the scheduling cell. A PCell may be basically a scheduling cell, and a specific SCell may be designated as a scheduling cell by an upper layer.

In the embodiment of FIG. 10, it is assumed that three DL CCs are merged. Here, it is assumed that DL component carrier #0 is DL PCC (or PCell), and DL component carrier #1 and DL component carrier #2 are DL SCCs (or SCell). In addition, it is assumed that the DL PCC is set to the PDCCH monitoring CC. When cross-carrier scheduling is not configured by UE-specific (or UE-group-specific or cell-specific) higher layer signaling, a CIF is disabled, and each DL CC can transmit only a PDCCH for scheduling its PDSCH without the CIF according to an NR PDCCH rule (non-cross-carrier scheduling, self-carrier scheduling). Meanwhile, if cross-carrier scheduling is configured by UE-specific (or UE-group-specific or cell-specific) higher layer signaling, a CIF is enabled, and a specific CC (e.g., DL PCC) may transmit not only the PDCCH for scheduling the PDSCH of the DL CC A using the CIF but also the PDCCH for scheduling the PDSCH of another CC (cross-carrier scheduling). On the other hand, a PDCCH is not transmitted in another DL CC. Accordingly, the UE monitors the PDCCH not including the CIF to receive a self-carrier scheduled PDSCH depending on whether the cross-carrier scheduling is configured for the UE, or monitors the PDCCH including the CIF to receive the cross-carrier scheduled PDSCH.

On the other hand, FIGS. 9 and 10 illustrate the subframe structure of the 3GPP LTE-A system, and the same or similar configuration may be applied to the 3GPP NR system. However, in the 3GPP NR system, the subframes of FIGS. 9 and 10 may be replaced with slots.

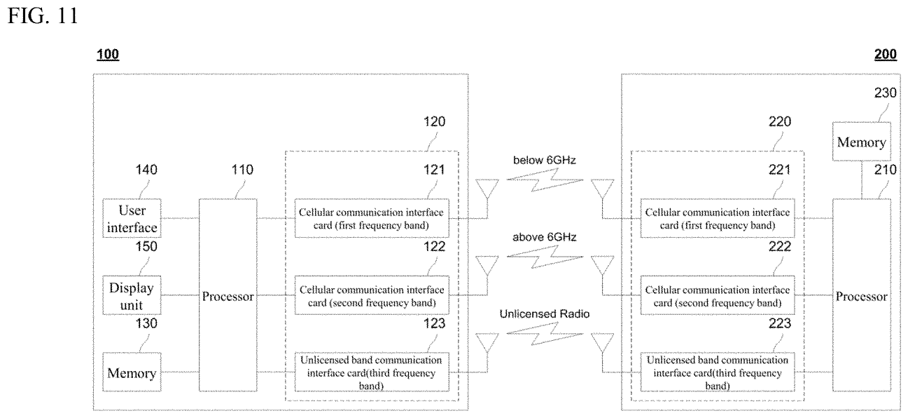

FIG. 11 is a block diagram showing the configurations of a UE and a base station according to an embodiment of the present disclosure. In an embodiment of the present disclosure, the UE may be implemented with various types of wireless communication devices or computing devices that are guaranteed to be portable and mobile. The UE may be referred to as a User Equipment (UE), a Station (STA), a Mobile Subscriber (MS), or the like. In addition, in an embodiment of the present disclosure, the base station controls and manages a cell (e.g., a macro cell, a femto cell, a pico cell, etc.) corresponding to a service area, and performs functions of a signal transmission, a channel designation, a channel monitoring, a self diagnosis, a relay, or the like. The base station may be referred to as next Generation NodeB (gNB) or Access Point (AP).

As shown in the drawing, a UE 100 according to an embodiment of the present disclosure may include a processor 110, a communication module 120, a memory 130, a user interface 140, and a display unit 150.

First, the processor 110 may execute various instructions or programs and process data within the UE 100. In addition, the processor 110 may control the entire operation including each unit of the UE 100, and may control the transmission/reception of data between the units. Here, the processor 110 may be configured to perform an operation according to the embodiments described in the present disclosure. For example, the processor 110 may receive slot configuration information, determine a slot configuration based on the slot configuration information, and perform communication according to the determined slot configuration.

Next, the communication module 120 may be an integrated module that performs wireless communication using a wireless communication network and a wireless LAN access using a wireless LAN. For this, the communication module 120 may include a plurality of network interface cards (NICs) such as cellular communication interface cards 121 and 122 and an unlicensed band communication interface card 123 in an internal or external form. In the drawing, the communication module 120 is shown as an integral integration module, but unlike the drawing, each network interface card can be independently arranged according to a circuit configuration or usage.

The cellular communication interface card 121 may transmit or receive a radio signal with at least one of the base station 200, an external device, and a server by using a mobile communication network and provide a cellular communication service in a first frequency band based on the instructions from the processor 110. According to an embodiment, the cellular communication interface card 121 may include at least one NIC module using a frequency band of less than 6 GHz. At least one NIC module of the cellular communication interface card 121 may independently perform cellular communication with at least one of the base station 200, an external device, and a server in accordance with cellular communication standards or protocols in the frequency bands below 6 GHz supported by the corresponding NIC module.

The cellular communication interface card 122 may transmit or receive a radio signal with at least one of the base station 200, an external device, and a server by using a mobile communication network and provide a cellular communication service in a second frequency band based on the instructions from the processor 110. According to an embodiment, the cellular communication interface card 122 may include at least one NIC module using a frequency band of more than 6 GHz. At least one NIC module of the cellular communication interface card 122 may independently perform cellular communication with at least one of the base station 200, an external device, and a server in accordance with cellular communication standards or protocols in the frequency bands of 6 GHz or more supported by the corresponding NIC module.

The unlicensed band communication interface card 123 transmits or receives a radio signal with at least one of the base station 200, an external device, and a server by using a third frequency band which is an unlicensed band, and provides an unlicensed band communication service based on the instructions from the processor 110. The unlicensed band communication interface card 123 may include at least one NIC module using an unlicensed band. For example, the unlicensed band may be a band of 2.4 GHz or 5 GHz. At least one NIC module of the unlicensed band communication interface card 123 may independently or dependently perform wireless communication with at least one of the base station 200, an external device, and a server according to the unlicensed band communication standard or protocol of the frequency band supported by the corresponding NIC module.

The memory 130 stores a control program used in the UE 100 and various kinds of data therefor. Such a control program may include a prescribed program required for performing wireless communication with at least one among the base station 200, an external device, and a server.

Next, the user interface 140 includes various kinds of input/output means provided in the UE 100. In other words, the user interface 140 may receive a user input using various input means, and the processor 110 may control the UE 100 based on the received user input. In addition, the user interface 140 may perform an output based on instructions from the processor 110 using various kinds of output means.

Next, the display unit 150 outputs various images on a display screen. The display unit 150 may output various display objects such as content executed by the processor 110 or a user interface based on control instructions from the processor 110.

In addition, the base station 200 according to an embodiment of the present disclosure may include a processor 210, a communication module 220, and a memory 230.

First, the processor 210 may execute various instructions or programs, and process internal data of the base station 200. In addition, the processor 210 may control the entire operations of units in the base station 200, and control data transmission and reception between the units. Here, the processor 210 may be configured to perform operations according to embodiments described in the present disclosure. For example, the processor 210 may signal slot configuration and perform communication according to the signaled slot configuration.

Next, the communication module 220 may be an integrated module that performs wireless communication using a wireless communication network and a wireless LAN access using a wireless LAN. For this, the communication module 120 may include a plurality of network interface cards such as cellular communication interface cards 221 and 222 and an unlicensed band communication interface card 223 in an internal or external form. In the drawing, the communication module 220 is shown as an integral integration module, but unlike the drawing, each network interface card can be independently arranged according to a circuit configuration or usage.

The cellular communication interface card 221 may transmit or receive a radio signal with at least one of the UE 100, an external device, and a server by using a mobile communication network and provide a cellular communication service in the first frequency band based on the instructions from the processor 210. According to an embodiment, the cellular communication interface card 221 may include at least one NIC module using a frequency band of less than 6 GHz. The at least one NIC module of the cellular communication interface card 221 may independently perform cellular communication with at least one of the UE 100, an external device, and a server in accordance with the cellular communication standards or protocols in the frequency bands less than 6 GHz supported by the corresponding NIC module.

The cellular communication interface card 222 may transmit or receive a radio signal with at least one of the UE 100, an external device, and a server by using a mobile communication network and provide a cellular communication service in the second frequency band based on the instructions from the processor 210. According to an embodiment, the cellular communication interface card 222 may include at least one NIC module using a frequency band of 6 GHz or more. The at least one NIC module of the cellular communication interface card 222 may independently perform cellular communication with at least one of the base station 100, an external device, and a server in accordance with the cellular communication standards or protocols in the frequency bands 6 GHz or more supported by the corresponding NIC module.

The unlicensed band communication interface card 223 transmits or receives a radio signal with at least one of the base station 100, an external device, and a server by using the third frequency band which is an unlicensed band, and provides an unlicensed band communication service based on the instructions from the processor 210. The unlicensed band communication interface card 223 may include at least one NIC module using an unlicensed band. For example, the unlicensed band may be a band of 2.4 GHz or 5 GHz. At least one NIC module of the unlicensed band communication interface card 223 may independently or dependently perform wireless communication with at least one of the UE 100, an external device, and a server according to the unlicensed band communication standards or protocols of the frequency band supported by the corresponding NIC module.

FIG. 11 is a block diagram illustrating the UE 100 and the base station 200 according to an embodiment of the present disclosure, and blocks separately shown are logically divided elements of a device. Accordingly, the aforementioned elements of the device may be mounted in a single chip or a plurality of chips according to the design of the device. In addition, a part of the configuration of the UE 100, for example, a user interface 140, a display unit 150 and the like may be selectively provided in the UE 100. In addition, the user interface 140, the display unit 150 and the like may be additionally provided in the base station 200, if necessary.

I. Initial Access Method of RedCap UE

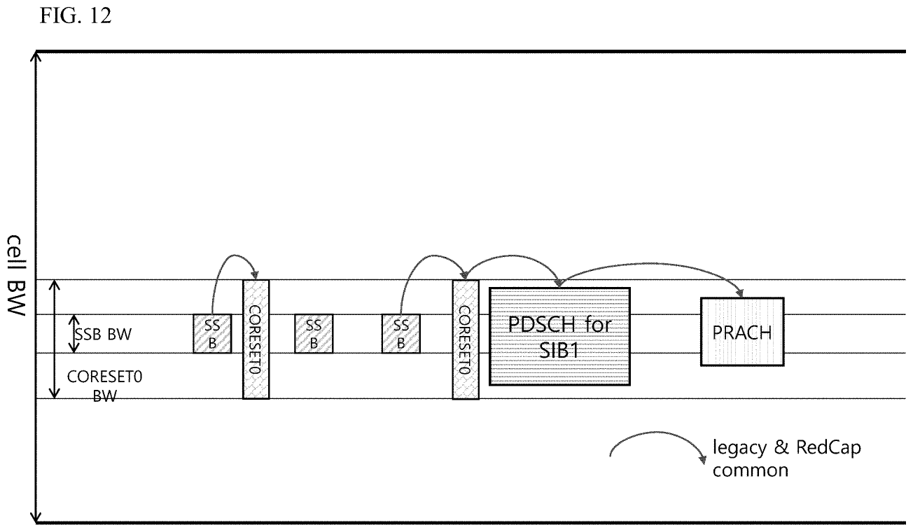

FIG. 12 illustrates an initial access method according to an example. Hereinafter, an Rel-15 UE or an Rel-16 UE is referred to as a legacy UE, and FIG. 12 is a general initial access procedure performed by a legacy UE.

Referring to FIG. 12, a UE receives an SSB from a base station. A frequency domain and a time domain in which the SSB is transmittable may be defined. The UE may receive the SSB within the frequency and time domains. The SSB includes a PSS, an SSS, and a PBCH. The UE may perform downlink synchronization and identify a physical cell ID by receiving a PSS and an SSS. The UE may receive a master information block (MIB) included in a PBCH by receiving the PBCH.

The MIB includes the most basic information of a cell and configuration information of a Type-0 search space and a basic CORESET (i.e., CORESET0). The UE may monitor and receive a PDCCH, based on configuration information of the Type-0 search space and CORESET0. The PDCCH may deliver DCI format 1_0 in which a CRC is scrambled with an SI-RNTI. DCI format 1_0 may be for scheduling of a PDSCH. The PDSCH may deliver, to the UE, SIB1 including cell common information necessary for the UE to access a cell.

The UE may receive cell common information from SIB1 delivered by the PDSCH and configuration information of a PRACH. The UE may transmit the PRACH according to configuration information of the PRACH. Via transmission of the PRACH and a subsequent random-access procedure, the UE may perform uplink synchronization and receive UE-specific information.

However, a new type of UE (hereinafter, referred to as a RedCap UE) having reduced capability (RedCap) compared to a legacy type UE may not be able to access a cell by using the initial cell access procedure according to FIG. 12. This is because of the following reasons.

1) A bandwidth in which a RedCap UE is able to perform reception may be limited. This is because a RedCap UE may support only a small bandwidth for low product prices. On the other hand, in the initial cell access procedure as shown in FIG. 12, a bandwidth of the UE is not considered. For example, a bandwidth (indicated as CORESET0 BW in FIG. 12) of CORESET0 may be greater than that of a RedCap UE.

2) A RedCap UE may request higher coverage. The initial cell access procedure according to FIG. 12 is determined according to a link budget of a legacy type UE. Therefore, in order for a RedCap UE to succeed in initial cell access, the initial cell access procedure according to FIG. 12 needs to be further improved. For example, a PDCCH received in CORESET0 should be able to satisfy sufficient coverage.

The following embodiments disclose an improved initial access procedure for such a RedCap UE.

### (1) First Embodiment

As a first embodiment of the present disclosure, a RedCap UE may receive control channel information for initial cell access of the RedCap UE via SIB1.

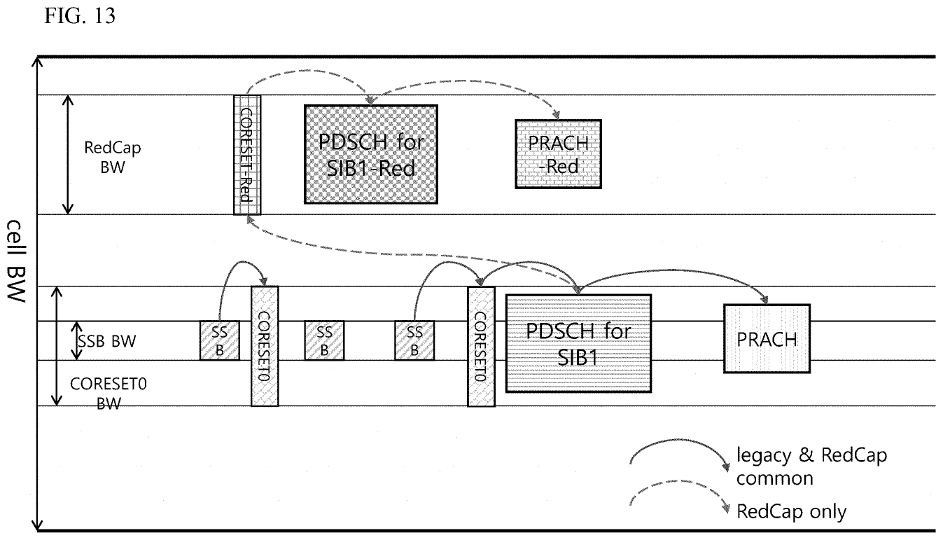

FIG. 13 is a diagram illustrating an initial cell access method according to an embodiment of the present disclosure.

Referring to FIG. 13, a RedCap UE may receive an SS/PBCH (or SSB) of a cell. The RedCap UE may receive information of a frequency domain of CORESET0 (indicated as CORESET0 BW in FIG. 13) or information of a time domain of a Type-0 search space via the SS/PBCH. The RedCap UE may receive a PDCCH scrambled with an SI-RNTI within the Type-0 search space or CORESET0. The RedCap UE may receive DCI format 1_0 through the PDCCH. DCI format 1_0 may include scheduling information of a PDSCH (indicated as PDSCH for SIB1 in FIG. 13) for delivering of SIB1. Accordingly, the RedCap UE may receive SIB1 through the PDSCH.

The RedCap UE may identify the presence or absence of information for initial cell access of the RedCap UE in the received SIB1. The information for the initial cell access of the RedCap UE may include information on a CORESET (hereinafter, referred to as CORESET-Red) or a search space (hereinafter, referred to as search space-Red) for initial cell access of the RedCap UE.

The RedCap UE may be configured with frequency resource allocation information, a length, REG, an REG bundle, or CCE configuration information of the CORESET (indicated as CORESET-Red in FIG. 13) of the RedCap UE. The RedCap UE may be configured with a search space corresponding to the CORESET-Red separately from CORESET0. In order to configure a search space (search space-Red), the UE may receive information, such as a period and an offset for monitoring of the PDCCH or aggregation levels of PDCCH candidates and the number of PDCCH candidates per aggregation level.

If there is no configuration of the CORESET-Red for the RedCap UE in SIB1 received by the RedCap UE, or there is no configuration of a search space corresponding to the CORESET-Red, the RedCap UE may perform at least one of the following operations.

A first operation includes an operation of, if the RedCap UE fails to receive configurations of the CORESET-Red and search space-Red via SIB1, determining that the RedCap UE cannot access the cell.

A second operation includes an operation of, if the RedCap UE fails to receive the configuration of the CORESET-Red via SIB1, assuming that the frequency resource allocation information, length, REG, REG bundle, or CCE configuration information of the CORESET-Red are the same as the configuration information of CORESET0.

A third operation includes an operation of, if the RedCap UE fails to receive some of the configuration of the CORESET-Red via SIB1 but receives some of the configuration of the CORESET-Red, assuming that the configuration information of the CORESET-Red, which has failed to be received, is the same as the configuration information of CORESET0. For example, if the RedCap UE receives the frequency resource allocation information of the CORESET-Red via SIB1 but fails to receive the length, REG, REG bundle, or CCE configuration information, assuming that the length, REG, REG bundle, and CCE configuration information are the same as the length, REG, REG bundle, or CCE configuration information of CORESET0.

A fourth operation includes an operation of, if the RedCap UE fails to receive the configuration of the search space-Red via SIB1, the period and offset or aggregation levels of PDCCH candidates and the number of PDCCH candidates per aggregation level of the search space-Red are the same as the configuration of the Type-0 search space of the cell. Here, the Type-0 search space is a search space for monitoring of the PDCCH having the CRC scrambled with the SI-RNTI.

A fifth operation includes an operation of, if the RedCap UE receives some of the configuration of the search space-Red via SIB1 and fails to receive some of the same, assuming that the configuration information of the search space-Red, which has failed to be received, is the same as the configuration information of the Type-0 search space. For example, if the RedCap UE receives the period and offset of the search space-Red via SIB1, but fails to receive the aggregation levels of PDCCH candidates and the number of PDCCH candidates per aggregation level, it may be assumed that the aggregation levels of PDCCH candidates and the number of PDCCH candidates per aggregation level are the same as the aggregation levels of PDCCH candidates and the number of PDCCH candidates per aggregation level of the search space-Red.

Additionally, the RedCap UE may receive, from SIB1, an indicator indicating whether the RedCap UE is able to access the cell.

As an example, the indicator may indicate that the RedCap UE is able to the cell or that the RedCap UE cannot access the cell. If the indicator indicates that the RedCap UE cannot access the cell, the RedCap UE cannot perform cell access using a PRACH resource received in SIB1.

As another example, the indicator may indicate that the RedCap UE is able to access the cell using the CORESET-Red or the search space-Red, or that the RedCap UE cannot access the cell using the CORESET-Red or the search space-Red. If the indicator indicates that the RedCap UE cannot access the cell using the CORESET-Red or the search space-Red, the RedCap UE may perform cell access using the PRACH resource received in SIB1.

As another example, the indicator may indicate whether the RedCap UE is able to access the cell via the PRACH configured in SIB1. If the indicator indicates that the RedCap UE is able to access the cell using the PRACH configured in SIB1, the RedCap UE may perform cell access using the PRACH resource received in SIB1.

A method for the RedCap UE to receive information of a CORESET-Red and a search space-Red via SIB1 is as follows.

As a first method, information of a CORESET-Red and a search space-Red relating to the RedCap UE may be configured in the same way as configuring of CORESET0 or a Type-0 search space in the PBCH. That is, the information of the CORESET-Red and search space-Red may be 8 bits. Among the 8 bits, 4 bits may represent the CORESET-Red information, and the remaining 4 bits may represent the search space-Red information. The 4-bit CORESET-Red information indicates one combination among 16 combinations. The 4-bit search space-Red indicates one combination among 16 combinations. Here, descriptions are provided using 8 bits, but if 8 bits are not sufficient, it may be extended to any integer bits.

As a second method, information of a CORESET-Red and a search space-Red relating to the RedCap UE may be configured in the same way as configuring of the existing CORESET and search space.

As an example, the CORESET-Red information may include CORESET-Red frequency information.

In an aspect, the CORESET-Red frequency information may include an offset of a PRB based on CORESET0. That is, the CORESET-Red frequency information (allocated PRBs) may be PRBs obtained by adding an offset to PRBs of CORESET0.

In another aspect, the CORESET-Red frequency information may include a common PRB index of the cell. Here, the common PRB index of the cell is a PRB index commonly used by UEs of the cell, and a frequency corresponding to common PRB index 0 may be received in SIB1. The UE may assign an index from common PRB index 0. CORESET-Red information may indicate a start index of PRBs by using the common PRB index.

As another example, the CORESET-Red information may include the length (number of symbols) of a CORESET-Red. The length may include 1, 2 or 3 symbols. The length may additionally include 6 to 12 symbols. A value obtained by comparing the length (number of symbols) of the CORESET-Red and that of CORESET0 may be included. For example, information indicating whether the length (number of symbols) of the CORESET-Red is equal to or different from the length (number of symbols) of CORESET0 may be included. The length (number of symbols) of the CORESET-Red may be indicated using a difference from the length (number of symbols) of CORESET0. That is, information obtained according to the length (number of symbols) of the CORESET-Red—the length (number of symbols) of CORESET0 may be included. In general, since the length (number of symbols) of the CORESET-Red is greater than or equal to the length (number of symbols) of CORESET0, the difference (the length (number of symbols) of the CORESET-Red—the length (number of symbols) of CORESET0) may include only a non-negative integer.

As another example, the CORESET-Red information may include information on whether interleaving is performed with respect to REG-to-CCE mapping. If interleaving is not performed, REGs (REG bundles) for the RedCap UE may be sequentially bundled into CCEs. If interleaving is performed, indices of REGs (REG bundles) for the RedCap UE are interleaved, and the interleaved indices may be sequentially bundled into CCEs.

As another example, the CORESET-Red information may include size configuration information of an REG bundle. The size of an REG bundle represents the number of REGs included in one REG bundle. REGs may be bundled according to the size of an REG bundle. The RedCap UE may assume that the same precoding is applied to REGs included in an REG bundle. Therefore, the RedCap UE may reduce a channel estimation error by jointly detecting DM-RSs of REGs included in an REG bundle.

For higher channel estimation performance, CORESET-Red may include additional information. The RedCap UE may assume that the same precoding is used between different CCEs, based on the additional information. Here, the different CCEs may be CCEs adjacent in the frequency domain. For example, when indices of CCEs are sequentially numbered as 0, 1, 2, . . . in the frequency domain, the RedCap UE may assume, according to the additional information, that the same precoding is used for the CCEs adjacent in the frequency domain, for example, CCE0 and CCE1. In addition, the RedCap UE may assume that the same precoding is used for subsequent CCEs, for example, CCE2 and CCE3. Channel estimation performance may be improved by assuming that the same precoding is used for multiple CCEs adjacent in the frequency domain.

Here, application of the same precoding may be limited to CCEs included in one PDCCH candidate. That is, the RedCap UE may assume that the same precoding is used only for CCEs included in one PDCCH candidate. In addition, the RedCap UE may assume that different precodings are used for CCEs included in different PDCCH candidates.

As an example, the search space-Red may include period and offset information. The period and offset may include at least one time unit among a slot unit, a set unit of slots, a symbol unit, and a set unit of symbols. The RedCap UE may additionally be indicated with an index of a symbol at which PDCCH monitoring starts within each time unit. If the unit of the period and offset information is a slot unit, the index of the start symbol may be indicated by a 14-bit bitmap. A most significant bit (MSB) of a bitmap indicates a first symbol of a slot, and a least significant bit (LSB) indicates a last symbol of the slot. If the unit of the period and offset information is a time unit other than a slot, a bitmap corresponding to the number of symbols included in the time unit may be indicated. An MSB of the bitmap may indicate a first symbol among symbols included in the time unit, and an LSB may indicate a last symbol among the symbols included in the time unit. The RedCap UE may determine a monitoring occasion in which the PDCCH needs to be monitored via a start index or the period and offset value. The RedCap UE needs to blind-decode the PDCCH in symbols corresponding to the monitoring occasion.

As another example, the search space-Red may include information on an additional monitoring occasion at which PDCCHs monitored by the RedCap UE at the monitoring occasion may be repeatedly received. The UE may monitor and receive a first PDCCH at the monitoring occasion. However, if sufficient reception is not possible with only one first PDCCH, reception performance of the PDCCH may be improved by repeatedly receiving the first PDCCH at another monitoring occasion. Accordingly, information on an additional monitoring occasion enabling repetitive reception of the first PDCCH may be required.

The additional monitoring occasion may be provided by the following methods.

As a first method, an additional monitoring occasion may be repeated in each time unit and indicated by the number of time units. Here, the time unit may include at least one among a slot, a set of slots, a symbol, and a set of symbols. For example, the time unit is assumed to be a slot. According to the first method, the additional monitoring occasion may be indicated by the number (K) of slots. In this case, a first PDCCH monitored and received by the RedCap UE at a monitoring occasion of a first slot may be repeatedly received at the same symbol start position as that of a first slot in a subsequent slot. The RedCap UE may repeatedly receive the PDCCH as many times as the number (K) of slots indicated in this way. The same scheme may be used even in a case of a time unit other than a slot.

As a second method, an additional monitoring occasion may be repeated in a symbol immediately subsequent to the monitoring occasion, and may be indicated by the number (K) of repetitions. For example, if it is assumed that a monitoring occasion is configured in one slot, an additional monitoring occasion may be located in a symbol immediately subsequent to a symbol in which the monitoring occasion ends in the one slot. Further, in a symbol immediately subsequent to the symbol in which the additional monitoring occasion ends, another additional monitoring occasion may be located. In this way, additional monitoring occasions may be located consecutively according to the number (K) of repetitions.

Again in FIG. 13, the RedCap UE having received information of the CORESET-Red or search space-Red from SIB1 may receive a PDCCH within the CORESET-Red and the search space-Red. The PDCCH may be for scheduling of a PDSCH. The PDSCH may carry SIB1 (hereinafter, referred to as SIB1-Red) including system information to be additionally received by the RedCap UE. Therefore, the RedCap UE may receive the PDCCH according to the information of the CORESET-Red or search space-Red, and may receive the PDSCH scheduled by the PDCCH, thereby receiving SIB1-Red which is system information necessary for initial cell access of the RedCap UE. SIB1-Red may include information on a PRACH for cell access of the RedCap UE. For convenience, the PRACH used by the RedCap UE for cell access may be referred to as PRACH-Red.

In order to receive SIB1-Red, time-frequency resources on which the PDSCH has been scheduled should be indicated to the RedCap UE via the PDCCH. In order to be scheduled with a frequency resource (i.e., PRBs), the RedCap UE needs to identify an active downlink BWP. Alternatively, the RedCap UE needs to configure an active downlink BWP. Related methods are as follows.

As a first method, the RedCap UE may not be configured with a separate active downlink BWP from SIB1. In addition, based on CORESET-Red indicated by SIB1, frequencies from a lowest frequency PRB to a highest frequency PRB may not be determined as an active downlink BWP of the RedCap UE.

As a second method, the UE may be configured with an active downlink BWP for the RedCap UE from SIB1. Here, the active downlink BWP includes a CORESET-Red band.

In the above description, SS/PBCH, CORESET0, CORESET-Red, etc. are downlink signals or channels. Accordingly, the downlink signals or channels may be included in a downlink BWP of a downlink cell. On the other hand, a PRACH or a PRACH-Red is an uplink channel and may be thus included in an uplink BWP of an uplink cell. Therefore, in addition to the information of the CORESET-Red and search space-Red, time-frequency domain information for PRACH-Red transmission may be additionally required.

A PRACH may have a different subcarrier spacing to be used. For example, a PRACH may have a smaller subcarrier spacing in order to have a longer symbol length. 15 kHz, 30 kHz, 60 kHz, or 120 kHz is used for subcarrier spacings of a PUSCH and a PUCCH for transmitting uplink data or control information, whereas a subcarrier spacing of a PRACH may be 1.25 kHz or 5 kHz. Accordingly, signals or channels having different subcarrier spacings may coexist in an uplink cell. In this case, a guard band is required to suppress interference between signals or channels having subcarrier spacings adjacent to each other. Therefore, if a PRACH is distributed in time-frequency resources, uplink resources may be wasted due to the guard band. In order to prevent this, a PRACH used by a legacy type UE and a PRACH used by a RedCap UE need to be placed in time and frequency resources that are as close as possible.

Hereinafter, the present embodiment discloses a method for placing a PRACH of a legacy type UE and a PRACH-Red of a RedCap UE in adjacent time-frequency resources in an uplink cell.

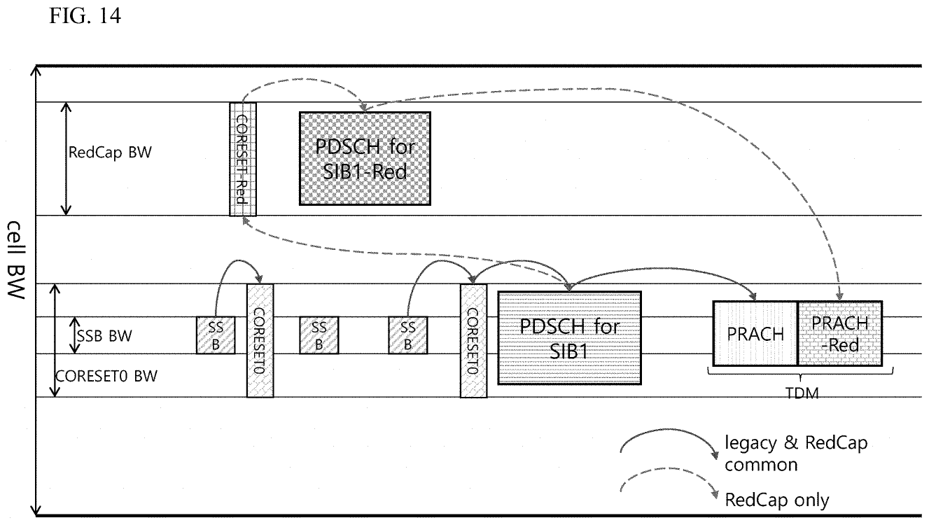

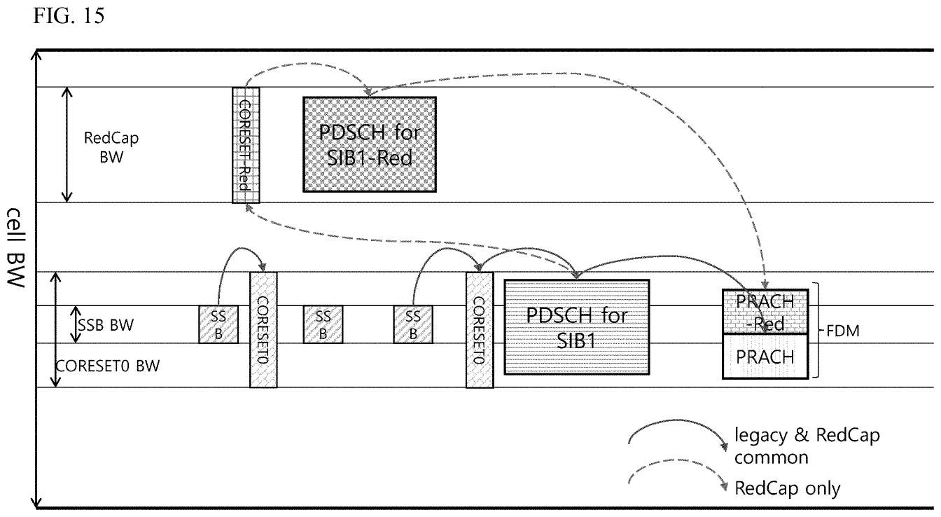

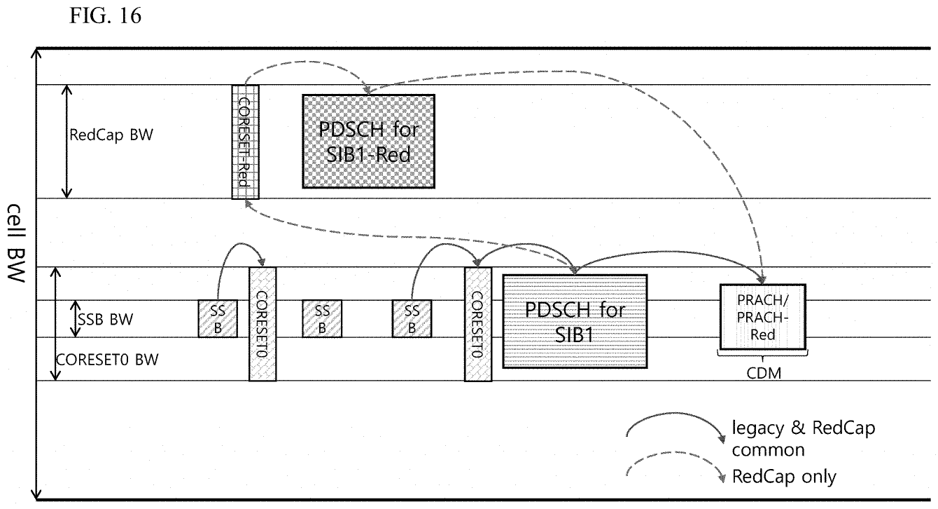

A first method is described with reference to FIG. 14, a second method is described with reference to FIG. 15, and a third method is described with reference to FIG. 16.

FIG. 14 is a diagram illustrating an initial cell access method and a PRACH resource configuration according to an embodiment of the present disclosure.

Referring to FIG. 14, a RedCap UE may determine that a PRACH-Red is located at a time adjacent to a PRACH of a legacy type UE (see TDM shown in FIG. 14). There may not be a separate configuration of frequency information for the PRACH-Red. In this case, frequency information of the PRACH-Red may be the same as frequency information of the PRACH. That is, a frequency occupied by the PRACH and a frequency occupied by the PRACH-Red may be the same. The RedCap UE may be configured with separate time information for the PRACH-Red.

Here, the time information may include information on whether the PRACH-Red is located immediately before or located immediately after the PRACH. If located immediately after the PRACH, the PRACH-Red may start at a time point immediately subsequent to a time point at which the PRACH ends (or a subsequent slot). If located immediately before the PRACH, the PRACH-Red may end at a time point immediately before a time point at which the PRACH starts (or a subsequent slot).

Alternatively, the time information may indicate a time difference between the PRACH and the PRACH-Red. More specifically, the time information may include a time difference or interval (the number of symbols or the number of slots) between the last time point of the PRACH and the first time point of the PRACH-Red. Alternatively, the time information may include a time difference or interval (the number of symbols or the number of slots) between the last time point of the PRACH-Red and the first time point of the PRACH. Alternatively, the time information may include a time difference or interval (the number of symbols or the number of slots) between the first time point of the PRACH and the first time point of the PRACH-Red.

FIG. 15 is a diagram illustrating an initial cell access method and a PRACH resource configuration according to another embodiment of the present disclosure.

Referring to FIG. 15, a RedCap UE may determine that a PRACH-Red is located at a frequency adjacent to a PRACH of a legacy type UE. There may not be a separate configuration of time information for the PRACH-Red. In this case, time information of the PRACH-Red may be the same as time information of the PRACH. That is, a time occupied by the PRACH (slot and symbol) and a time occupied by the PRACH-Red (slot and symbol) may be the same. The RedCap UE may be configured with separate frequency information for the PRACH-Red.

Here, the frequency information may include information on whether a frequency of the PRACH-Red is immediately below or is immediately above the PRACH.

Alternatively, the frequency information may indicate a frequency difference between the PRACH and the PRACH-Red. More specifically, the frequency information may include a frequency difference or interval (the number of subcarriers according to the units of subcarrier spacings of an uplink BWP of an uplink cell or the number of subcarriers according to the units of subcarrier spacings of the PRACH or the number pf PRBs) between a highest frequency of the PRACH and a lowest frequency of the PRACH-Red. Alternatively, the frequency information may include a frequency difference or interval (the number of subcarriers according to the units of subcarrier spacings of an uplink BWP of an uplink cell or the number of subcarriers according to the units of subcarrier spacings of the PRACH or the number pf PRBs) between a highest frequency of the PRACH-Red and a lowest frequency of the PRACH. Alternatively, the frequency information may include a frequency difference or interval (the number of subcarriers according to the units of subcarrier spacings of an uplink BWP of an uplink cell or the number of subcarriers according to the units of subcarrier spacings of the PRACH or the number pf PRBs) between a lowest frequency of the PRACH and a lowest frequency of the PRACH-Red.

FIG. 16 is a diagram illustrating an initial cell access method and a PRACH resource configuration according to another embodiment of the present disclosure.

Referring to FIG. 16, a RedCap UE may determine that a PRACH-Red is located at the same time-frequency as a PRACH of a legacy type UE. There may not be a separate configuration of time-frequency information for the PRACH-Red. In this case, time-frequency information of the PRACH-Red may be the same as time-frequency information of the PRACH. The RedCap UE may use some PRACHs among PRACHs at the time-frequency. For example, PRACHs of the legacy type UE may include multiple PRACH preamble sequences. In this case, some of the multiple PRACH preamble sequences may be used by the RedCap UE.

To this end, the RedCap UE may be configured with an index (or ID) of an available sequence among the PRACH preamble sequences. More specifically, the RedCap UE may be configured with a lowest index (or ID) among indices (or IDs) of available sequences, and may use sequences having the index (to ID) and an index (to ID) subsequent to the index (to ID).

As another example, the RedCap UE may be configured with the number of available sequences, and may use as many sequences as the number of available sequences having a high index (or ID) from among all sequences.

### (2) Second Embodiment

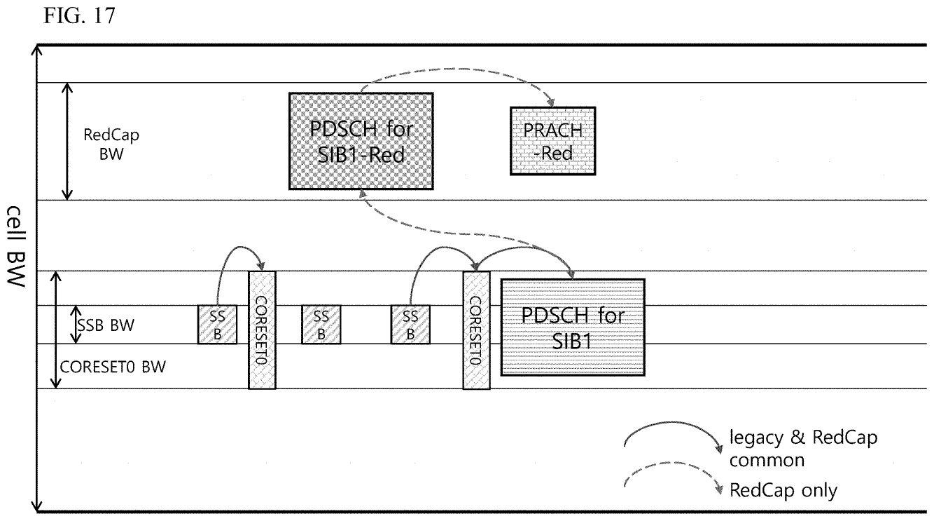

According to the second embodiment of the present disclosure, a RedCap UE may receive scheduling information of system information for initial cell access of the RedCap UE in SIB1. Here, the system information for initial cell access of the RedCap UE is referred to as SIB1-Red. This is illustrated in FIG. 17.

FIG. 17 is a diagram illustrating an initial cell access method according to another embodiment of the present disclosure.

Referring to FIG. 17, a RedCap UE may receive an SS/PBCH (or SSB) of a cell. The RedCap UE may receive information of a frequency domain of CORESET0 or information of a time domain of a Type-0 search space via the SS/PBCH. The RedCap UE may receive a PDCCH scrambled with an SI-RNTI in the Type-0 search space or CORESET0. The RedCap UE may receive DCI format 1_0 through the PDCCH. DCI format 1_0 may include scheduling information of a PDSCH delivering SIB1. Accordingly, the RedCap UE may receive SIB1 (indicated as PDSCH for SIB1 in FIG. 17).

SIB1 received by the RedCap UE may include information for cell access of a legacy type UE. The legacy type UE does not need to separately receive system information for the RedCap UE. Therefore, if the system information for the RedCap UE is added to existing SIB1, an overhead of SIB1 may increase. In order to prevent this, it is preferable that the system information required by the RedCap UE is transmitted separately. Therefore, SIB1 may include time-frequency information of the PDSCH on which the system information required by the RedCap UE may be received. The RedCap UE may receive the PDSCH according to the time-frequency information. The received PDSCH may include SIB1-Red (indicated as PDSCH for SIB1-Red in FIG. 17). The RedCap UE may receive information for initial cell access, by receiving SIB1-Red. For example, the RedCap UE may identify, based on SIB1-Red, the configuration of the PRACH-Red for initial cell access.

In order for the RedCap UE to be allocated with frequency resources (i.e., PRBs) on which the PDSCH for SIB1-Red is scheduled, the UE needs to identify an active downlink BWP (indicated as RedCap BW in FIG. 17) on which the PDSCH is scheduled. Therefore, the RedCap UE needs to be configured with the active downlink BWP.

As an example, the RedCap UE may be configured with a length and an index of a start PRB (PRB having a lowest frequency) of the active downlink BWP from SIB1. Here, the index of the PRB may be indicated by a common PRB index. Alternatively, the index of the PRB may be indicated by a frequency interval (the number of PRBs) from CORESET0. That is, since the RedCap UE has identified a frequency domain occupied by CORESET0, the start PRB of the active downlink BWP may be determined by adding a given frequency interval (the number of PRBs) to the frequency domain.

At least one value of 24 PRBs, 48 PRBs, and 96 PRBs may be configured as the length. As another example, the length may be equal to the number of PRBs included in CORESET0. In this case, information on the length of the active downlink BWP may be omitted in SIB1.

The RedCap UE may assume that a PDSCH delivering SIB1-Red is received within the configured active downlink BWP.

### (3) Third Embodiment

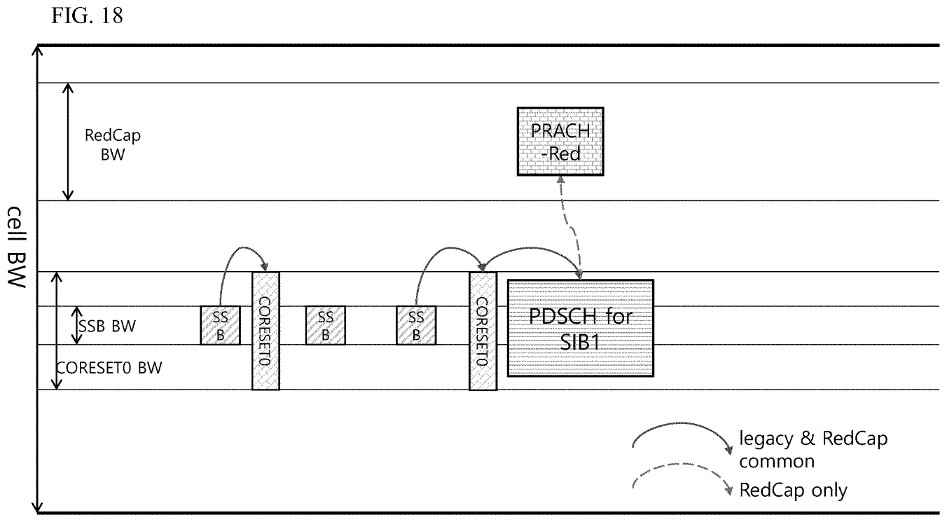

According to the third embodiment of the present disclosure, a RedCap UE may receive PRACH configuration information for initial cell access of the RedCap UE in SIB1. Here, a PRACH for initial cell access of the RedCap UE is referred to as PRACH-Red. This is illustrated in FIG. 18.

FIG. 18 is a diagram illustrating an initial cell access method according to another embodiment of the present disclosure.

Referring to FIG. 18, a RedCap UE may receive an SS/PBCH (or SSB) of a cell. The RedCap UE may receive information of a frequency domain of CORESET0 or information of a time domain of a Type-0 search space via the SS/PBCH. The RedCap UE may receive a PDCCH scrambled with an SI-RNTI in the Type-0 search space or CORESET0. The RedCap UE may receive DCI format 1_0 through the PDCCH. DCI format 1_0 may include PDSCH scheduling information for SIB1. Accordingly, the RedCap UE may receive SIB1 (indicated as PDSCH for SIB1 in FIG. 18).

SIB1 received by the RedCap UE may include information for cell access of a legacy type UE. In addition, SIB1 may additionally include system information for the RedCap UE. Therefore, the RedCap UE may acquire information on initial cell access of the RedCap UE via SIB1 without needing to receive separate system information (e.g., SIB1-Red in FIG. 17). For example, SIB1 may include PRACH-Red configuration information for initial cell access.

The RedCap UE may be configured with an uplink BWP for configuration of the PRACH-Red and cell access. The PRACH-Red may be transmitted in the uplink BWP. Therefore, the PRACH-Red configuration is included in the uplink BWP. The uplink BWP for the RedCap UE in SIB1 may be configured as follows.

### (4) Fourth Embodiment

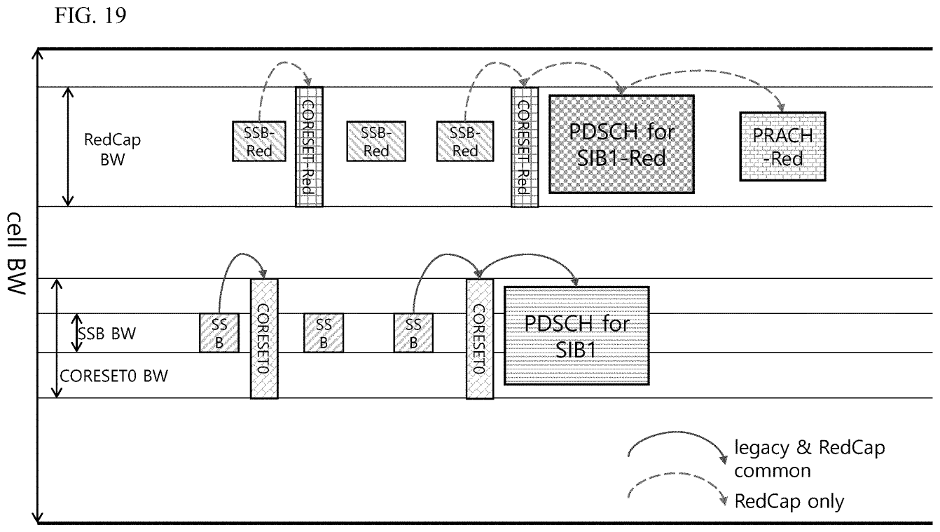

According to the fourth embodiment of the present disclosure, a RedCap UE may receive an SS/PBCH only for a RedCap UE. This may be distinguished from an SS/PBCH received by the legacy type UE. A distinguishing method will be described later. For convenience, an SS/PBCH that may be received only by a RedCap UE is referred to as SSB-Red. This is illustrated in FIG. 19.

FIG. 19 is a diagram illustrating an initial cell access method according to another embodiment of the present disclosure.

Referring to FIG. 19, a RedCap UE may receive an SSB-Red which is an SS/PBCH only for a RedCap UE in a BWP (indicated as RedCap BW in FIG. 19) only for a RedCap UE. By receiving the SSB-Red, the RedCap UE may obtain downlink signal synchronization and receive a cell ID and a master information block (MIB) transmitted in a PBCH. By receiving the SSB-Red, the RedCap UE may acquire configuration information of a CORESET-Red or a search space-red, in which a PDCCH for scheduling of a PDSCH that delivers SIB1-Red is to be monitored. The RedCap UE may monitor and receive the PDCCH in the CORESET-Red or the search space-red. By receiving the PDCCH, the RedCap UE may receive the PDSCH (indicated as PDSCH for SIB1-Red in FIG. 19) that delivers SIB1-Red. The RedCap UE may be configured with configuration information of a PRACH-Red for cell access from SIB1-Red, and may transmit a PRACH according to the configuration information of the PRACH-Red.

In the fourth embodiment, the RedCap UE needs to receive the SSB-Red in a separate BWP different from a downlink BWP of a legacy type UE. However, since the SSB-Red is received before cell access, the RedCap UE cannot identify a frequency and time at which the SSB-Red is transmitted. In addition, the RedCap UE should be able to distinguish an SS/PBCH and an SSB-Red received by the legacy type UE. A method for this is disclosed below.

A first method includes a procedure in which the RedCap UE performs an initial cell access procedure like a legacy type UE. For example, the RedCap UE may receive an SS/PBCH (or SSB) of a cell. The RedCap UE may receive information of a frequency domain of CORESET0 or information of a time domain of a Type-0 search space via the SS/PBCH. The RedCap UE may receive a PDCCH scrambled with an SI-RNTI by using information of the Type-0 search space or CORESET0. The RedCap UE may receive DCI format 1_0 through the PDCCH. DCI format 1_0 may include scheduling information of a PDSCH delivering SIB1. Accordingly, the RedCap UE may receive SIB1. SIB1 may include information of a frequency and time at which an SSB-Red is transmitted. That is, the UE may be configured, via SIB1, with information for reception of an SSB-Red for a RedCap UE.

The frequency of the SSB-Red may be indicated using an absolute radio frequency channel number (ARFCN). Alternatively, the frequency of the SSB-Red may be indicated by a common PRB index. Alternatively, the frequency of the SSB-Red may be indicated by an interval from a frequency of an SSB. Here, the interval may be indicated as a frequency. The interval may be indicated by the number of PRBs. The interval may be indicated by the number of subcarriers. The interval may be indicated by the number of channel rasters or the number of synchronization rasters between the SSB and the SSB-Red.

The time of the SSB-Red may be the same as that of the SSB. That is, the SSB and the SSB-Red may be transmitted at the same time (slot and symbol). As another example, the time of the SSB-Red and that of the SSB may have a certain time interval. For example, the certain time interval may be given as 5 ms (a half frame length). Through the predetermined time interval between the SSB and the SSB-Red, the RedCap UE may receive the SSB in a first time interval and may receive the SSB-Red in a second time interval. In this way, two synchronization blocks are received, and therefore downlink synchronization may be more accurately performed.

A second method includes an SSB-Red having a different structure from that of a legacy type UE.

As an example, the SSB-Red may be designed to include a larger frequency band in order to improve reception performance of the PBCH. For example, the SSB-Red may be designed to have 4 PRBs more compared to the SSB of the legacy type UE. That is, the SSB-Red may be designed to occupy 24 PRBs. More specifically, the SSB-Red may have 4 symbols. Among the four symbols, a PSS is transmitted in a first symbol, and an SSS is transmitted in a third symbol. In addition, the PBCH may be transmitted in 24 PRBs of a second symbol, 24 PRBs of a fourth symbol, and in resources other than a resource in which the SSS is mapped from among 24 PRBs of the third symbol. Although an example of 24 PRBs has been described in the above example, it may be extended to more PRBs.

The RedCap UE may receive the PSS and SSS to acquire downlink signal synchronization and a cell ID. In order to determine between an SS/PBCH (SSB) including 20 PRBs and an SS/PBCH (SSB-Red) designed to have more PRBs, the RedCap UE may perform PBCH decoding by making an assumption of having 20 PRBs and may perform PBCH decoding by making an assumption of being designed to have more PRBs. If PBCH decoding succeeds by making an assumption of having 20 PRBs, the UE may identify that the SS/PBCH is an SSB of a normal UE (legacy). If PBCH decoding succeeds by making an assumption of having more PRBs, the RedCap UE may identify that the SS/PBCH is an SSB-Red of RedCap.

As another example, the SSB-Red may be designed to include more symbols to improve reception performance of the PBCH. For example, the SSB-Red may be designed to have one or two more symbols than symbols of the legacy type UE. That is, the SSB-Red may be designed to include 5 to 6 symbols. A PSS is transmitted in a first symbol, and an SSS is transmitted in a third symbol. In addition, the PBCH may be transmitted in a second symbol and a fourth symbol, and the PBCH may be transmitted in a fifth symbol or a sixth symbol.

The RedCap UE may receive the PSS and the SSS to acquire downlink signal synchronization and a cell ID. In order to determine between an SS/PBCH (SSB) including four symbols and a PBCH (SSB-Red) designed to have more symbols, the RedCap UE may perform PBCH decoding by making an assumption of having four symbols and may perform PBCH decoding by making an assumption of being designed to have more symbols. If PBCH decoding succeeds by making an assumption of having four symbols, the UE may identify that the SS/PBCH is an SSB of a normal UE (legacy). If PBCH decoding succeeds by making an assumption of having more symbols, the RedCap UE may identify that the SS/PBCH is an SSB-Red of RedCap.

As another example, the SSB and the SSB-Red may be distinguished according to a sequence of symbols to which the SS/PBCH is mapped. For example, in the SSB-Red, unlike in the SSB, the PSS is located in the first symbol and the position of the SSS may be moved to the second symbol or the fourth symbol. If the SSS is moved to the second symbol, the PBCH may be transmitted in 20 PRBs of the third symbol, 20 PRBs of the fourth symbol, and PRBs which are not occupied by the SSS from among 20 PRBs of the second symbol. If the SSS is moved to the fourth symbol, the PBCH may be transmitted in 20 PRBs of the second symbol, 20 PRBs of the third symbol, and PRBs which are not occupied by the SSS from among 20 PRBs of the fourth symbol.

The RedCap UE may receive the PSS. In addition, the RedCap UE may determine a symbol in which the SSS is transmitted, so as to determine whether the SSB is an SSB of a legacy type UE or is an SSB-Red of a RedCap UE. If the SSS is received in the third symbol, the UE may identify that the SS/PBCH is an SSB of a normal UE (legacy). If the SSS is received in the second or fourth symbol, the UE may identify that the SS/PBCH is an SSB-Red of RedCap.

As another example, an SSB and an SSB-Red may be distinguished using a physical cell ID obtained from the SS/PBCH. For example, the SS/PBCH may have up to 1008 physical cell IDs. The RedCap UE may determine an SSB-Red in a case of a specific value among up to 1008 physical cell IDs. For example, the specific value may be a physical cell ID having a remainder of 0 when divided by 3. As another example, since a physical cell ID has a form of N^{cell}_{ID}=3*N⁽¹⁾_{ID}+N⁽²⁾_{ID}, an SSB-Red may be determined if N⁽¹⁾_{ID} or N⁽²⁾_{ID} is the specific value. As another example, the number of physical cell IDs available for the SS/PBCH may be increased to 1008 or more. In this case, the RedCap UE may determine that the SS/PBCH is an SSB-Red if the physical cell ID has a value of 1008 or greater.

As another example, an SSB and an SSB-Red may be distinguished according to an RE mapping sequence of the PBCH in the SS/PBCH. For example, if a PBCH of an SSB of a legacy type UE is in a first direction (e.g., mapping is performed in a sequence from a low frequency RE to a high frequency RE), a PBCH of an SSB-Red of a RedCap UE may be in a second direction (e.g., a reverse direction, in which mapping is performed in an RE sequence from a high frequency RE to a low frequency RE). Here, the second direction may be a direction different from the first direction. The UE may determine whether a corresponding SSB is an SSB of a legacy type UE or an SSB-Red of a RedCap UE, based on RE mapping of the PBCH.

The RedCap UE may receive the PSS and SSS to acquire downlink signal synchronization and a cell ID. In order to determine between an SS/PBCH (SSB) mapped in the first direction and a PBCH (SSB-Red) designed to be in the second direction, the RedCap UE may perform PBCH decoding by making an assumption of the first direction and may perform PBCH decoding by making an assumption of being designed to be in the second direction. If PBCH decoding succeeds by making an assumption of the first direction, the UE may identify that the SS/PBCH is an SSB of a normal UE (legacy). If PBCH decoding succeeds by making an assumption of the second direction, the UE may identify that the SS/PBCH is an SSB-Red of RedCap.

As another example, an SSB and an SSB-Red may be distinguished according to a CRC of the PBCH in the SS/PBCH. For example, if a PBCH of an SSB of a legacy type UE is scrambled with a first CRC, a PBCH of an SSB-Red of a RedCap UE may be scrambled with a second CRC different from the first CRC. The UE may determine whether a corresponding SSB is an SSB of a legacy type UE or an SSB-Red of a RedCap UE, by identifying a CRC value of the PBCH.

The RedCap UE may receive the PSS and SSS to acquire downlink signal synchronization and a cell ID. In order to determine between an SS/PBCH (SSB) scrambled with the first CRC and a PBCH (SSB-Red) scrambled with the second CRC, the RedCap UE may perform PBCH decoding by making an assumption of the first CRC and may perform PBCH decoding by making an assumption of the second CRC. If PBCH decoding succeeds by making an assumption of the first CRC, the UE may identify that the SS/PBCH is an SSB of a legacy type UE. If PBCH decoding succeeds by making an assumption of the second CRC, the UE may identify that the SS/PBCH is an SSB-Red of RedCap.

As another example, an SSB and an SSB-Red may be distinguished according to 1-bit of the PBCH in the SS/PBCH. The PBCH of the SSB of a legacy type UE may have unused 1 bit. Therefore, determination between an SSB of a legacy type UE or an SSB-Red of a RedCap UE may be made according to the value of 1 bit. For example, if the value of 1 bit in the PBCH is “0”, the RedCap UE may determine a corresponding SSB as an SSB of a legacy type UE, and if the value is “1”, a corresponding SSB may be determined as an SSB-Red of a RedCap UE.

In the previous example, the RedCap UE may determine between an SSB of a legacy type UE or an SSB-Red of a RedCap UE only after receiving the PSS, SSS, and PBCH. This may cause overhead and battery consumption for additional reception.

As another example, a frequency at which an SSB-Red is transmittable may be different from a frequency at which an SSB is transmitted. For example, the UE may receive an SSB at a certain frequency interval in order to receive a correct SSB. Here, the certain frequency interval may be defined as a synchronization raster. This may enable, in order to reduce battery consumption of the UE, reception of SSBs sparsely at a certain frequency interval (e.g., tens of kHz to hundreds of kHz) instead of receiving SSBs at all frequencies. A base station transmits an SSB at a certain frequency interval in order for the UE to properly receive the SSB. In other words, there may be a frequency band in which the UE does not perform SSB monitoring. The base station may transmit an SSB-Red in the frequency band, and the RedCap UE may receive the SSB-Red in the frequency band.

As another example, a time interval in which an SSB-Red is transmittable may be different from a time interval in which an SSB is transmitted. For example, in order to receive a correct SSB, the UE may receive an SSB within a 5 ms half frame of a 10 ms radio frame. In other words, there may be a time interval in which the UE does not perform SSB monitoring. For example, if an SSB is transmitted in a 5 ms half frame of a 10 ms radio frame, SSB monitoring is not performed in the remaining time interval. The base station may transmit an SSB-Red in the time interval, and the RedCap UE may receive the SSB-Red in the time interval.

### (5) Fifth Embodiment

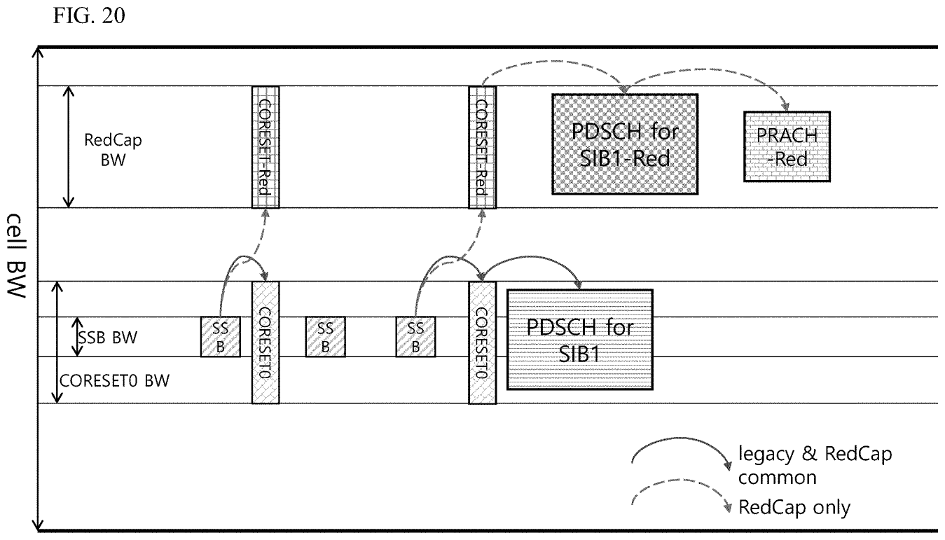

According to the fifth embodiment of the present disclosure, a RedCap UE may interpret information indicated by an SS/PBCH differently from a legacy type UE. Here, both a legacy type UE and a RedCap UE may receive an SS/PBCH. That is, a structure of the SS/PBCH may be the same as that of an SSB of a legacy type UE. This is illustrated in FIG. 20.

FIG. 20 is a diagram illustrating an initial cell access method according to another embodiment of the present disclosure.

Referring to FIG. 20, a legacy type UE and a RedCap UE may receive an SS/PBCH. By receiving a PSS and an SSS, downlink signal synchronization may be obtained and a physical cell ID may be received. A legacy type UE and a RedCap UE may receive a PBCH. In this case, the legacy type UE and the RedCap UE may interpret the PBCH in different ways.

The legacy type UE may receive configuration information of CORESET0 and configuration information of a Type-0 search space through 8 bits of the PBCH. 4 bits that represent frequency configuration information of CORESET0 may indicate one combination among 16 combinations. 4 bits that represent configuration information of the Type-0 search space may indicate one combination among 16 combinations. If the 4 bits indicate “0000”, it indicates a first combination among 16 combinations. In this way, via 4 bits and 4 bits, a total of 8 bits, the UE may receive a PDCCH for scheduling of a PDSCH that delivers SIB1.

The RedCap UE may interpret the 8 bits of the PBCH differently. 4 bits representing the configuration information of CORESET0 may be reinterpreted so as to be used as the configuration information of a CORESET-Red. That is, the configuration information of the CORESET-Red is indicated by 4 bits and may indicate one combination among 16 combinations. 4 bits representing the configuration information of the Type-0 search space may be reinterpreted so as to be used as the configuration information of a search space-Red.

For example, when 4 bits representing the configuration information of CORESET0 indicate “0000”, operations of the UE are as follows. If the UE is a legacy type UE, it is determined that the 4 bits indicate one combination among 16 combinations representing the configuration information of CORESET0. That is, if 4 bits show “0000”, this is determined to be a first combination among 16 combinations representing the configuration information of CORESET0. If the UE is a RedCap UE, it is determined that the 4 bits indicate one combination among 16 combinations representing the configuration information of the CORESET-Red. That is, if 4 bits show “0000”, this is determined to be a first combination among 16 combinations representing the configuration information of the CORESET-Red.

The UE may be indicated whether to perform the reinterpretation. For example, the RedCap UE may be indicated, using 1 bit of the PBCH, whether information received in the PBCH can be reinterpreted according to the RedCap UE. If the 1 bit is “0”, the RedCap UE should not reinterpret the information received in the PBCH. If the 1 bit is “1”, the RedCap UE may reinterpret the information received in the PBCH.

### (6) Sixth Embodiment

According to the sixth embodiment of the present disclosure, a RedCap UE may determine configuration information of a CORESET-Red, based on CORESET0. More specifically, the RedCap UE may acquire configuration information of CORESET0 by receiving an SS/PBCH. The RedCap UE may infer the configuration information of the CORESET-Red, based on the configuration information of CORESET0.

As an example, it may be assumed that the CORESET-Red starts in a symbol immediately subsequent to a symbol in which CORESET0 ends. Here, the CORESET-Red may have the same configuration as that of CORESET0. That is, the number of PRBs, the position of PRBs, or a CORESET length may be the same as that for CORESET0. It may be assumed that the CORESET-Red starts in a slot immediately subsequent to a slot to which CORESET0 belongs. Here, the CORESET-Red may have the same configuration as that of CORESET0. That is, the number of PRBs, the position of PRBs, or a CORESET length may be the same as that of CORESET0. A position of a symbol in which the CORESET-Red starts within a slot may be the same as a position at which CORESET0 starts within a slot. Here, an immediately subsequent symbol or an immediately subsequent slot is described, but this may be further extended so that a symbol after a certain number of symbols or a slot after a certain number of slots may be applied. In addition, it has been described that the CORESET-Red is located only subsequent to CORESET0, but on the contrary, the CORESET-Red may be located before CORESET0.

As another example, it may be assumed that the CORESET-Red starts in a PRB immediately above a PRB in which CORESET0 ends. Here, the CORESET-Red may have the same configuration as that of CORESET0. That is, the number of PRBs or a CORESET length may be the same as that for CORESET0. Here, it has been described that the CORESET-Red starts in an immediately above PRB, but this may be further extended so that the CORESET-Red may start after a certain number of PRBs. The CORESET-Red may be located immediately below a PRB in which CORESET0 starts.

### (7) Seventh Embodiment

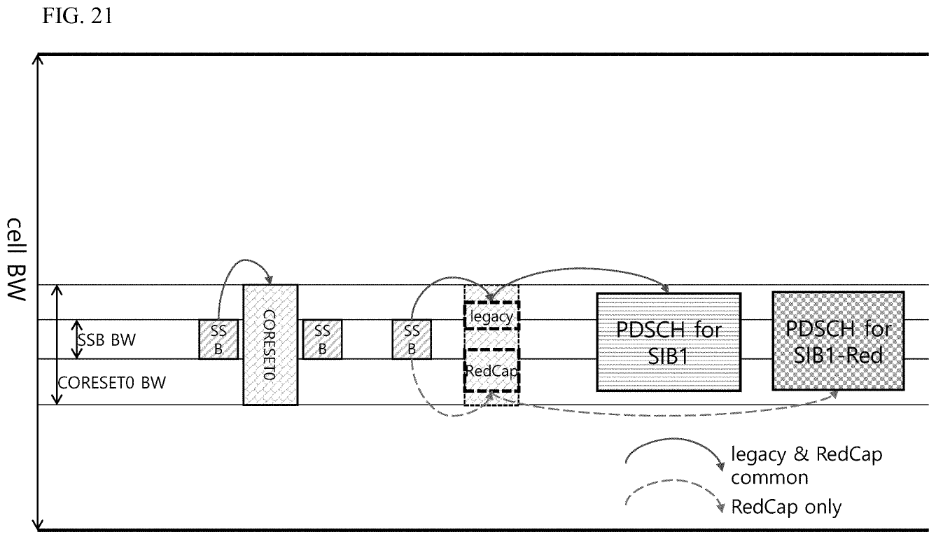

In the seventh embodiment of the present disclosure, a legacy type UE and a RedCap UE may monitor different PDCCH candidates in CORESET0. Here, CORESET0 is indicated in an SS/PBCH. A legacy type UE and a RedCap UE may equally receive CORESET0 configuration information without distinction. This is illustrated in FIG. 21.

FIG. 21 is a diagram illustrating an initial cell access method according to another embodiment of the present disclosure.

Referring to FIG. 21, a legacy type UE may receive a PDCCH for scheduling of SIB1 in CORESET0. This PDCCH may deliver DCI format 1_0.

A RedCap UE may receive a PDCCH delivering SIB1-Red in CORESET0. This PDCCH may deliver DCI format X. A method of configuring DCI format X is as follows.

In a first method, lengths of DCI format 1_0 and DCI format X may be different from each other. That is, since the legacy type UE blind-decodes DCI format 1_0 which is a first length, the legacy type UE may receive DCI format 1_0 but may not receive DCI format X. Conversely, since the RedCap UE blind-decodes DCI format X which is a second length, the RedCap UE may receive DCI format X but may not receive DCI format 1_0. The RedCap UE may additionally blind-decode DCI format 1_0, which is the first length, to receive DCI format 1_0, and may receive SIM scheduled by DCI format 1_0.

In a second method, CRCs of DCI format 1_0 and DCI format X may be scrambled with different values. For example, the CRC of DCI format 1_0 is scrambled with an SI-RNTI, but the CRC of DCI format X may be scrambled with a value different from the SI-RNTI. That is, since the legacy type UE blind-decodes DCI format 1_0 scrambled with the SI-RNTI, the legacy type UE may receive DCI format 1_0 but may not receive DCI format X. Conversely, since the RedCap UE blind-decodes DCI format X scrambled with a different value, the RedCap UE may receive DCI format X but may not receive DCI format 1_0. The RedCap UE may additionally blind-decode DCI format 1_0 scrambled with the SI-RNTI to receive DCI format 1_0 and may receive SIB1 scheduled by DCI format 1_0.

In a third method, the legacy type UE and the RedCap UE may receive DCI format 1_0 and DCI format X, and DCI format 1_0 and DCI format X may be distinguished by a 1-bit indicator. The 1-bit indicator may be located at the same position in DCI format 1_0 and DCI format X. If a 1-bit value is “0”, DCI format 1_0 is determined, and if the 1-bit value is “1”, DCI format X may be determined. Although descriptions have been provided using 1 bit for convenience, DCI format 1_0 and DCI format X may be distinguished by multiple bits or may be determined by a combination of specific code points.

II. PRACH Configuration and RAR Reception Method of RedCap UE

The present embodiment relates to a method of multiple PRACH configurations and random-access response (RAR) reception due to multiple PRACH configurations in an initial cell access and random-access procedure of a UE.

In general, a UE may receive one PRACH configuration for random access from a base station via an SIB. For reference, a system information block may configure one uplink initial BWP. Here, the initial uplink BWP is a BWP used by the UE during a random-access procedure. The one uplink initial BWP includes one PRACH configuration.

The PRACH configuration may include at least one piece of the following information.
Slots in which PRACH occasions are transmitted in the time domain
Symbol in which a PRACH occasion starts within a slot in which a PRACH occasion is transmitted in the time domain
Subcarrier in which a PRACH occasion is located in the frequency domain
Number of PRACH occasions, i.e., a set of PRACH occasions in the frequency domain
Sequence used by preambles in a code area

Here, one PRACH occasion may include up to 64 preambles. Each preamble may be assigned with an index of one of 0, 1, . . . , 63.

The base station may configure an additional uplink carrier to provide higher coverage to the UE. This is referred to as a supplementary UL carrier (SUL carrier). The base station may configure a PRACH also for an SUL, and the UE may access an uplink cell through the PRACH of the SUL. For reference, the SIB may configure one uplink initial BWP for the SUL. Here, the initial uplink BWP is a BWP used by the UE during a random-access procedure. One PRACH configuration may be included in the one initial uplink BWP.

Hereinafter, in the present disclosure, in order to distinguish between an SUL carrier and a normal uplink carrier, a normal uplink carrier is referred to as a normal UL carrier (NUL carrier). Unless otherwise specified, embodiments disclosed in the present disclosure may be applied without a difference of NUL/SUL.

If a UE receives both a PRACH configuration in an NUL carrier and a PRACH configuration in an SUL carrier, the UE is able to perform random access through a PRACH of the NUL carrier and perform random access through a PRACH of the SUL carrier. That is, the UE may perform a random-access procedure by transmitting one of the PRACH of the NUL carrier and the PRACH of the SUL carrier to the base station.

The UE may select one preamble based on the PRACH information and may transmit the selected preamble to the base station. Thereafter, a rough procedure of random access is as follows.

The UE may monitor a PDCCH transmitted from the base station for a predetermined time after transmission of the preamble. Here, the UE may monitor a PDCCH scrambled with an RA-RNTI. Here, an RA-RNTI value is a value determined according to the preamble transmitted by the UE, and a method of obtaining a specific RA-RNTI value will be described later. When the PDCCH scrambled with the RA-RNTI is received, the UE may receive a PDSCH scheduled by the PDCCH. The PDSCH may a TC-RNTI value and information for scheduling of a message 3 PUSCH. The UE may transmit the message 3 PUSCH to the base station according to the scheduling information. The UE may receive a PDCCH for scheduling a message 4 PDSCH from the base station. Here, the PDCCH may be scrambled with the TC-RNTI value. When the PDCCH scrambled with the TC-RNTI value is received, the UE may receive the message 4 PDSCH scheduled by the PDCCH, and may transmit HARQ-ACK to the base station depending on whether the PDSCH is successfully received.

A method by which the UE obtains an RA-RNTI in the random-access procedure described above is as follows.

RA-RNTI=1+s_id+14×t_id+14×80×f_id+14×80×8×ul_carrier_id [Equation 1]

Where s_id is an index of a first OFDM symbol of a PRACH occasion (0≤s_id<14), t_id is an index of a first slot of a PRACH occasion in a system frame (0≤t_id<80), f_id is an index of a PRACH occasion in the frequency domain (0≤f_id<8), and ul_carrier_id is an index of an uplink carrier used for random-access preamble transmission (0 for NUL carrier, and 1 for SUL carrier).

The UE and the base station may obtain an RA-RNTI based on Equation 1. If two UEs transmit preambles in different PRACH occasions, at least one value of s_id, t_id, or f_id for each UE is different. Therefore, since the two UEs having transmitted the preambles in different PRACH occasions monitor PDCCHs scrambled with different RA-RNTIs, it is possible to distinguish the preambles and the corresponding PDCCHs. In addition, even if different UEs have the same s_id, t_id, and fid, if one UE transmits a preamble in an NUL carrier and the other UE transmits a preamble in an SUL carrier, the two UEs may monitor PDCCHs scrambled with different RA-RNTIs according to ul_carrier_id values. Accordingly, the preambles of the two UEs and the corresponding PDCCHs may be distinguished.

A case where RA-RNTI values of two UEs are the same is a case where preambles are transmitted in a PRACH occasion having the same s_id, t_id, or f_id in the same carrier (one of NUL and SUL). In this case, if the preambles transmitted by the two UEs in a PRACH occasion are different from each other, the preambles may be distinguished according to IDs of the preambles. More specifically, since the two UEs have the same RA-RNTI value, the two UEs monitor PDCCHs scrambled with the same RA-RNTI value. If the two UEs receive the PDCCHs scrambled with the RA-RNTI value, PDSCHs scheduled by the PDCCHs may be received. Here, the PDSCHs may include random-access preamble identifiers (RAPIDs). If the RAPIDs are the same as indices of the preambles transmitted by the UEs themselves, the UEs may identify that random-access responses (RARs) correspond to the preambles transmitted thereby. Therefore, the two UEs having transmitted the different preambles may be distinguished via the RAPIDs.

In this way, each UE may receive an RAR transmitted thereto, based on the index of the preamble and the PRACH occasion of the PRACH transmitted by the UE itself. However, there may be a case where the UE cannot determine an RAR transmitted thereto, based on the index of the preamble and the PRACH occasion of the PRACH transmitted by the UE itself. An embodiment that solves this problem is disclosed below.

In order to support a new type of UE such as a RedCap UE, the base station may additionally configure a new PRACH configuration for the RedCap UE. Hereinafter, for convenience, a PRACH configuration for a legacy type UE is referred to as a legacy PRACH configuration, and a newly configured PRACH configuration for a RedCap UE is referred to as a new PRACH configuration. The ground or motive that a base station provides a new PRACH configuration to a RedCap UE is as follows.
Ground 1: A base station may perform scheduling schemes differently during a random-access procedure depending on a UE type. For example, the base station may repetitively transmit a PDSCH including an RAR and a message 4 PDSCH including message 4 in order to increase downlink coverage of a RedCap UE. In addition, the base station may indicate repetitive transmission of a message 3 PUSCH including message 3 in order to increase uplink coverage of the RedCap UE. As described above, for scheduling for a RedCap UE, a base station needs to identify a UE type. This is possible by a RedCap UE transmitting a PRACH according to a separate new PRACH configuration.
Ground 2: A base station may use a different PRACH format depending on a UE type. For example, a PRACH format with high coverage may be used to increase uplink coverage of a RedCap UE, and a normal UE may use a PRACH format with low coverage. To this end, a separate new PRACH configuration may be provided to a RedCap UE.
Ground 3: In general, the number of RedCap UEs may be greater than the number of normal UEs. For this reason, when normal UEs and RedCap UEs perform random access according to the same PRACH configuration, random access by a small number of normal UEs becomes difficult due to random-access attempts by a large number of RedCap UEs. Therefore, in order to ensure successful random access of a normal UE, random access of a RedCap UE and random access of a normal UE need to be separated. This is possible by providing a separate new PRACH configuration of the RedCap UE.
Ground 4: For a RedCap UE, there is an application that periodically transmits data. For example, a wireless sensor transmits measured data at regular intervals. Therefore, the UEs are highly likely to attempt random access periodically. A base station can reduce PRACH overhead via a PRACH configuration suitable for a characteristic of a RedCap UE. To this end, a new PRACH configuration may be provided to a RedCap UE.

Hereinafter, a method by which a base station provides a new PRACH configuration to a RedCap UE is disclosed.

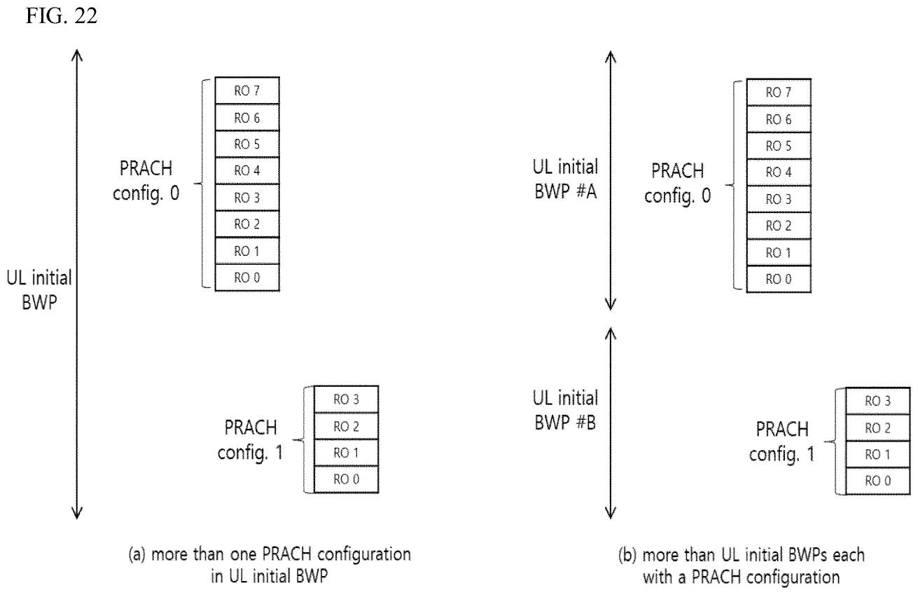

FIG. 22 shows diagrams illustrating PRACH resource configurations according to another embodiment of the present disclosure. FIG. 22A is a diagram relating to a first method, and FIG. 22B is a diagram relating to a second method.

According to the first method, a RedCap UE may receive a new PRACH configuration via an SIB transmitted from a base station.

More specifically, the SIB may configure one uplink initial BWP for one uplink cell (NUL or SUL). Here, the uplink initial BWP is a BWP used by the UE during a random-access procedure, and may also be referred to as an initial uplink BWP. The one uplink initial BWP may include an existing legacy PRACH configuration and a new PRACH configuration. For reference, there may be one or multiple new PRACH configurations. For convenience, if there are multiple new PRACH configurations, indices may be assigned to distinguish respective new PRACH configurations. For convenience, the indices may start from 0.

According to the second method, a RedCap UE may receive multiple initial uplink BWPs via an SIB transmitted from a base station. Here, each uplink initial BWP may include a PRACH configuration. More specifically, the SIB may configure an existing uplink initial BWP and a new uplink initial BWP for one uplink cell (NUL or SUL). Here, each uplink initial BWP may include one PRACH configuration. Specifically, the existing uplink initial BWP may include a legacy PRACH configuration, and the new uplink initial BWP may include a new PRACH configuration. The UE may select one of the multiple uplink initial BWPs so as to transmit a PRACH. In this case, the selected uplink initial BWP is a BWP used by the UE during a random-access procedure. For reference, there may be one or multiple new uplink initial BWPs. For convenience, if there are multiple new uplink initial BWPs, indices may be assigned to distinguish new PRACH configurations of respective new uplink initial BWPs. For convenience, the indices may start from 0.

Based on the first method or the second method, a RedCap UE may be provided with one or multiple new PRACH configurations. Here, the RedCap UE may perform random access via one PRACH configuration among the multiple new PRACH configurations.

It is assumed that the base station has provided a legacy PRACH configuration and one new PRACH configuration for the UE. One of two UEs may transmit a preamble according to the legacy PRACH configuration, and the other UE may transmit a preamble according to the new PRACH configuration. According to the legacy PRACH configuration and the new PRACH configuration, the preambles transmitted by the two UEs may differ in at least one of time, frequency, and code, and accordingly, the base station may distinguish the preambles transmitted by the two UEs. Therefore, the base station needs to transmit an RAR for random access to each of the two UEs.

As described above, the UE may determine an RAR that the UE itself needs to receive, by using the index of the preamble or an RA-RNTI corresponding to its own preamble. However, if one UE transmits a preamble according to the legacy PRACH configuration and the other UE transmits a preamble according to the new PRACH configuration, the two UEs cannot determine RARs to be received, in the following situations.

For example, if s_id, t_id, and f_id of the preamble selected according to the legacy PRACH configuration of one UE and s_id, t_id, and f_id of the preamble selected according to the new PRACH configuration of the other UE are the same, the two UEs monitor PDCCHs for scheduling of RARs based on the same RA-RNTI value. In this case, if an index of the preamble selected by one UE according to the legacy PRACH configuration and an index of the preamble selected by the other UE according to the new PRACH configuration are the same, the two UEs determine the RAR with the same RAPID. Therefore, the two UEs determine the RAR as their own RAR, and thus have the same message 3 PUSCH scheduling grant and TC-RNTI value.

Hereinafter, since a problem may occur when a base station provides a new PRACH configuration as described above, and methods for solving this problem are disclosed below.

According to the first method, an RA-RNTI value may be determined according to a preamble of which PRACH configuration has been transmitted. If the UE transmits the preamble of the legacy PRACH configuration, the UE may determine the RA-RNTI value as follows.

RA-RNTI=1+s_id+14×t_id+14×80×f_id+14×80×8 [Equation 2]

Where s_id is an index of a first OFDM symbol of a PRACH occasion (0≤s_id<14), t_id is an index of a first slot of a PRACH occasion in a system frame (0 ≤t_id<80), f_id is an index of a PRACH occasion in the frequency domain (0≤f_id<8), and ul_carrier_id is an index of an uplink carrier used for random-access preamble transmission (0 for NUL carrier, and 1 for SUL carrier).

The UE may perform a simplified random-access procedure based on the new PRACH configuration in order to reduce latency of a random-access procedure based on the legacy PRACH configuration. This procedure is referred to as a 2-step random-access procedure. For convenience, the PRACH configuration in the 2-step random-access procedure is referred to as a 2-step PRACH. The 2-step random-access procedure is roughly as follows.

The UE may transmit, to the base station, one preamble and data selected using PRACH information configured for the 2-step random-access procedure. Then, the UE may monitor a PDCCH transmitted from the base station for a certain period of time. Here, the UE may monitor a PDCCH scrambled with an MsgB-RNTI. Here, an MsgB-RNTI value is a value determined according to the preamble transmitted by the UE, and a method of obtaining a specific MsgB-RNTI value will be described later. When the PDCCH scrambled with the MsgB-RNTI is received, the UE may receive a PDSCH scheduled by the PDCCH, and may transmit HARQ-ACK to the base station depending on whether the PDSCH is successfully received.

The described MsgB-RNTI may be interpreted as an RA-RNTI of the UE performing the 2-step random-access procedure. Therefore, if an index of the preamble selected by one UE according to the 2-step PRACH configuration is the same as an index of the preamble selected according to the new PRACH 5 configuration, the two UEs determine RARs with the same RAPID, and thus a problem that the UEs cannot determine the RARs to be received thereby occurs.

If the UE transmits the preamble of the 2-step PRACH configuration, the UE may determine the MsgB-RNTI value as follows.

MsgB-RNTI−1+s_id+14×t_id+14×80×f_id+14×80×8×ul_carrier_id+14×80×8×2 [Equation 3]

Where s_id is an index of a first OFDM symbol of a PRACH occasion (0≤s_id<14), t_id is an index of a first slot of a PRACH occasion in a system frame (0 ≤t_id<80), f_id is an index of a PRACH occasion in the frequency domain (0≤f_id<8), and ul_carrier_id is an index of an uplink carrier used for random-access preamble transmission (0 for NUL carrier, and 1 for SUL carrier).

In an aspect, if the UE transmits the preamble of the new PRACH configuration, the UE may determine an RA-RNTI value as follows.

RA-RNTI=X+1+s_id+14×t_id+14×80×f_id+14×80×8×(new PRACH configuration index) [Equation 4]

Here, a new PRACH configuration index is an index assigned to each new PRACH configuration and may start from 0. X may be determined according to a maximum value that Equation 2 for obtaining RA-RNTI may have. If s_id=13, t_id=79, f_id=7, and ul_carrier_id=1 are possible, X=17920, which is a maximum value obtainable according to Equation 2, may be determined.

The RA-RNTI obtained according to this example has the following characteristics.

If the UE transmits the preamble of the legacy PRACH configuration, a value of RA-RNTI is one value among 1 to X=17920 according to Equation 2. If the UE transmits the preamble of the new PRACH configuration, a value of RA-RNTI is a value greater than or equal to X+1 according to Equation 4. Accordingly, the UE having transmitted the preamble of the legacy PRACH configuration and the UE having transmitted the preamble of the new PRACH configuration may monitor PDCCHs with different RA-RNTI values. Therefore, the base station may schedule different RARs for the two UEs by using the different RA-RNTIs.

In another aspect, an equation for obtaining RA-RNTI may be expressed as follows.

RA-RNTI=1+s_id+14×t_id+14×80×f_id+14×80×8×ID [Equation 5]

Here, contents indicated by ID are as follows.
ID=0: legacy PRACH in NUL carrier
ID=1: legacy PRACH in SUL carrier
ID=2: new PRACH having first index
ID=3: new PRACH having second index
ID= . . .

In this example, when multiple new PRACH configurations are provided, a maximum number of the new PRACH configurations is 5. That is, an index of the new PRACH is one of 0, 1, 2, 3, and 4. For reference, the first index is a lowest index, and the second index is a second lowest index. Here, an index may be uniquely assigned in each new PRACH. The index may be configured via a higher layer signal (or RRC signal) for selecting of each new PRACH, or may be derived according to a configuration of each new PRACH. The index may be derived based on at least one of time information and frequency information of the new PRACH configuration.

In another aspect, if the UE transmits the preamble of the new PRACH configuration, the UE may determine an RA-RNTI value as follows.

RA-RNTI=X+1+s_id+14×t_id+14×80×f_id14×80×8(new PRACH configuration index) [Equation 6]

Here, a new PRACH configuration index is an index assigned to each new PRACH configuration and may start from 0. X may be determined according to a maximum value that Equation 3 for obtaining an RA-RNTI may have. If s_id=13, t_id=79, f_id=7, and ul_carrier_id=1 are possible, X=35840 may be determined according to Equation 3.

The RA-RNTI obtained according to this example has the following characteristics.

If the UE transmits the preamble of the new PRACH configuration, a value of RA-RNTI is one value among 1 to X=35840 according to Equation 3. If the UE transmits the preamble of the new PRACH configuration, a value of RA-RNTI is a value greater than or equal to X+1 according to Equation 6. Accordingly, the UE having transmitted the preamble of the legacy PRACH configuration and the UE having transmitted the preamble of the new PRACH configuration may monitor PDCCHs with different RA-RNTI values. Therefore, the base station may schedule different RARs for the two UEs by using the different RA-RNTIs.

In another aspect, an equation for obtaining RA-RNTI may be expressed as follows.

RA-RNTI=1+s_id+14×t_id+14×80×f_id+14λ80λ8λID [Equation 7]

Here, contents indicated by ID are as follows.
ID=0: legacy PRACH in NUL carrier
ID=1: legacy PRACH in SUL carrier
ID=2: 2-step PRACH in NUL carrier
ID=3: 2-step PRACH in SUL carrier
ID=4: new PRACH having first index
ID=5: new PRACH having second index

In the embodiment, when multiple new PRACH configurations are provided, a maximum number of the new PRACH configurations is 2. That is, an index of the new PRACH is one of 0 and 1. For reference, the first index is a lowest index, and the second index is a second lowest index. Here, an index may be uniquely assigned in each new PRACH. The index may be configured via a higher layer signal (or RRC signal) for selecting of each new PRACH, or may be derived according to a configuration of each new PRACH. The index may be derived based on at least one of time information and frequency information of the new PRACH configuration.

For reference, the RedCap UE may be configured, via an SIB, with a method of calculating RA-RNTI. For example, it may be configured, via the SIB, to use one of Equations 4 or 6 (or Equation 5 or 7). As another example, even if there is no separate indication in the SIB, it may be configured to use one of Equation 4 or 6 (or Equation 5 or 7) according to a 2-step RACH configuration. For example, if a 2-step RACH is configured, an RA-RNTI value may be calculated by Equation 6 (or Equation 7), and otherwise, an RA-RNTI value may be calculated by Equation 4 (or Equation 5). Furthermore, only when the 2-step RACH has been configured and a PRACH resource of the 2-step RACH overlaps with a PRACH resource of the RedCap UE, an RA-RNTI value is calculated by Equation 6 (or Equation 7), and otherwise, an RA-RNTI value may be calculated by Equation 4 (or Equation 5).

According to the second method, a search space for monitoring of a PDCCH may be determined differently depending on a preamble of which PRACH configuration has been transmitted. If the UE transmits the preamble of the legacy PRACH configuration, the UE may monitor the PDCCH, based on the RA-RNTI value in a first search space in order to receive an RAR. If the UE transmits the preamble of the new PRACH configuration, the UE may monitor the PDCCH, based on the RA-RNTI value in a second search space in order to receive an RAR. Here, the RA-RNTI value may be determined based on Equation 1 for obtaining RA-RNTI. That is, different UEs may all monitor PDCCHs with the same RA-RNTI value, but may receive RARs corresponding to the preambles transmitted by the UEs themselves, by monitoring the PDCCHs in different search spaces.

More specifically, the UE may be signaled as follows. The UE may receive a new PRACH configuration for random access and a search space configuration corresponding to the new PRACH configuration via the SIB transmitted from the base station. Here, via the search space configuration, the UE may identify the following information.
Slot in which a search space is configured according to period and offset information
Number of consecutive slots in which the search space is configured
Symbol in which a search space starts within a slot
PDCCH aggregation level (AL) to be monitored in a search space and the number of PDCCH candidates per AL
DCI format which needs to be monitored in a search space

The search space corresponding to the new PRACH configuration is associated with CORESET #0. Therefore, a search space corresponding to the preamble of the legacy PRACH configuration and a search space corresponding to the preamble of the new PRACH configuration may be associated with the same CORESET #0, and may thus have the same frequency domain information, CCE-to-REG mapping, and CORESET duration.

If a separate search space corresponding to a new PRACH is not configured, the UE may monitor a PDCCH for RAR reception in a search space corresponding to the legacy PRACH. In this case, when the PDCCH is monitored, an RA-RNTI value may be based on the equations for obtaining RA-RNTI, which are proposed in the first method or Equation 1 for obtaining RA-RNTI.

According to the third method, a CORESET for monitoring of the PDCCH may be determined differently depending on a preamble of which PRACH configuration has been transmitted by the UE. If the UE transmits the preamble of the legacy PRACH configuration, the UE may monitor the PDCCH, based on an RA-RNTI value in a search space of a first CORESET in order to receive an RAR. If the UE transmits the preamble of the new PRACH configuration, the UE may monitor the PDCCH, based on an RA-RNTI value in a search space of a second CORESET in order to receive an RAR. Here, the RA-RNTI value may be determined based on Equation 1 for obtaining RA-RNTI. That is, the UE monitors the PDCCH with the same RA-RNTI value, but may receive an RAR corresponding to the preamble transmitted by the UE itself, by monitoring the PDCCH in search spaces of different CORESETs.

More specifically, the UE may be signaled as follows. The UE may receive a new PRACH configuration for random access and a CORESET configuration corresponding to the new PRACH configuration via the SIB transmitted from the base station. Here, via the CORESET configuration, the UE may identify the following information.
Frequency information where CORESET is located. This may be identified in units of sets of 6 consecutive PRBs.
Mapping between REG and CCE included in CORESET. This may be either localized mapping or distributed mapping.
Number of symbols included in CORESET. This may be 1 symbol or may be 2 or 3 consecutive symbols.

According to the fourth method, a downlink (DL) initial BWP for random access may be determined differently depending on a preamble of which PRACH configuration has been transmitted by the UE. If the UE transmits the preamble of the legacy PRACH configuration, the UE may monitor the PDCCH, based on an RA-RNTI value in a first downlink initial BWP in order to receive an RAR. If the UE transmits the preamble of the new PRACH configuration, the UE may monitor the PDCCH, based on an RA-RNTI value in a second downlink initial BWP in order to receive an RAR. Here, the RA-RNTI value may be determined based on Equation 1 for obtaining RA-RNTI. In each downlink initial BWP, the CORESET and search space for monitoring of the PDCCH may be configured. That is, the UE monitors the PDCCH with the same RA-RNTI value, but may receive an RAR corresponding to the preamble transmitted by the UE itself, by monitoring the PDCCH in different initial downlink BWPs.

III. Frequency Hopping Method of RedCap UE

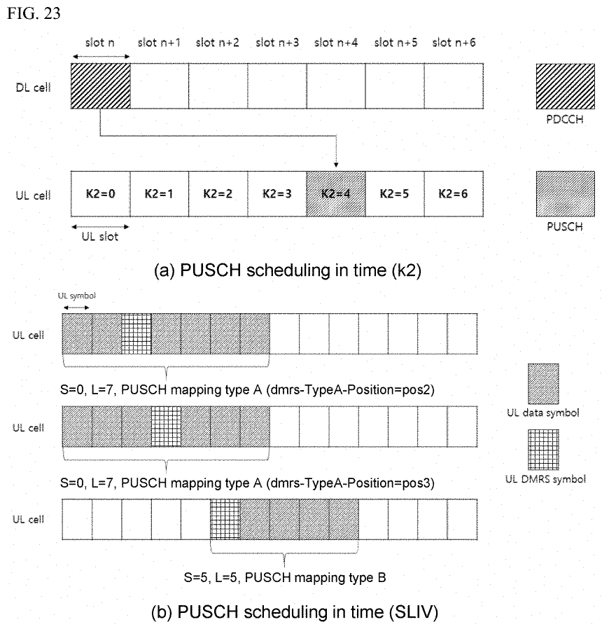

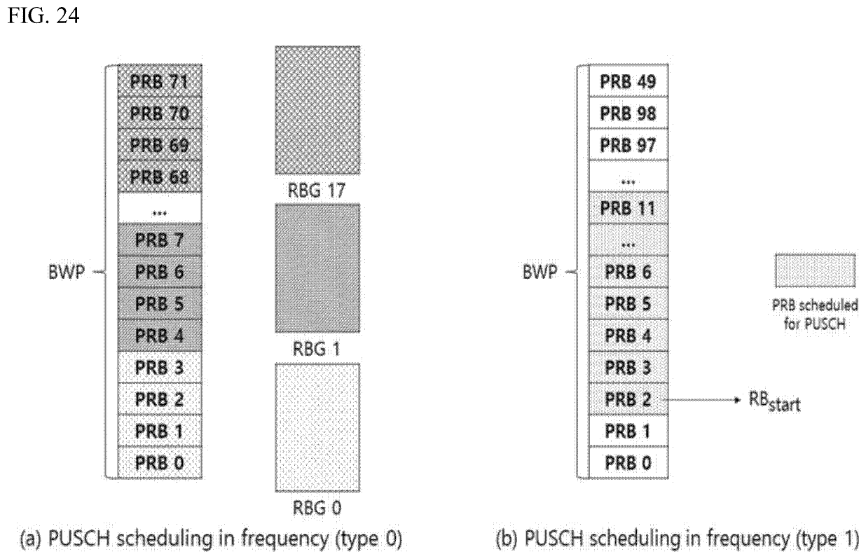

FIG. 23 shows diagrams illustrating scheduling of a physical uplink shared channel in the time domain, and FIG. 24 shows diagrams illustrating scheduling of a physical uplink shared channel in the frequency domain.

Based on FIG. 23 and FIG. 24, a method by which a UE transmits a physical uplink shared channel (PUSCH) will be described.

A UE may transmit uplink data through a physical uplink shared channel. A UE may transmit uplink data using a method (dynamic grant (DG)) of scheduling transmission of a physical uplink shared channel in downlink control information (DCI) delivered via reception of a physical downlink control channel (PDCCH) or a method (configured grant (CG)) of transmitting a physical uplink shared channel according to a resource and transmission method preconfigured from a base station.

Downlink control information (DCI) delivered via PDCCH reception of the UE may include PUSCH scheduling information. This scheduling information may include time domain information (hereinafter, time-domain resource assignment (TDRA)) and frequency domain information (frequency-domain resource assignment (FDRA)). The UE may interpret the DCI delivered via PDCCH reception, based on a control resource set and search space information, and may perform an operation indicated by the DCI. The DCI may include one of DCI format 0_0, 0_1, or 0_2 for scheduling of a physical uplink shared channel (PUSCH).

Time domain information of the PUSCH indicated by a TDRA field in DCI format 0_0, 0_1, or 0_2 includes the following. K2 is an offset value between a slot in which the PDCCH is received from the base station and a slot in which the UE transmits the PUSCH. A start and length indication value (SLIV) is a value obtained by joint-coding a start symbol index (S) of the PUSCH and a symbol length (L) of the PUSCH in a slot indicated by K2.

When DCI format 0_0, 0_1, or 0_2 for scheduling of the PUSCH is received in slot n, the UE makes a determination as slot floor(n*2^{μPUSCH}/n*2^{μPDCCH})+K2. Where, μPUSCH and μPDCCH are subcarrier spacings (SCSs) of a cell in which the PUSCH is scheduled and a cell in which the PDCCH is received, respectively.

For example, referring to FIG. 23A, the subcarrier spacing of the cell in which the PDCCH is received and that of the cell in which the PUSCH is scheduled are the same, and therefore when the UE receives the PDCCH in slot n, for example, when the UE receives an indication that a K2 value is 4, the UE determines that the slot in which the PUSCH is scheduled is slot n+K2=n+4.

Two mapping types of A and B may be applied to the physical uplink shared channel transmitted by the UE. The SLIV obtained by joint-encoding of the start symbol index and the symbol length of the PUSCH has a different value range depending on a PUSCH mapping type. In PUSCH mapping type A, only resource allocation including a DMRS symbol is possible, and the DMRS symbol is located in a third or a fourth OFDM symbol of a slot according to a value indicated by a higher layer. That is, in the case of PUSCH mapping type A, a start symbol index (S) of the PUSCH is 0, and a length (L) of the PUSCH may have one of values from 4 to 14 (12 for an extended CP) according to the position pf the DMRS symbol. In the case of PUSCH mapping type B, a DMRS symbol is always a first symbol of the PUSCH, and therefore S may have a value from 0 to 13 (11 for the extended CP), and L may have one of values from 1 to 14 (12 for the extended CP). In addition, one PUSCH cannot cross a slot boundary, and thus the values of S and L need to satisfy S+L14 (12 for the extended CP).

FIG. 23B illustrates PUSCH examples according to PUSCH mapping types. Sequentially starting from the top, the UE determines that a mapping type A PUSCH in which a third symbol is a DMRS symbol, a start symbol index (S) is 0, and a length (L) is 7, a mapping type A PUSCH in which a fourth symbol is a DMRS symbol, a start symbol index (S) is 0, and a length (L) is 7, and a mapping type B PUSCH in which a first symbol is a DMRS symbol, a start symbol index (S) is 5, and a length (L) is 5 are scheduled. The frequency domain information of the PUSCH indicated by the FDRA field in DCI format 0_0, 0_1, or 0_2 may be divided into two types according to frequency resource allocation types.

A first type is frequency resource allocation type 0, in which a resource block group (RBG) is generated by combining a fixed number of PRBs according to the number of RBs included in a BWP configured for the UE, and the UE is indicated with a bitmap in units of RBGs so as to determine whether to use the RBG. The number of PRBs included in one RBG is configured from a higher layer, and as the number of RBs included in the BWP configured for the UE becomes larger, the more PRBs are configured. For example, referring to FIG. 24A, when a BWP size configured for the UE is 72 PRBs and one RBG includes 4 PRBs, the UE determines four PRBs as one RBG in ascending order from PRB 0. That is, if mapping is performed up to RBG 17 according to a sequence in which RBG 0 includes PRB 0 to PRB 3 and RBG 1 includes PRB 4 to PRB 7, the UE receives 1 bit (0 or 1) per RBG, a total of 18 bits, so as to determine whether to use PRBs in a corresponding RBG. In this case, if a bit value is 0, the UE determines that a PUSCH is not scheduled in any of PRBs in the RBG, and if a bit value is 1, the UE determines that a PUSCH is scheduled in all PRBs in the RBG. Alternatively, the bit values may be applied in reverse.

A second type is frequency resource allocation type 1, and may indicate information on consecutive PRBs allocated according to the size of an active BWP or an initial BWP of the UE. This information is a resource indication value (MV) obtained by joint-encoding of a start index (S) and a length (L) of consecutive PRBs. For example, referring to FIG. 24B, if a BWP size of the UE is 50 PRBs and a PUSCH is scheduled from PRB 2 to PRB 11, a start index of consecutive PRBs is 2 and a length thereof is 10. By receiving RIV=N^{size}_{BWP}*(L−1)+S=50*(10−1)+2=452, the UE may determine that the start index and the length of the consecutive PRBs for which the PUSCH is scheduled are 2 and 10, respectively.

Only for DCI format 0_1 or 0_2 for scheduling of the PUSCH, the UE may be configured, from a higher layer, to use only one of two frequency resource allocation types of the PUSCH or dynamically use the two types. If configured to dynamically use the two types, the UE may determine one of the types via 1 bit of a most significant bit (MSB) of an FDRA field in DCI format 0_1 or 0_2 for scheduling of the PUSCH.

A grant (configured grant)-based uplink shared channel transmission scheme configured to support uplink URLLC transmission, etc. is supported, and this scheme is also referred to as grant-free transmission. The configured grant-based uplink transmission scheme is a scheme in which, when the base station configures, for the UE via a higher layer, i.e., RRC signaling, a resource available for uplink transmission, the UE transmits an uplink shared channel through the corresponding resource. This scheme may be divided into two types according to the availability of activation or release via DCI.

A type 1-configured grant-based transmission scheme is a scheme for configuring a resource and a transmission scheme for grant-based transmission pre-configured in a higher layer.

A type 2-configured grant-based transmission scheme is a scheme of configuring grant-based transmission configured in a higher layer, wherein a resource and a scheme for transmission are indicated from DCI delivered through a physical downlink control channel.

The configured grant-based uplink transmission scheme may support URLLC transmission, and repetitive transmission is thus supported in multiple slots so as to ensure high reliability. In this case, a redundancy version (RV) sequence is configured with one of {0, 0, 0, 0}, {0, 2, 3, 1}, and {0, 3, 0, 3}, and in n-th repetitive transmission, an RV corresponding to a (mod(n−1, 4)+1)th value is used. The UE configured with repetitive transmission may start repetitive transmission only in a slot having an RV value of 0. However, if an RV sequence is {0, 0, 0, 0}, and repetitive transmission is performed in 8 slots, repetitive transmission cannot be started in an 8th slot. The UE terminates repetitive transmission when the number of repetitive transmissions configured in a higher layer is reached, when a period is over, or when a UL grant having the same HARQ process ID is received. Here, the UL grant refers to DCI for scheduling of a PUSCH.

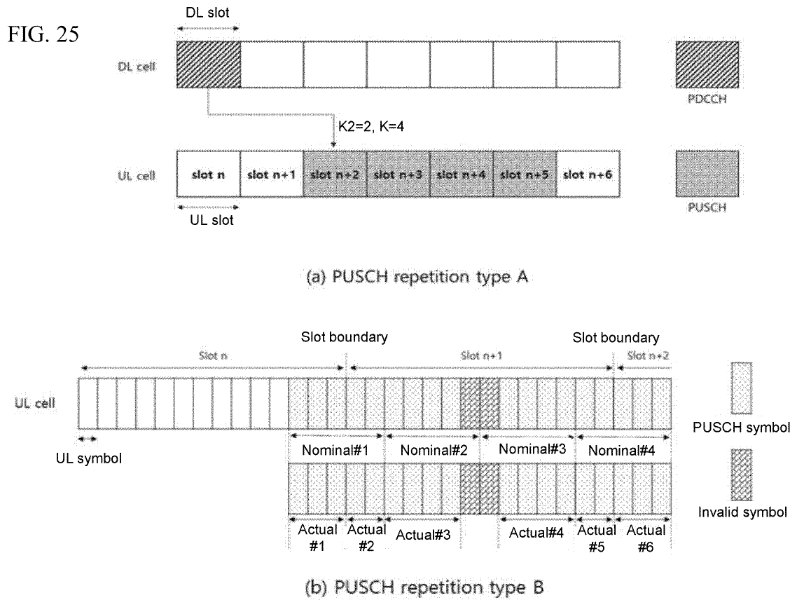

In order to improve reception and transmission reliability of a physical uplink shared channel between a base station and a UE in a wireless communication system, the UE may be configured with repetitive transmission of the uplink shared channel from the base station. This is described by referring to FIG. 25.

FIG. 25 shows diagrams illustrating repetitive transmission of a physical uplink shared channel according to an example.

Referring to FIG. 25, PUSCH repetitive transmission that a UE is able to perform may be divided into two types.

First, a transmission procedure of PUSCH repetitive transmission type A of a UE is as follows. When a UE receives DCI format 0_1 or 0_2 from a base station through a PDCCH for scheduling of a PUSCH, PUSCH repetitive transmission is possible in K consecutive slots. Here, the UE may be configured with a K value from a higher layer, or the K value may be added to a TDRA field of DCI so as to be received. For example, referring to FIG. 25A, if it is assumed that the UE receives the PDCCH for scheduling of the PUSCH in slot n, and receives 2 as a K2 value and 4 as a K value from the DCI format received through the PDCCH, the UE starts transmitting the PUSCH in slot n+K2, i.e., n+2, and the UE repetitively transmits the PUSCH from slot n+2 to slot n+2+K−1, i.e., n+5. In this case, time and frequency resources in which the PUSCH is transmitted in each slot are the same as those indicated by the DCI. That is, the PUSCH may be transmitted in the same symbol and PRB(s) within a slot.

Subsequently, a UE transmission procedure of PUSCH repetitive transmission type B for supporting low-latency PUSCH repetitive transmission in order to satisfy URLLC requirements and the like is as follows. The UE may be indicated, from the base station, a start symbol (S) of the PUSCH and a length (L) of the PUSCH via the TDRA field. Here, the PUSCH obtained using the indicated start symbol and length is not an actual PUSCH but a temporarily obtained PUSCH, and is referred to as a nominal PUSCH. In addition, the UE may be indicated with a nominal number (N) of repetitions of the indicated nominal PUSCH via the TDRA field. The UE may determine as many nominal number (N) of repetitions as nominal PUSCHs including the nominal PUSCH indicated via the TDRA field. Here, as many nominal number (N) of repetitions as nominal PUSCHs have the same length, i.e., L, and the nominal PUSCHs are consecutive on the time axis without a separate symbol.

The UE may determine, from among the nominal PUSCHs, an actually transmitted (actual) PUSCH. One nominal PUSCH may be determined based on one or multiple actually transmitted (actual) PUSCHs. The base station may indicate or configure, for the UE, symbols unavailable in PUSCH repetitive transmission type B. This is referred to as an invalid symbol. The UE may exclude invalid symbols from the nominal PUSCHs. As mentioned above, the nominal PUSCHs are determined continuously in symbols, but may be discontinuously determined when an invalid symbol is excluded. Actually transmitted (actual) PUSCHs may be determined based on consecutive symbols in one nominal PUSCH excluding an invalid symbol. Here, if successive symbols cross a slot boundary, the actually transmitted (actual) PUSCHs may be divided and determined based on the boundary.

For reference, the invalid symbol may at least include a DL symbol configured for the UE by the base station.

For example, referring to FIG. 25B, it is assumed that the UE is scheduled with PUSCH transmission having a length of 5 symbols starting from a 12th OFDM symbol of a first slot (slot n), and is indicated with four times of type B repetitive transmission. Nominal PUSCHs are as follows. A first nominal PUSCH (nominal #1) includes symbol (n,11), symbol (n,12), symbol (n,13), symbol (n+1,0), and symbol (n+1,1). A second nominal PUSCH (nominal #2) includes symbol (n+1,2), symbol (n+1,3), symbol (n+1,4), symbol (n+1,5), and symbol (n+1,6). A third nominal PUSCH (nominal #3) includes symbol (n+1,7), symbol (n+1,8), symbol (n+1,9), symbol (n+1,10), and symbol (n+1,11). A fourth nominal PUSCH (nominal #4) includes symbol (n+1,12), symbol (n+1,13), symbol (n+2,0), symbol (n+2,1), and symbol (n+2,2). Here, symbol (n,k) denotes symbol k of slot n. A symbol k index starts from 0 to 13 for a normal CP, and is from 0 to 11 for an extended CP.

It is assumed that invalid symbols are configured or indicated in symbol 6 and symbol 7 of slot n+1. According to the invalid symbols configured or indicated by the base station, a last symbol of the second nominal PUSCH (nominal #2) is excluded, and a first symbol of the third nominal PUSCH (nominal #3) is excluded.

The first nominal PUSCH (nominal #1) is divided into two actually transmitted (actual) PUSCHs (actual #1 and actual #2) by a slot boundary. The second nominal PUSCH (nominal #2) and the third nominal PUSCH (nominal #3) are divided into respective actually transmitted (actual) PUSCHs (actual #3 and actual #4) by combining consecutive symbols except for an invalid symbol. Finally, the fourth nominal PUSCH (nominal #4) is divided into two actually transmitted (actual) PUSCHs (actual #5 and actual #6) by a slot boundary. The UE finally transmits actually transmitted (actual) PUSCHs.

One actually transmitted (actual) PUSCH needs to include at least one DMRS symbol, and when PUSCH repetitive transmission type B is configured, an actually transmitted (actual) PUSCH having a full length of one symbol may be omitted without being transmitted. This is because information other than DMRS cannot be transmitted in a case of an actually transmitted (actual) PUSCH having one symbol.

In order to obtain diversity gain in the frequency domain, frequency hopping may be configured for the UE.

For PUSCH repetitive transmission type A, one of intra-slot frequency hopping of performing frequency hopping within a slot and inter-slot frequency hopping of performing frequency hopping for each slot may be configured for the UE. If intra-slot frequency hopping is configured for the UE, the UE divides a PUSCH in half in the time domain in a slot for PUSCH transmission so as to transmit a half of the PUSCH in a scheduled PRB, and transmits the other half in a PRB obtained by adding an offset value to the scheduled PRB. In this case, two or four offset values are configured according to an active BWP size via a higher layer, and one of the values may be indicated to the UE via DCI. If inter-slot frequency hopping is configured for the UE, the UE transmits a PUSCH in a scheduled PRB in a slot having an even-numbered slot index, and transmits a PUSCH in a PRB obtained by adding an offset value to a scheduled PRB in an odd-numbered slot.

For PUSCH repetitive transmission type B, one of inter-repetition frequency hopping of performing frequency hopping at a nominal PUSCH boundary and inter-slot frequency hopping of performing frequency hopping in each slot may be configured. If inter-repetition frequency hopping is configured for the UE, the UE transmits an actually transmitted (actual) PUSCH(s) corresponding to an odd-numbered nominal PUSCH in a scheduled PRB, and transmits an actually transmitted (actual) PUSCH(s) corresponding to an even-numbered nominal PUSCH in a PRB obtained by adding an offset value to the scheduled PRB. In this case, two or four offset values are configured according to an active BWP size via a higher layer, and one of the values may be indicated to the UE via DCI. If inter-slot frequency hopping is configured for the UE, the UE transmits, in a scheduled PRB, an actually transmitted (actual) PUSCH of a slot having an even-numbered slot index, and transmits an actually transmitted (actual) PUSCH of an odd-numbered slot, in a PRB obtained by adding an offset value to the scheduled PRB.

When performing PUSCH repetitive transmission, if a symbol scheduled for PUSCH transmission overlaps, in a specific slot, with a semi-statically configured DL symbol or a symbol position configured for SS/PBCH block reception, the UE does not perform PUSCH transmission overlapping in the corresponding slot and does not delay transmission to a subsequent slot.

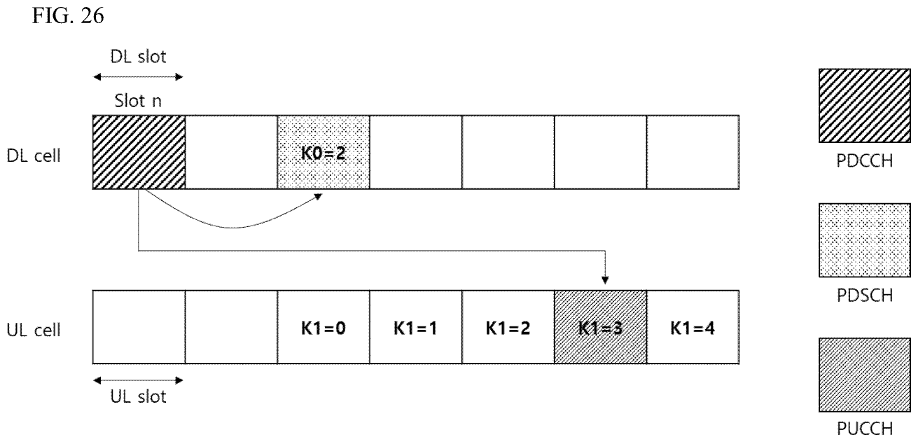

Based on FIG. 26, a method by which a UE transmits a physical uplink control channel (PUCCH) will be described.

FIG. 26 is a diagram illustrating scheduling of a physical uplink control channel.

Referring to FIG. 26, when a UE receives DCI format 1_0, 1_1, or 1_2 for scheduling of a physical uplink control channel, the UE needs to transmit a scheduled uplink control channel. The physical uplink control channel may include uplink control information (UCI), and the UCI may include HARQ-ACK, SR, and CSI information. The HARQ-ACK information may be two types of HARQ-ACK information on whether channels have been successfully received. A first type may indicate HARQ-ACK for whether reception of a physical downlink shared channel (PDSCH) is successful, when the physical downlink shared channel (PDSCH) is scheduled via DCI format 1_0, 1_1, or 1_2. A second type may indicate HARQ-ACK for whether reception of DCI format 1_0, 1_1, or 1_2 is successful, when DCI format 1_0, 1_1, or 1_2 is DCI indicating release of a semi-static physical downlink shared channel (SPS PDSCH).

In order to transmit a PUCCH for delivering of HARQ-ACK, a PDSCH-to-HARQ feedback timing indicator field included in DCI format 1_0, 1_1, or 1_2 may indicate a K1 value that is a value for information on a slot in which a scheduled uplink control channel needs to be transmitted. Here, the K1 value may be a non-negative integer value. The K1 value of DCI format 1_0 may indicate one value among {0, 1, 2, 3, 4, 5, 6, 7}. The K1 value that can be indicated by DCI format 1_1 or 1_2 may be configured or set from a higher layer.

The UE may determine a slot for transmission of an uplink control channel including HARQ-ACK information of the first type, as follows. The UE may determine an uplink slot overlapping with a last symbol of a physical downlink shared channel (PDSCH) corresponding to the HARQ-ACK information. When an index of the uplink slot is m, the uplink slot in which the UE transmits the physical uplink control channel including the HARQ-ACK information may be m+K1. Here, the index of the uplink slot is a value based on a subcarrier spacing of an uplink BWP in which the uplink control channel is transmitted.

For reference, if the UE is configured with downlink slot aggregation, an ending symbol indicates a last symbol of the PDSCH scheduled in a last slot among slots in which the physical downlink shared channel (PDSCH) is received.

Referring to FIG. 26, it is assumed that a subcarrier spacing of a DL BWP in which a PDCCH is received, a subcarrier spacing of a DL BWP in which a PDSCH is scheduled, and a subcarrier spacing of a UL BWP in which a PUCCH is transmitted are the same. It is assumed that a UE receives a PDSCH and a PDCCH for scheduling of a PUCCH from a base station in slot n, wherein DCI delivered by the PDCCH indicates that K0=2 and K1=3. If the last symbol of the PDSCH has been received in slot n+K0, i.e., n+2, the UE needs to transmit HARQ-ACK of the PDSCH through the PUCCH in slot n+2+K1, i.e., n+5.

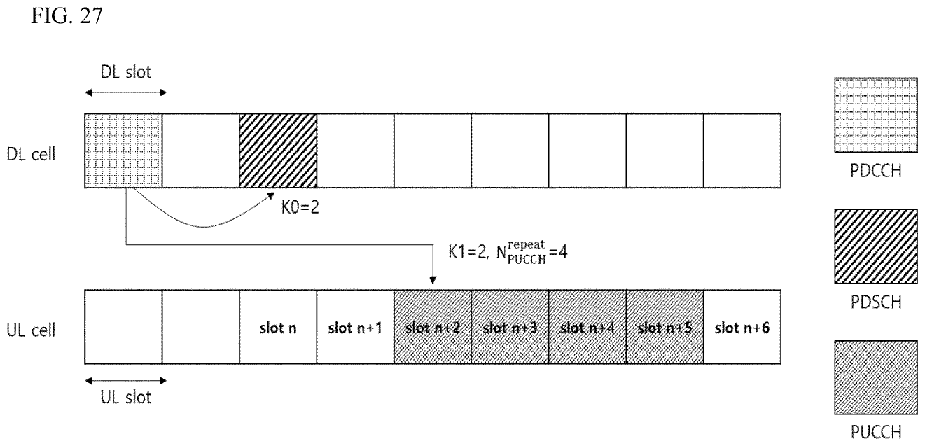

In order to secure wide coverage in the NR system, the UE may be configured to repetitively transmit long PUCCH (PUCCH formats 1, 3, and 4) in 2, 4, or 8 slots. If the UE is configured to repetitively transmit the PUCCH, the same UCI is repetitively transmitted in every slot. This will be described with reference to FIG. 27.

FIG. 27 is a diagram illustrating repetitive transmission of a physical uplink control channel.

Referring to FIG. 27, when PDSCH reception ends in slot n, and K1=2, a UE 5 transmits a PUCCH in slot n+K1, that is, n+2. In this case, if the number of PUCCH repetitive transmissions is configured and set as N^{repeat}_{PUCCH}=4 for the UE, the PUCCH is repetitively transmitted from slot n+2 to slot n+5. Symbol configurations of repetitively transmitted PUCCHs are the same. That is, repetitively transmitted PUCCHs start from the same symbol in each slot and include the same number of symbols.

In order to obtain diversity gain in the frequency domain, frequency hopping may be configured for the UE. Intra-slot frequency hopping of performing frequency hopping within a slot and inter-slot frequency hopping of performing frequency hopping for each slot may be configured. If intra-slot frequency hopping is configured for the UE, the UE divides the PUCCH in half in the time domain in a slot for PUCCH transmission, so as to transmit a half of the PUCCH in a first PRB and transmit the other half in a second PRB. In this case, the first PRB and the second PRB may be configured for the UE via a higher layer for configuring of PUCCH resources. When inter-slot frequency hopping is configured for the UE, the UE transmits the PUCCH in the first PRB in a slot having an even-numbered slot index, and transmits the PUCCH in the second PRB in a slot having an odd-numbered slot index.

When PUCCH repetitive transmission is performed, if a symbol required for PUCCH transmission overlaps, in a specific slot, with a semi-statically configured DL symbol or a symbol position configured for reception of an SS/PBCH block, the UE does not transmit the PUCCH in the corresponding slot and delays the transmission to a subsequent slot so that, if the PUCCH symbol does not overlap with the semi-statically configured DL symbol or the symbol position configured for reception of the SS/PBCH block in the corresponding slot, the UE transmits the PUCCH.

When transmitting the PUSCH or the PUCCH, the UE may perform transmission using a frequency hopping scheme so as to obtain frequency diversity gain. Here, the frequency hopping scheme refers to transmitting a PUSCH or PUCCH in a zeroth PRB set and transmitting a PUSCH or PUCCH in a first PRB set. For reference, in the description of the present disclosure, the PUSCH or PUCCH transmitted in the zeroth PRB set is referred to as hop 0, and the PUSCH or PUCCH transmitted in the first PRB set is referred to as hop 1. In the present disclosure, only up to two hops (hop 0 and hop 1) are described, but the number of hops may be further increased.

When the UE transmits a PUSCH or PUCCH, a method of determining a zeroth PRB set of hop 0 and a first PRB set of hop 1 is as follows.

For the PUCCH before an RRC connection, determinations may be made as follows. For reference, the PUCCH before the RRC connection is a PUCCH for transmission of HARQ-ACK which is a PDSCH reception success response including Msg4.

The UE selects one PUCCH resource from among 16 PUCCH resources. In this case, the selection is determined based on a PUCCH resource indicator included in a DCI format for scheduling of the PUCCH or an index of a control channel element (CCE) in which the DCI format has been received. If an index of the selected PUCCH resource is r_{PUCCH}, the index may have a value of 0, 1, . . . , 15.

If r_{PUCCH} is one value among 0, 1, . . . , 7, the index of the zeroth PRB set of hop 0 of the selected PUCCH resource is RB_{BWP}^{offset}+ [symbol] r_{PUCCH}/N_{CS} [symbol] , and the index of the first PRB set of hop 1 is N_{BWP}^{size}−1−RB_{BWP}^{offset}− [symbol] r_{PUCCH}/N_{CS} [symbol] . If r_{PUCCH} is one value among 8, 9, . . . , 15, the index of the zeroth PRB set of hop 0 of the selected PUCCH resource is RB_{BWP}^{size}−1−RB_{BWP}^{offset}− [symbol] (r_{PUCCH}−8)/N_{CS} [symbol] , and the index of the first PRB set of hop 1 is RB_{BWP}^{offset}+ [symbol] (r_{PUCCH}−8)/N_{CS} [symbol] .

Here, N^{size}_{BWP} is the number of PRBs included in an active BWP for transmission of the PUCCH. Here, if the PUCCH transmits HARQ-ACK of an Msg4 PDSCH, the active BWP is an initial UL BWP. This initial UL BWP is a UL BWP for cell access by the UE, and is configured in a system information block (SIB1). N_{CS} is the number of initial cyclic shift indices, and RB_{BWP}^{offset} and the initial cyclic shift index are as shown in Table 4.

TABLE 4

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | [symbol] N_{BWP}^{size}/4 [symbol] | {0, 3, 6, 9} |

Here, if the index of the RB at which the zeroth PRB set of hop 0 starts is 0, this indicates the lowest PRB of the active BWP of the UE. For reference, if the PUCCH transmits HARQ-ACK of the Msg4 PDSCH, the active BWP is an initial UL BWP. That is, the index of the RB at which the zeroth PRB set of hop 0 starts is interpreted as the index of the initial UL BWP.

For the PUCCH after the RRC connection, determinations may be made as follows.

The index of the lowest PRB of the zeroth PRB set of hop 0 and the index of the lowest PRB of the first PRB set of hop 1 of the PUCCH may be configured as PUCCH resources for the UE via an RRC signal. That is, if indicated with one PUCCH resource, the UE may transmit hop 0 and hop 1 by using the index of the lowest PRB of the zeroth PRB set of hop 0 and the index of the lowest PRB of the first PRB set of hop 1, which are configured in the PUCCH resource. Here, if the index of the PRB is 0, this indicates the lowest PRB of the active BWP of the UE. That is, the index of the PRB is interpreted as the index of the active BWP of the UE.

For the PUSCH, determinations may be made as follows.

The UE may determine the zeroth PRB set of hop 0 via DCI for scheduling of the PUSCH or a DCI/RRC signal for activation of the PUSCH. Here, the DCI for scheduling of the PUSCH or the DCI/RRC signal for activation of the PUSCH may include a frequency domain resource assignment (FDRA) field. The FDRA field may include the index of the RB at which the zeroth PRB set of hop 0 starts and the number of consecutive RBs. Here, if the index of the RB at which the zeroth PRB set of hop 0 starts is 0, this indicates the lowest PRB of the active BWP of the UE. That is, the index of the RB at which the zeroth PRB set of hop 0 starts is interpreted as the index of the active BWP of the UE. The UE needs to determine the index of the RB at which the first PRB set of hop 1 starts. This may be determined via the following equation.

RBₛₜₐᵣₜ(1)=(RBₛₜₐᵣₜ(0)+RB_{offset})mod N_{BWP}^{size}

Here, RBₛₜₐᵣₜ(0) denotes the index of the RB at which the zeroth PRB set of hop 0 starts, and RBₛₜₐᵣₜ(1) indicates the index of the RB at which the first PRB set of hop 1 starts. RB_{offset} denotes a PRB gap between the zeroth PRB set of hop 0 and the first PRB set of hop 1. The base station may configure and indicate RB_{offset} for the UE, and a value of the RB_{offset} may be one of 0, 1, . . . , N_{BWP}^{size}−1. N_{BWP}^{size} denotes the number of PRBs included in the active BWP of the UE. If the index of the RB at which the first PRB set of hop 1 starts is 0, wherein the index is obtained using the equation, this indicates the lowest PRB of the active BWP of the UE. That is, the index (RBₛₜₐᵣₜ(1)) of the RB at which the first PRB set of hop 1 starts is interpreted as the index of the active BWP of the UE.

When the PUSCH transmits Msg3, RB_{offset} may have one of the following values. If the size of the initial UL BWP is less than 50 RBs, RB_{offset} may be one value among and [symbol] N_{BWP}^{size}/2 [symbol] and [symbol] N_{BWP}^{size}/4 [symbol] , and if the size of the initial UL BWP is greater than 50 RBs, RB_{offset} may be one value among [symbol] N_{BWP}^{size}/2 [symbol] . [symbol] N_{BWP}^{size}/4 [symbol] , and [symbol] N_{BWP}^{size}/4 [symbol] . Here, for the Msg3 PUSCH, since the initial UL BWP is an active BWP, N_{BWP}^{size} is the number of RBs included in the initial UL BWP.

In the frequency hopping scheme described above, the zeroth PRB set of hop 0 and the first PRB set of hop 1 are located within the active BWP. For reference, in cases of the PUSCH (i.e., Msg3 PUSCH) and PUCCH (i.e., PUCCH transmitting HARQ-ACK of the Msg4 PDSCH) before the RRC connection, the active BWP is the initial UL BWP. However, the UE may require frequency hopping in a frequency band other than an active BWP in the following situations.

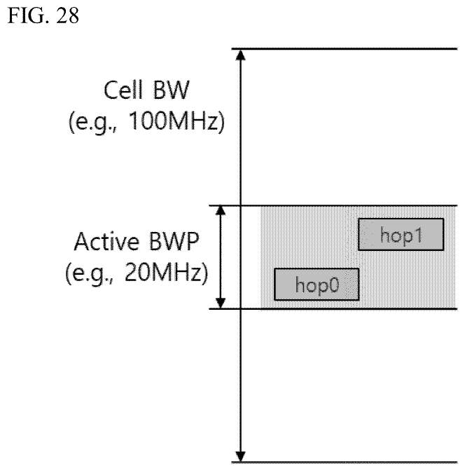

A first example is a case where an RF bandwidth supported by a UE is significantly smaller than a bandwidth supported by a cell. For example, FIG. 28 is referenced.

FIG. 28 is a diagram illustrating frequency hopping.

Referring to FIG. 28, it is assumed that an RF bandwidth of a UE supports up to 20 MHz, and a bandwidth supported by a cell supports 100 MHz. Since the RF bandwidth of the UE supports up to 20 MHz, an active BWP of the UE may support only up to 20 MHz. Therefore, if a frequency hopping scheme is used according to the aforementioned scheme, obtainable frequency diversity gain may be small.
In a second example, even if the RF bandwidth supported by the UE is not small, the UE needs to maintain the bandwidth of the active BWP small for lower energy consumption. In this case, as in the first example, if a frequency hopping scheme is used according to the aforementioned scheme, obtainable frequency diversity gain may be small.

In order to improve transmission based on frequency hopping within an active BWP as described above, the following frequency hopping may be considered.

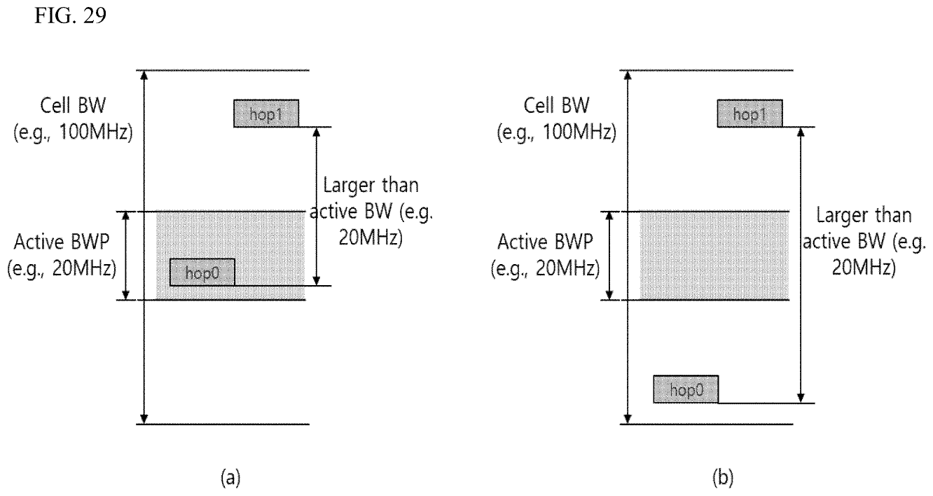

FIG. 29 is a diagram illustrating wide-band frequency hopping.

Referring to FIG. 29A, a first PRB set of hop 0 and a second PRB set of hop 1 of a UE may be farther apart from a specific frequency. In this case, one hop may be located within an active BWP. More specifically, a zeroth PRB set of hop 0 is located within the active BWP of the UE, but the first PRB set of hop 1 may be located in a frequency band outside the active BWP of the UE. Conversely, the first PRB set of hop 1 is located within the active BWP of the UE, but the zeroth PRB set of hop 0 may be located in a frequency band outside the active BWP of the UE. As another example, referring to FIG. 18B, the first PRB set of hop 0 and the second PRB set of hop 1 of the UE may be farther apart than a specific frequency. In this case, the two hops may be located in a frequency band out of the active BWP. More specifically, the zeroth PRB set of hop 0 and the first PRB set of hop 1 may be located in a frequency band outside the active BWP of the UE.

As shown in the example of FIG. 29, a signaling scheme by which the UE transmits one or two hops in a frequency band outside the active BWP is disclosed.

For the PUCCH before an RRC connection, determinations may be made as follows.

If r_{PUCCH} is one value among 0, 1, . . . , 7, the index of the zeroth PRB set of hop 0 of the selected PUCCH resource is RB_{BWP}^{offset}+ [symbol] r_{PUCCH}/N^{CS} [symbol] , and the index of the first PRB set of hop 1 is N_{BWP}^{size}−1−RB_{BWP}^{offset}− [symbol] r_{PUCCH}/N_{CS} [symbol] . If r_{PUCCH} is one value among 8, 9, . . . , 15, the index of the zeroth PRB set of hop 0 of the selected PUCCH resource is N_{BWP}^{size}−1−RB_{BWP}^{offset}− [symbol] r_{PUCCH}−8)/N_{CS} [symbol] , and the index of the first PRB set of hop 1 is RB_{BWP}^{offset}+ [symbol] (r_{PUCCH}−8)/N_{CS} [symbol] . Here, N_{BWP}^{size} is the number of PRBs included in a specific BWP for transmission of the PUCCH. Here, if the PUCCH transmits HARQ-ACK of an Msg4 PDSCH, the specific BWP is an initial UL BWP of a normal UE. The initial UL BWP of the normal UE is a UL BWP for cell access by the normal UE, and is configured in a system information block (SIB1). For reference, the UE in the aforementioned first or second example has an active BWP with a bandwidth smaller than that of an initial UL BWP of a normal UE. That is, the UE may determine the zeroth PRB set of hop 0 and the first PRB set of hop 1, based on a bandwidth greater than the bandwidth of the active BWP that the UE may have. Here, if the index of the RB at which the zeroth PRB set of hop 0 starts is 0, this indicates the lowest PRB of the specific BWP. That is, if the index of the RB at which the zeroth PRB set of hop 0 starts is 0, this indicates the lowest PRB of the initial UL BWP of the normal UE.

For the PUCCH after the RRC connection, determinations may be made as follows.

The index of the lowest PRB of the zeroth PRB set of hop 0 and the index of the lowest PRB of the first PRB set of hop 1 of the PUCCH may be configured as PUCCH resources for the UE via an RRC signal. That is, if indicated with one PUCCH resource, the UE may transmit hop 0 and hop 1 by using the index of the lowest PRB of the zeroth PRB set of hop 0 and the index of the lowest PRB of the first PRB set of hop 1, which are configured in the PUCCH resource. Here, if the index of the PRB is 0, this indicates the lowest PRB of the specific BWP of the UE. That is, the index of the PRB is interpreted as the index of the specific BWP of the UE. Here, the specific BWP may be one of the following.

As an example of the specific BWP, the UE may be configured with the specific BWP from a base station. The UE may be configured with an index of an RB at which the specific BWP starts or the number of PRBs included in the BWP, from the base station. In this case, the start RB index of the specific BWP may be configured based on a start RB index of the active BWP of the UE. That is, a difference between the start RB index of the specific BWP and a start RB index of the active BWP of the UE may be configured.

As an example of the specific BWP, the UE may assume a maximum BWP of a cell. The maximum BWP of the cell may be determined as follows. At initial access to the cell, the UE is configured with a frequency position of a PRB corresponding to cell common PRB index 0. 275 consecutive PRBs starting from cell common PRB index 0 may be grouped together so as to be determined as the maximum BWP of the cell. That is, any BWP is included in the maximum BWP of the cell. By using the maximum BWP of the cell in this way, the base station may perform frequency hopping and transmit, to the UE, the PUCCH at an arbitrary frequency of the cell.

As an example of the specific BWP, the UE may use an initial UL BWP of a normal UE. The initial UL BWP of the normal UE is a UL BWP for cell access by the normal UE, and is configured in a system information block (SIB1). For reference, the UE in the aforementioned first or second example has an active BWP with a bandwidth smaller than that of an initial UL BWP of a normal UE.

For the PUSCH, determinations may be made as follows.

### (1) First Embodiment

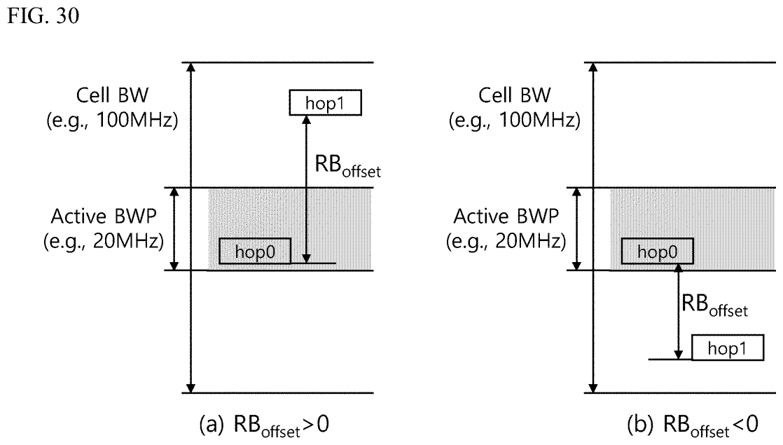

FIG. 30 is a diagram illustrating wide-band frequency hopping according to an embodiment of the present disclosure.

Referring to FIG. 30, a UE may determine a zeroth PRB set of hop 0 via DCI for scheduling of a PUSCH or a DCI/RRC signal for activation of the PUSCH. Here, the DCI for scheduling of the PUSCH or the DCI/RRC signal for activation of the PUSCH may include a frequency domain resource assignment (FDRA) field. The FDRA field may include the index of the RB at which the zeroth PRB set of hop 0 starts and the number of consecutive RBs. Here, if the index of the RB at which the zeroth PRB set of hop 0 starts is 0, this indicates the lowest PRB of the active BWP of the UE. That is, the index of the RB at which the zeroth PRB set of hop 0 starts is interpreted as the index of the active BWP of the UE. The UE needs to determine the index of the RB at which the first PRB set of hop 1 starts. This may be determined via the following equation.

RBₛₜₐᵣₜ(1)=(RBₛₜₐᵣₜ(0)+RB_{offset})

Here, RBₛₜₐᵣₜ(0) denotes the index of the RB at which the zeroth PRB set of hop 0 starts, and RBₛₜₐᵣₜ(1) indicates the index of the RB at which the first PRB set of hop 1 starts. RB_{offset} denotes a PRB gap between the zeroth PRB set of hop 0 and the first PRB set of hop 1. A base station may configure and indicate RB_{offset} for the UE, and a value of the RB_{offset} may be one of a positive number, 0, and a negative number. More specifically, the value of RB_{offset} may be one of −274, −273, . . . , 0, . . . , 273, and 274. If the index of the RB at which the first PRB set of hop 1 starts is 0, wherein the index is obtained using the equation, this indicates the lowest PRB of the active BWP of the UE. That is, the index (RBₛₜₐᵣₜ(1)) of the RB at which the first PRB set of hop 1 starts is interpreted as the index of the active BWP of the UE. If the index of the RB at which the first PRB set of hop 1 starts is a negative number, this indicates a PRB of a frequency band lower than that of the active BWP of the UE. For example, if the index of the RB at which the first PRB set of hop 1 starts is −A, this indicates a PRB lower, by A PRBs, than the lowest PRB of the active BWP of the UE.

### (2) Second Embodiment

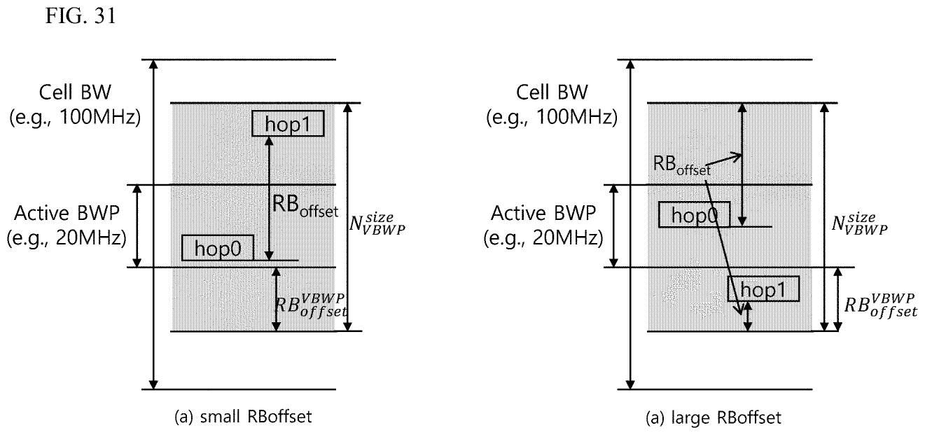

FIG. 31 is a diagram illustrating wide-band frequency hopping according to another embodiment of the present disclosure.

Referring to FIG. 31, a UE may determine a zeroth PRB set of hop 0 via DCI for scheduling of a PUSCH or a DCI/RRC signal for activation of the PUSCH. Here, the DCI for scheduling of the PUSCH or the DCI/RRC signal for activation of the PUSCH may include a frequency domain resource assignment (FDRA) field. The FDRA field may include the index of the RB at which the zeroth PRB set of hop 0 starts and the number of consecutive RBs. Here, if the index of the RB at which the zeroth PRB set of hop 0 starts is 0, this indicates the lowest PRB of the active BWP of the UE. That is, the index of the RB at which the zeroth PRB set of hop 0 starts is interpreted as the index of the active BWP of the UE. The UE needs to determine the index of the RB at which the first PRB set of hop 1 starts. This may be determined via the following equation.

RBₛₜₐᵣₜ(1)=(RBₛₜₐᵣₜ(0)+RB_{offset}+RB_{offset}^{VBWP})mod N_{VBWP}^{size}−RB_{offset}^{VBWP}

Here, RBₛₜₐᵣₜ(0) denotes the index of the RB at which the zeroth PRB set of hop 0 starts, and RBₛₜₐᵣₜ(1) indicates the index of the RB at which the first PRB set of hop 1 starts. RB_{offset} denotes a PRB gap between the zeroth PRB set of hop 0 and the first PRB set of hop 1. A base station may configure and indicate RB_{offset} for the UE. The UE may be configured with a specific BWP, in which the first PRB set of hop 1 may be located, from the base station. This specific BWP may include N_{VBWP}^{size} PRBs. The specific BWP may include an active BWP of the UE. RB_{offset}^{VBWP} denotes a difference between the index of the lowest PRB of the active BWP of the UE and the lowest index of the specific BWP.

If the index of the RB at which the first PRB set of hop 1 starts is 0, wherein the index is obtained using the equation, this indicates the lowest PRB of the active BWP of the UE. That is, the index (RBₛₜₐᵣₜ(1)) of the RB at which the first PRB set of hop 1 starts is interpreted as the index of the active BWP of the UE. If the index of the RB at which the first PRB set of hop 1 starts is a negative number, this indicates a PRB of a frequency band lower than that of the active BWP of the UE. For example, if the index of the RB at which the first PRB set of hop 1 starts is −A, this indicates a PRB lower, by A PRBs, than the lowest PRB of the active BWP of the UE.

### (3) Third Embodiment

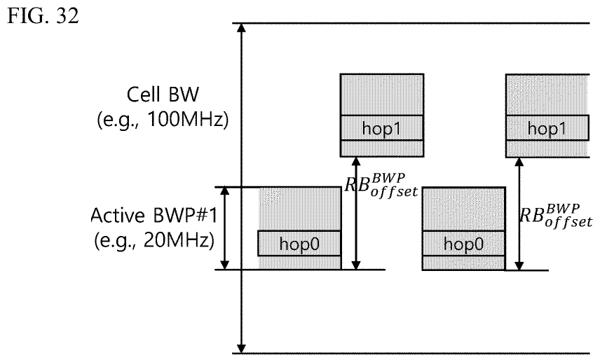

FIG. 32 is a diagram illustrating wide-band frequency hopping according to another embodiment of the present disclosure.

Referring to FIG. 32, in the aforementioned first or second embodiment, the UE determines the frequency positions of the zeroth PRB set of hop 0 and the first PRB set of hop 1. In this case, the active BWP of the UE is fixed. The third embodiment of the present disclosure proposes a method by which a UE moves an active BWP in a frequency band. The UE may determine the zeroth PRB set of hop 0 via DCI for scheduling of the PUSCH or a DCI/RRC signal for activation of the PUSCH. Here, the DCI for scheduling of the PUSCH or the DCI/RRC signal for activation of the PUSCH may include a frequency domain resource assignment (FDRA) field. The FDRA field may include the index of the RB at which the zeroth PRB set of hop 0 starts and the number of consecutive RBs. Here, if the index of the RB at which the zeroth PRB set of hop 0 starts is 0, this indicates the lowest PRB of the active BWP of the UE. That is, the index of the RB at which the zeroth PRB set of hop 0 starts is interpreted as the index of the active BWP of the UE. The UE needs to determine the index of the RB at which the first PRB set of hop 1 starts. To this end, the frequency domain of the active BWP of the UE may be changed as follows.

N_{BWP}^{start}(1)=N_{BWP}^{start,μ}(0)+RB_{offset}^{BWP} mod N_{cell,BW}^{size}

Where, N_{BWP}^{start,μ}(0) denotes the lowest PRB index of the active BWP in which hop 0 has been transmitted, and N_{BWP}^{start,μ}(1) denotes the lowest PRB index of a new active BWP for transmission of hop 1. RB_{offset}^{BWP} denotes a gap between the lowest PRB index of the active BWP in which hop 0 has been transmitted and the lowest PRB index of the new active BWP for transmission of hop 1. N_{cell-BW}^{size} is the number of PRBs included in a cell. The RB index at which the first PRB set of hop 1 starts is as follows.

RBₛₜₐᵣₜ(1)=RBₛₜₐᵣₜ(0)

That is, the RB index at which the zeroth PRB set of hop 0 starts and the RB index at which the first PRB set of hop 1 starts are the same. However, since the active BWP in which hop 0 has been transmitted and the active BWP in which hop 1 has been transmitted are different, the two hops are transmitted at different frequencies. That is, if the index of the RB at which the first PRB set of hop 1 starts is 0, this indicates the lowest PRB of the new active BWP of the UE. That is, the index of the RB at which the first PRB set of hop 1 starts is interpreted as the index of the new active BWP of the UE.

### (4) Fourth Embodiment

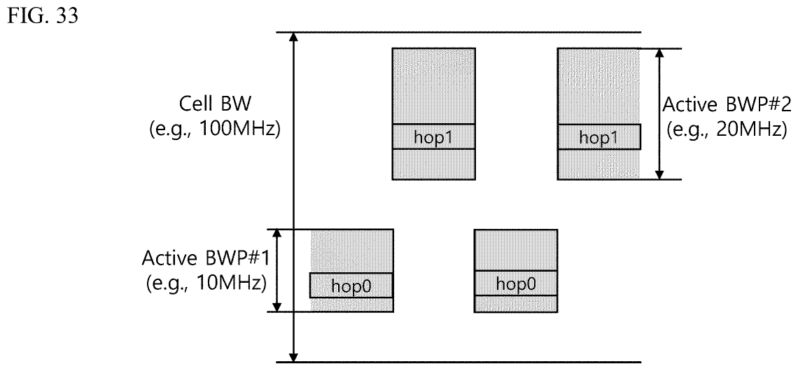

FIG. 33 is a diagram illustrating wide-band frequency hopping according to an embodiment of the present disclosure.

Referring to FIG. 33, in the aforementioned third embodiment, the UE moves the active BWP in the frequency domain according to a RB_{offset}^{BWP} value. In the fourth embodiment, frequency hopping is enabled by transmitting hop 0 in a zeroth active BWP and changing hop 1 to a second active BWP. The UE may determine the zeroth PRB set of hop 0 via DCI for scheduling of the PUSCH or a DCI/RRC signal for activation of the PUSCH. Here, the DCI for scheduling of the PUSCH or the DCI/RRC signal for activation of the PUSCH may include a frequency domain resource assignment (FDRA) field. The FDRA field may include the index of the RB at which the zeroth PRB set of hop 0 starts and the number of consecutive RBs. Here, if the index of the RB at which the zeroth PRB set of hop 0 starts is 0, this indicates the lowest PRB of the active BWP of the UE. That is, the index of the RB at which the zeroth PRB set of hop 0 starts is interpreted as the index of the active BWP of the UE. The UE needs to determine the index of the RB at which the first PRB set of hop 1 starts. The UE may be indicated or configured with the second active BWP in order to determine the index of the RB at which the first PRB set of hop 1 starts. Here, the second active BWP may have a different frequency domain or a different subcarrier spacing from that of the active BWP in which hop 0 has been transmitted. The UE may obtain the start index of the first PRB set of hop 1 by interpreting, as the index of the second active BWP, the previously obtained start index of the RB indicated by the FDRA field. The number of PRBs included in the first PRB set of hop 1 is equal to the number of PRBs included in the zeroth PRB set of hop 0.

In the aforementioned first and second embodiments, the UE transmits a channel and a signal in a frequency band outside the RF bandwidth of the UE. In this case, the RF of the UE needs to move from transmission in a previous frequency band to transmission in a new frequency band. The time for this may be referred to as an RF switching time. The UE needs a sufficient RF switching time. That is, the base station should ensure a sufficient RF switching time for the UE.

The RF switching time may be given in units of time. For example, the RF switching time may be configured in x millisecond (ms) or x micro-second (us). Alternatively, the RF switching time may be given as x samples. In this case, if a duration of one sample is expressed in Ts (second), a value thereof is Ts=1/(Δf_{ref}·N_{f,ref})), where Δfref=15·10³ Hz and N_{f,ref}=2048. If the duration of one sample is expressed in Tc (second), a value thereof is Tc=1/((Δfₘₐₓ·Nₘₐₓ)), where Δfₘₐₓ=480·10³, N_{f}=4096.

The duration may be configured differently for each frequency band. The UE may determine the number of symbols corresponding to a value given as the time unit. For example, if the given value is x ms, the UE may determine the number of symbols corresponding to x ms by dividing the x ms by one symbol length (symbol_duration). That is, the number of symbols is x ms/symbol_duration. For reference, symbol_duration may be obtained as follows.

When a normal CP is used, a length of an OFDM symbol may be different for each symbol. This is because lengths of cyclic prefixes (CPs) are different. More specifically, when a normal CP is used, a CP length is shown as follows. If an OFDM symbol index in a subframe is 0 or 7*2^{μ}, the CP length is 144*κ*2^{-μ}+16*κ, and the CP length is 144*κ*2^{-μ} for the remaining OFDM symbol indices. Where μ is a subcarrier spacing configuration, which is 0 if the subcarrier spacing is 15 kHz, 1 if the subcarrier spacing is 30 kHz, 2 if the subcarrier spacing is 60 kHz, and 3 if the subcarrier spacing is 120 kHz. In addition, κ=Ts/Tc=64.

A short length among the symbol lengths may be used as symbol_duration for obtaining the number of symbols. That is, symbol_duration is 144*κ*2^{-μ}*Tc (second). The use of a short length is to obtain a minimum symbol for ensuring of an RF switching time.

As another example, when transmitting uplink channels, the UE may perform transmission using different subsequent beams so as to obtain beam diversity. In this case, it takes time for the UE to perform beam switching from a first beam to a second beam. This may be referred to as a beam switching time. The UE should satisfy the beam switching time. To this end, the base station may configure a time required for beam switching for the UE similarly to the RF switching time, and the UE may determine the number of symbols required for the beam switching time.

In the following description of the present disclosure, the number of symbols for ensuring the RF switching time or beam switching time is denoted by G. For reference, if the UE needs RF switching by frequency hopping and needs beam switching by beam changing, the G value may be determined based on the sum or the maximum value of the RF switching time or beam switching time. The UE cannot transmit an uplink signal during the G symbols.

A task to be achieved by the present disclosure is a method of, when an uplink channel or signal is transmitted, arranging G symbols in which the uplink signal/channel cannot be transmitted. Methods for this are disclosed below.

In addition, in the present disclosure, for convenience, a method of arranging G symbols to satisfy an RF switching time between frequency hopping will be described. The method may be interpreted as a method of arranging G symbols to satisfy a beam switching time by replacing frequency hopping with beam changing.

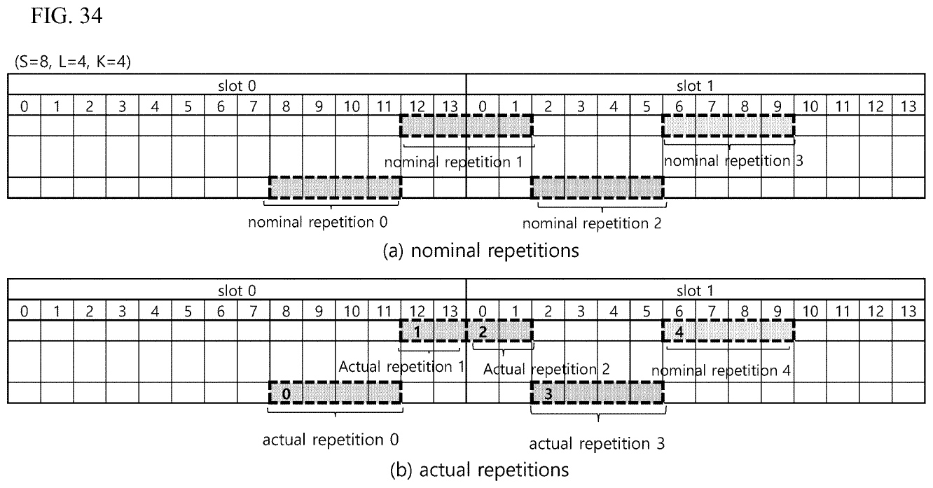

FIG. 34 illustrates PUSCH repetition type B according to an example.

Referring to FIG. 34, a UE is scheduled to repeat a PUSCH having a length of 4 (L=4) four times (K=4) from symbol 8 (S=8) of slot 0. As shown in FIG. 34A, the UE may generate 4 nominal repetitions by bundling each set of 4 symbols starting from symbol 8 of slot 0. Here, nominal repetition 0 includes symbols 8, 9, 10 and 11 of slot 0, nominal repetition 1 includes symbols 12 and 13 of slot 0 and symbols 0 and 1 of slot 1, nominal repetition 2 includes symbols 2, 3, 4 and 5 of slot 1, and nominal repetition 3 includes symbols 6, 7, 8 and 9 of slot 1.

As shown in FIG. 34B, the nominal repetition is divided at a slot boundary (although not shown in the drawing, division may occur around symbols in which UL transmission is not valid), consecutive symbols are combined in one slot, and an actual repetition may be thus generated. Referring to FIG. 34B, nominal repetition 1 may be divided into two actual repetitions. Therefore, the UE may transmit the PUSCH with 5 actual repetitions. More specifically, actual repetition 0 includes symbols 8, 9, 10, and 11 of slot 0, actual repetition 1 includes symbols 12 and 13 of slot 0, actual repetition 2 includes symbols 0 and 1 of slot 1, actual repetition 3 includes symbols 2, 3, 4, and 5 of slot 1, and actual repetition 4 includes symbols 6, 7, 8, and 9 of slot 1.

In subsequent drawings, only indices of actual repetitions are shown. That is, if 0 is indicated, this shows an actual repetition of 0.

In FIG. 34, the UE performs frequency hopping for each nominal repetition. That is, nominal repetitions of even-numbered indices are transmitted in a zeroth PRB set of hop 0, and nominal repetitions of odd-numbered indices are transmitted in a first PRB set of hop 1. For convenience of description of the present disclosure, frequency hopping is described for each nominal repetition, but the scheme of the present disclosure is applicable to other frequency hopping schemes.

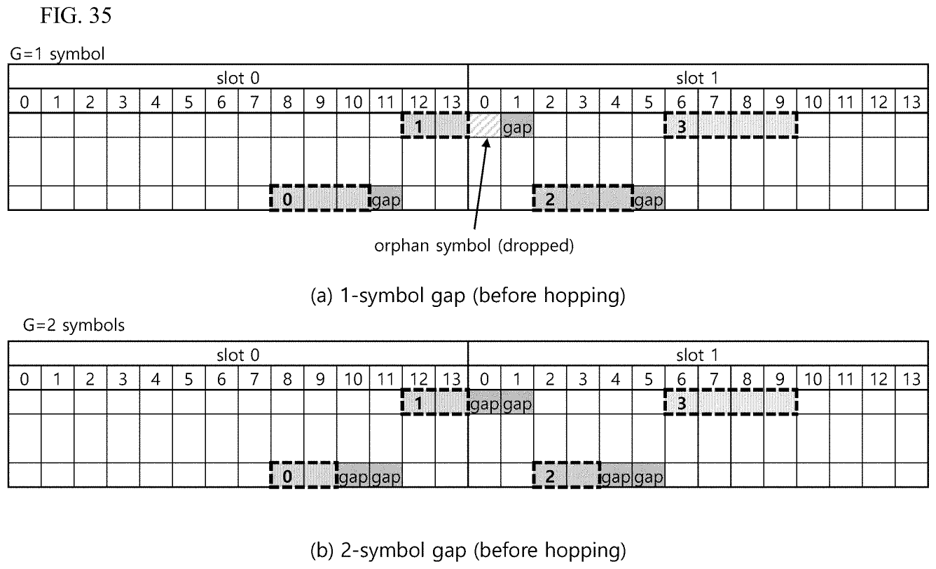

The UE needs G symbols for RF switching during frequency hopping. That is, at least G symbols are required between transmission in the zeroth PRB set of hop 0 and transmission in the first PRB set 1 of hop 1. A scheme for ensuring G symbols is disclosed. FIG. 35 is referenced as a first embodiment of PUSCH repetition type B of the present disclosure.

FIG. 35 shows diagrams illustrating gap symbols being arranged in preceding nominal repetitions in type-B PUSCH repetition according to an embodiment of the present disclosure.

Referring to FIG. 35, a UE may not transmit a PUSCH in G symbols immediately before frequency hopping and use the symbols as gaps. Referring to FIG. 35A, if G=1, the UE may not transmit a PUSCH in one symbol immediately before frequency hopping and may use the symbol as a gap for RF switching.

Referring to FIG. 35B, if G=2, the UE may not transmit a PUSCH in two symbols immediately before frequency hopping and may use the symbols as gaps for RF switching. Frequency hopping occurs between nominal repetition 0 (symbols 8, 9, 10, and 11 of slot 0) and nominal repetition 1 (symbols 12 and 13 of slot 0 and symbols 0 and 1 of slot 1). Therefore, according to an embodiment of the present disclosure, last G symbols of nominal repetition 0 immediately before frequency hopping may be determined to be symbols in which no PUSCH is transmitted. Accordingly, the symbols in which no PUSCH is transmitted may be excluded when actual repetition is determined. (When actual repetition is determined, the symbols in which no PUSCH is transmitted may be determined as invalid symbols).

Referring to FIG. 35A, when G=1, symbol 11 of slot 0, symbol 1 of slot 1, and symbol 5 of slot 1 may be determined to be symbols in which no PUSCH is transmitted. Accordingly, the UE may configure actual repetition 0 by combining symbols 8, 9, and 10 of slot 0, configure actual repetition 1 by combining symbols 12 and 13 of slot 0, configure actual repetition 2 by combining symbols 2, 3, and 4 of slot 1, and configure actual repetition 3 by combining symbols 6, 7, 8, and 9 of slot 1. For reference, since symbol 0 of slot 1 is 1 symbol, no PUSCH is transmitted. This symbol is referred to as an orphan symbol.

Referring to FIG. 35B, when G=2, symbols 10 and 11 of slot 0, symbols 0 and 1 of slot 1, and symbols 4 and 5 of slot 1 may be determined to be symbols in which no PUSCH is transmitted. Accordingly, the UE may configure actual repetition 0 by combining symbols 8 and 9 of slot 0, configure actual repetition 1 by combining symbols 12 and 13 of slot 0, configure actual repetition 2 by combining symbols 2 and 3 of slot 1, and configure actual repetition 3 by combining symbols 6, 7, 8, and 9 of slot 1.

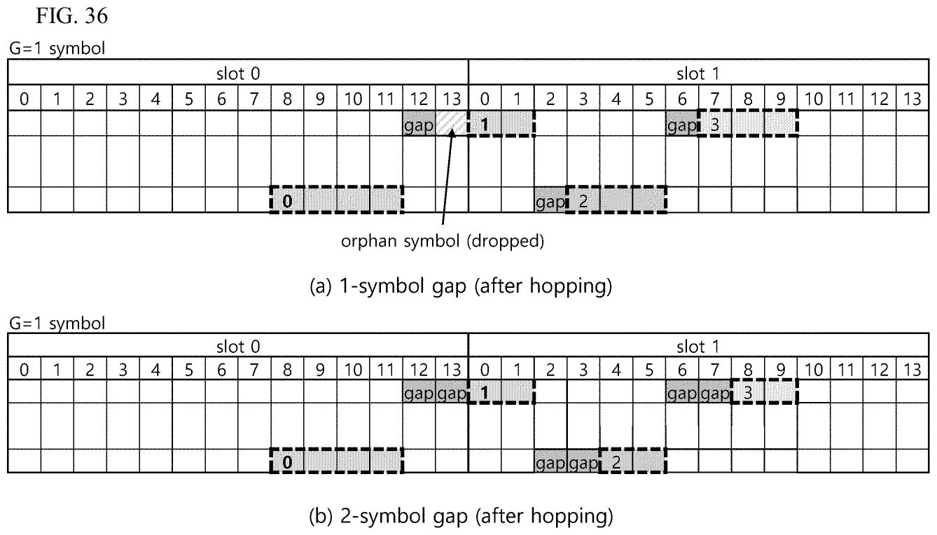

A second embodiment of PUSCH repetition type B of the present disclosure is as shown in FIG. 36.

FIG. 36 shows diagrams illustrating gap symbols being arranged in subsequent nominal repetitions in type-B PUSCH repetition according to an embodiment of the present disclosure.

Referring to FIG. 36, a UE may not transmit a PUSCH in G symbols immediately after frequency hopping and use the symbols as gaps for RF switching. Referring to FIG. 36A, if G=1, the UE may not transmit a PUSCH in one symbol immediately after frequency hopping and may use the symbol as a gap for RF switching. Referring to FIG. 36B, if G=2, the UE may not transmit a PUSCH in two symbols immediately after frequency hopping and may use the symbols as gaps for RF switching. Frequency hopping occurs between nominal repetition 0 (symbols 8, 9, 10, and 11 of slot 0) and nominal repetition 1 (symbols 12 and 13 of slot 0 and symbols 0 and 1 of slot 1). Therefore, according to an embodiment of the present disclosure, first G symbols of nominal repetition 1 immediately subsequent to frequency hopping may be determined to be symbols in which no PUSCH is transmitted. Accordingly, the symbols in which no PUSCH is transmitted may be excluded when actual repetition is determined. (When actual repetition is determined, the symbols in which no PUSCH is transmitted may be determined as invalid symbols).

Referring to FIG. 36A, when G=1, symbol 12 of slot 0, symbol 2 of slot 1, and symbol 6 of slot 1 may be determined to be symbols in which no PUSCH is transmitted. Accordingly, the UE may configure actual repetition 0 by combining symbols 8, 9, 10, and 11 of slot 0, configure actual repetition 1 by combining symbols 0 and 1 of slot 1, configure actual repetition 2 by combining symbols 3, 4, and 5 of slot 1, and configure actual repetition 3 by combining symbols 7, 8, and 9 of slot 1. For reference, since symbol 13 of slot 0 is 1 symbol, no PUSCH is transmitted. This symbol is referred to as an orphan symbol.

Referring to FIG. 36B, when G=2, symbols 12 and 13 of slot 0, symbols 2 and 3 of slot 1, and symbols 6 and 7 of slot 1 may be determined to be symbols in which no PUSCH is transmitted. Accordingly, the UE may configure actual repetition 0 by combining symbols 8, 9, 10, and 11 of slot 0, configure actual repetition 1 by combining symbols 0 and 1 of slot 1, configure actual repetition 2 by combining symbols 4 and 5 of slot 1, and configure actual repetition 3 by combining symbols 8 and 9 of slot 1.

When compared to the first embodiment, the second embodiment has the following advantages. When low latency is required such as in a URLLC system, it is preferable to transmit a PUSCH in as many preceding (preceding in time) symbols as possible. When comparing the number of symbols included in the first actual repetition of the first embodiment and that of the second embodiment, since there is no symbol used as a gap in the second embodiment, more symbols may be used to transmit the PUSCH. Therefore, a base station has a high probability of correctly receiving the PUSCH at an earlier point in time.

However, in the first embodiment and the second embodiment, G symbols are not used for PUSCH transmission in one nominal repetition, and therefore repetitions have different numbers of symbols. For example, in FIG. 35B, actual repetitions 0, 1, and 2 occupy 2 symbols, but actual repetition 3 occupies 4 symbols. Accordingly, PUSCH reception performance may deteriorate due to the difference in the number of symbols between repetitions.

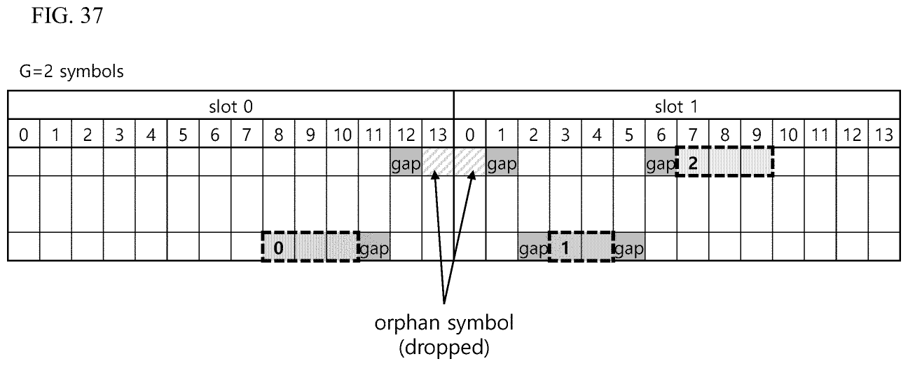

A third embodiment of PUSCH repetition type B of the present disclosure is as shown in FIG. 37.

FIG. 37 is a diagram illustrating gap symbols being distributedly arranged in type-B PUSCH repetition according to an embodiment of the present disclosure.

Referring to FIG. 37, a UE may not transmit a PUSCH in f(G/2) symbols immediately before frequency hopping and may not transmit a PUSCH in G−f(G/2) symbols immediately after frequency hopping. f(G/2) is at least one of floor(G/2), ceil(G/2), and round(G/2). That is, in the third embodiment, the difference in the number of symbols between repetitions can be reduced by preventing the same number of symbols, which are available for nominal repetition immediately before frequency hopping and nominal repetition immediately after frequency hopping, from being used for PUSCH transmission.

Referring to FIG. 37, when G=2, symbols 11 and 12 of slot 0, symbols 1 and 2 of slot 1, and symbols 5 and 6 of slot 1 may be determined to be symbols in which no PUSCH is transmitted. Accordingly, the UE may configure actual repetition 0 by combining symbols 8, 9, and 10 of slot 0, configure actual repetition 1 by combining symbols 3 and 4 of slot 1, and configure actual repetition 2 by combining symbols 7, 8, and 9 of slot 1. For reference, since symbol 13 of slot 0 is 1 symbol, no PUSCH is transmitted. In addition, since symbol 0 of slot 1 is 1 symbol, no PUSCH is transmitted.

Referring to FIG. 37, according to the third embodiment, it may be identified that the number of symbols of each repetition of the UE is similar. In FIG. 37, actual repetitions 0 and 2 occupy 3 symbols, and actual repetition 1 occupies 2 symbols. However, in FIG. 37, symbol 13 of slot 0 and symbol 0 of slot 1 are orphan symbols in which no PUSCH is transmitted. Therefore, the total number of symbols used for the PUSCH is reduced. A method to solve this is required.

As a fourth embodiment of PUSCH repetition type B of the present disclosure, the UE may compare the number of symbols of actual repetition immediately before frequency hopping with the number of symbols of actual repetition immediately after frequency hopping so as to determine G symbols in which no PUSCH is to be transmitted. Here, first in actual repetition with a larger number of symbols, some or all symbols may be determined to be symbols in which no PUSCH is to be transmitted. Specific methods are as follows.

As a first method, the UE compares the number of symbols of actual repetition immediately before frequency hopping with the number of symbols of actual repetition immediately after frequency hopping so as to determine, in actual repetition having a larger number of symbols, G symbols to be symbols in which no PUSCH is to be transmitted. Here, when the number of symbols of actual repetition immediately before frequency hopping is N1, and the number of symbols of actual repetition immediately after frequency hopping is N2, G symbols may be determined as follows.
If N1≥N2, last G symbols of actual repetition immediately before frequency hopping are determined to be symbols in which no PUSCH is transmitted.
If N1<N2, first G symbols of actual repetition immediately after frequency hopping are determined to be symbols in which no PUSCH is transmitted.

As a second method, the UE compares the number (N1) of symbols of actual repetition immediately before frequency hopping with the number (N2) of symbols of actual repetition immediately after frequency hopping so as to determine, in actual repetition having a larger number of symbols, one symbol to be a symbol in which no PUSCH is to be transmitted. If the actual repetition is actual repetition immediately before frequency hopping, then the one symbol is a last symbol of the actual repetition, and if the actual repetition is actual repetition immediately after frequency hopping, then the one symbol is a first symbol of the actual repetition. This operation is repeated until G symbols are obtained. More specifically, G symbols are obtained as follows.
It is assumed that g1=0 and g2=0.
If g1+g2<G, the following procedures are repeated. If N1−g1≥N2−g2, then g1=g1+1. If N1−g1<N2−g2, then g2=g2+1.
Last g1 symbols of actual repetition immediately before frequency hopping are determined to be symbols in which no PUSCH is transmitted.
First g2 symbols of actual repetition immediately after frequency hopping are determined to be symbols in which no PUSCH is transmitted.

As another third method, G symbols may be determined as follows.
If N1≥N2 and N1−N2≥G, last G symbols of actual repetition immediately before frequency hopping are determined to be symbols in which no PUSCH is transmitted.
If N1≥N2 and N1−N2<G, last N1−N2+4(G−(N1−N2))/2) symbols of actual repetition immediately before frequency hopping are determined to be symbols in which no PUSCH is transmitted, and first G−(N1−N2)−f((G−(N1−N2))/2) symbols of actual repetition immediately after frequency hopping are determined to be symbols in which no PUSCH is transmitted.
If N1<N2 and N2−N1≥G, first G symbols of actual repetition immediately after frequency hopping are determined to be symbols in which no PUSCH is transmitted.
If N1<N2 and N2−N1<G, last G−(N2−N1)−f((G−(N2−N1))/2) symbols of actual repetition immediately before frequency hopping are determined to be symbols in which no PUSCH is transmitted, and first N2−N1+f((G−(N2−N1))/2) symbols of actual repetition immediately after frequency hopping are determined to be symbols in which no PUSCH is transmitted.

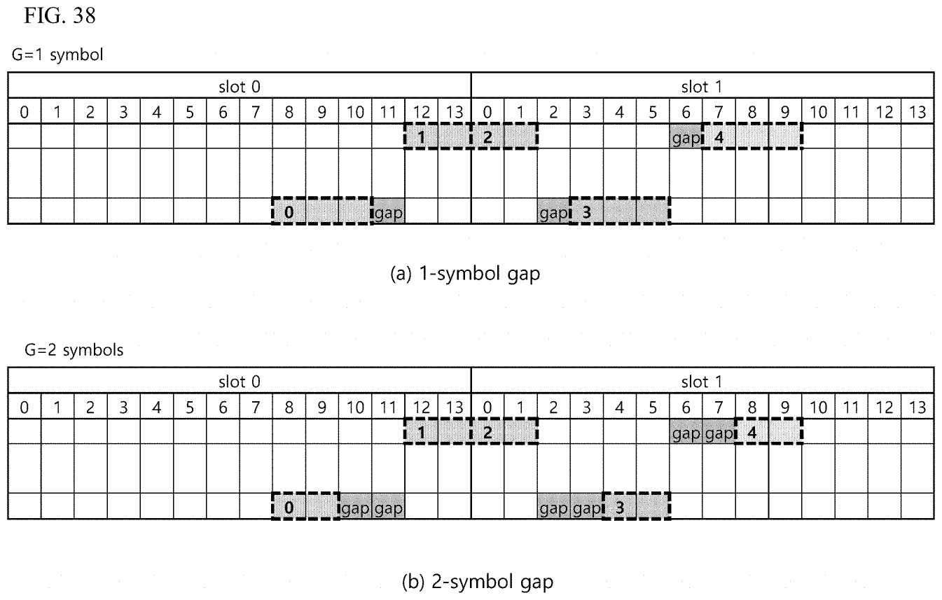

The fourth embodiment of PUSCH repetition type B of the present disclosure is as shown in FIG. 38.

FIG. 38 shows diagrams illustrating gap symbols being arranged in nominal repetition having a large number of symbols in type-B PUSCH repetition according to an embodiment of the present disclosure.

According to a first method, a UE determines a symbol in which no PUSCH is transmitted, as follows. First, the UE makes an assumption of G=0 (without considering a gap) and obtains actual repetition. Here, the obtained actual repetition is as shown in FIG. 34B. Here, the obtained actual repetition is an intermediate procedure and is, for convenience, referred to as intermediate actual repetition, and actually transmitted actual repetition according to a symbol in which no PUSCH is to be transmitted is obtained as follows.

According to FIG. 34B, there are five intermediate actual repetitions, and indices thereof are 0, 1, 2, 3, and 4. Frequency hopping occurs between intermediate actual repetitions 0 and 1, frequency hopping occurs between intermediate actual repetitions 2 and 3, and frequency hopping occurs between intermediate actual repetitions 3 and 4. First, a gap for frequency hopping that is most advanced in time is determined. Intermediate actual repetition 0 includes 4 symbols, and intermediate actual repetition 1 includes 2 symbols. Therefore, last G symbols of intermediate actual repetition 0 including more symbols are determined to be symbols in which no PUSCH is transmitted. A gap for frequency hopping that is next-most advanced in time is determined. Intermediate actual repetition 2 includes 2 symbols, and intermediate actual repetition 3 includes 4 symbols. Therefore, first G symbols of intermediate actual repetition 3 including more symbols are determined to be symbols in which no PUSCH is transmitted. Finally, a gap for latest frequency hopping in time is determined. Intermediate actual repetition 3 includes 3 symbols (when G=1 with reference to FIG. 38A) or 2 symbols (when G=2 with reference to FIG. 38B), and intermediate actual repetition 4 includes 4 symbols. Therefore, first G symbols of intermediate actual repetition 4 including more symbols are determined to be symbols in which no PUSCH is transmitted. The UE may determine actual repetition by excluding the determined symbols, in which no PUSCH is transmitted, from intermediate actual repetitions.

According to the fourth embodiment of PUSCH repetition type B of the present disclosure, some symbols in actual repetition having a longer length are determined to be symbols in which no PUSCH is transmitted. Therefore, overall, the length of actual repetition is reduced. Accordingly, one actual repetition cannot have a lower code rate. A method to solve this is required.

As a fifth embodiment of PUSCH repetition type B of the present disclosure, the UE may compare the number of symbols of actual repetition immediately before frequency hopping with the number of symbols of actual repetition immediately after frequency hopping so as to determine G symbols in which no PUSCH is to be transmitted. Here, first in actual repetition with a smaller number of symbols, some or all symbols may be determined to be symbols in which no PUSCH is to be transmitted. Specific methods are as follows.

As a first method, the UE compares the number of symbols of actual repetition immediately before frequency hopping with the number of symbols of actual repetition immediately after frequency hopping so as to determine, in actual repetition having a smaller number of symbols, G symbols to be symbols in which no PUSCH is to be transmitted. Here, when the number of symbols of actual repetition immediately before frequency hopping is N1, and the number of symbols of actual repetition immediately after frequency hopping is N2, G symbols may be determined as follows.
If N1≥N2, first G symbols of actual repetition immediately after frequency hopping are determined to be symbols in which no PUSCH is transmitted.
If N1<N2, last G symbols of actual repetition immediately before frequency hopping are determined to be symbols in which no PUSCH is transmitted.

As a second method, the UE compares the number (N1) of symbols of actual repetition immediately before frequency hopping with the number (N2) of symbols of actual repetition immediately after frequency hopping so as to determine, in actual repetition having a smaller number of symbols, one symbol to be a symbol in which no PUSCH is to be transmitted. If the actual repetition is actual repetition immediately before frequency hopping, then the one symbol is a last symbol of the actual repetition, and if the actual repetition is actual repetition immediately after frequency hopping, then the one symbol is a first symbol of the actual repetition. This operation is repeated until G symbols are obtained. More specifically, G symbols are obtained as follows.
It is assumed that g1=0 and g2=0.
If g1+g2<G, the following procedures are repeated. If N1−g1≥N2−g2, then g2=g2+1. If N1−g1<N2−g2, then g1=g1+1.
Last g1 symbols of actual repetition immediately before frequency hopping are determined to be symbols in which no PUSCH is transmitted.
First g2 symbols of actual repetition immediately after frequency hopping are determined to be symbols in which no PUSCH is transmitted.

As another third method, G symbols may be determined as follows.
If N1≥N2 and N2≥G, first G symbols of actual repetition immediately after frequency hopping are determined to be symbols in which no PUSCH is transmitted.
If N1≥N2 and N2<G, all N2 symbols of actual repetition immediately after frequency hopping are determined to be symbols in which no PUSCH is transmitted, and last G−N2 symbols of actual repetition immediately before frequency hopping are determined to be symbols in which no PUSCH is transmitted.
If N1<N2 and N1≥G, last G symbols of actual repetition immediately before frequency hopping are determined to be symbols in which no PUSCH is transmitted.
If N1<N2 and N1<G, all N1 symbols of actual repetition immediately before frequency hopping are determined to be symbols in which no PUSCH is transmitted, and first G−N1 symbols of actual repetition immediately after frequency hopping are determined to be symbols in which no PUSCH is transmitted.

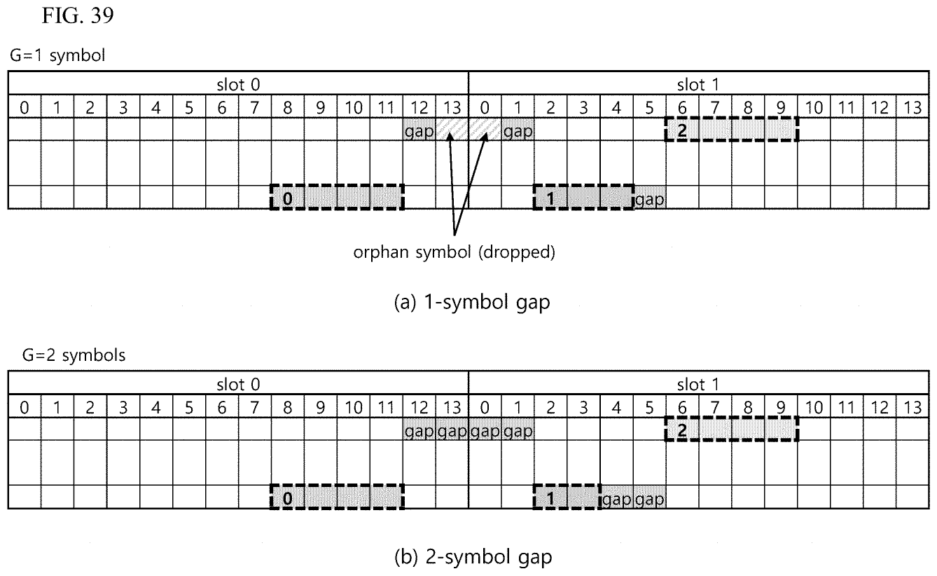

The fifth embodiment of PUSCH repetition type B of the present disclosure is as shown in FIG. 39.

FIG. 39 shows diagrams illustrating gap symbols being arranged in nominal repetition having a small number of symbols in type-B PUSCH repetition according to an embodiment of the present disclosure.

According to a first method, a UE determines a symbol in which no PUSCH is transmitted, as follows. First, the UE makes an assumption of G=0 (without considering a gap) and obtains actual repetition. Here, the obtained actual repetition is as shown in FIG. 34B. Here, the obtained actual repetition is an intermediate procedure and is, for convenience, referred to as intermediate actual repetition, and actually transmitted actual repetition according to a symbol in which no PUSCH is to be transmitted is obtained as follows.

According to FIG. 34B, there are five intermediate actual repetitions, and indices thereof are 0, 1, 2, 3, and 4. Frequency hopping occurs between intermediate actual repetitions 0 and 1, frequency hopping occurs between intermediate actual repetitions 2 and 3, and frequency hopping occurs between intermediate actual repetitions 3 and 4. First, a gap for frequency hopping that is most advanced in time is determined. Intermediate actual repetition 0 includes 4 symbols, and intermediate actual repetition 1 includes 2 symbols. Therefore, first G symbols of intermediate actual repetition 1 including fewer symbols are determined to be symbols in which no PUSCH is transmitted. A gap for frequency hopping that is next-most advanced in time is determined. Intermediate actual repetition 2 includes 2 symbols, and intermediate actual repetition 3 includes 4 symbols. Therefore, last G symbols of intermediate actual repetition 2 including fewer symbols are determined to be symbols in which no PUSCH is transmitted. Finally, a gap for latest frequency hopping in time is determined. Intermediate actual repetition 3 includes 4 symbols, and intermediate actual repetition 4 includes 4 symbols. Therefore, since intermediate actual repetitions 3 and 4 have the same number of symbols, last G symbols of preceding intermediate actual repetition 3 are determined to be symbols in which no PUSCH is transmitted. The UE may determine actual repetition by excluding the determined symbols, in which no PUSCH is transmitted, from intermediate actual repetitions. For reference, when G=1, each of intermediate actual repetitions 1 and 2 includes one symbol. Accordingly, the one symbol is an orphan symbol in which no PUSCH is transmitted.

Referring to FIG. 39, it may be identified that the UE transmits a PUSCH with actual repetition including more symbols. However, according to FIG. 39A, if G symbols are unavailable for PUSCH transmission in intermediate actual repetition including a small number of symbols, there may be one remaining symbol which is an orphan symbol. Due to this orphan, the total number of symbols used for PUSCH transmission is reduced. A method to solve this is required.

As a sixth embodiment of PUSCH repetition type B of the present disclosure, the UE may compare the number of symbols of actual repetition immediately before frequency hopping with the number of symbols of actual repetition immediately after frequency hopping so as to determine G symbols in which no PUSCH is to be transmitted. Here, first in actual repetition with a smaller number of symbols, some or all symbols may be determined to be symbols in which no PUSCH is to be transmitted. However, if actual repetition has 2 symbols, a symbol in which no PUSCH is to be transmitted may no longer be determined in the corresponding actual repetition, and a symbol in which no PUSCH is to be transmitted may be determined in actual repetition having more symbols. Specific methods are as follows.

As a first method, the UE compares the number of symbols of actual repetition immediately before frequency hopping with the number of symbols of actual repetition immediately after frequency hopping so as to determine, in actual repetition having a smaller number of symbols, G symbols to be symbols in which no PUSCH is to be transmitted. Here, when the number of symbols of actual repetition immediately before frequency hopping is N1, and the number of symbols of actual repetition immediately after frequency hopping is N2, G symbols may be determined as follows.
If N1≥N2 and N2−G≥2, first G symbols of actual repetition immediately after frequency hopping are determined to be symbols in which no PUSCH is transmitted.
If N1≥N2 and N2−G<2, first N2-2 symbols of actual repetition immediately after frequency hopping are determined to be symbols in which no PUSCH is transmitted. Last G−(N2-2) symbols of actual repetition immediately before frequency hopping are determined to be symbols in which no PUSCH is transmitted.
If N1<N2 and N1−G≥2 last G symbols of actual repetition immediately before frequency hopping are determined to be symbols in which no PUSCH is transmitted.
If N1<N2 and N1−G<2, last N1−2 symbols of actual repetition immediately before frequency hopping are determined to be symbols in which no PUSCH is transmitted. First G−(N1−2) symbols of actual repetition immediately after frequency hopping are determined to be symbols in which no PUSCH is transmitted.

As a second method, the UE compares the number (N1) of symbols of actual repetition immediately before frequency hopping with the number (N2) of symbols of actual repetition immediately after frequency hopping so as to determine, in actual repetition having a smaller number of symbols, one symbol to be a symbol in which no PUSCH is to be transmitted. If the actual repetition is actual repetition immediately before frequency hopping, then the one symbol is a last symbol of the actual repetition, and if the actual repetition is actual repetition immediately after frequency hopping, then the one symbol is a first symbol of the actual repetition.

This operation is repeated until G symbols are obtained. More specifically, G symbols are obtained as follows.
It is assumed that g1=0 and g2=0.
If g1+g2<G, the following procedures are repeated. If N1−g1≥N2−g2≥2, then g2=g2+1. Otherwise, g1=g1+1.
Last g1 symbols of actual repetition immediately before frequency hopping are determined to be symbols in which no PUSCH is transmitted.
First g2 symbols of actual repetition immediately after frequency hopping are determined to be symbols in which no PUSCH is transmitted.

As another third method, G symbols may be determined as follows.
If N1≥N2 and N2−G≥2, first G symbols of actual repetition immediately after frequency hopping are determined to be symbols in which no PUSCH is transmitted.
If N1≥N2 and N2−G<2, first N2-2 symbols of actual repetition immediately after frequency hopping are determined to be symbols in which no PUSCH is transmitted, and last G−(N2-2) symbols of actual repetition immediately before frequency hopping are determined to be symbols in which no PUSCH is transmitted.
If N1<N2 and N1−G≥2, last G symbols of actual repetition immediately before frequency hopping are determined to be symbols in which no PUSCH is transmitted.
If N1<N2 and N1−G<2, N1-2 symbols of actual repetition immediately before frequency hopping are determined to be symbols in which no PUSCH is transmitted, and first G−(N1-2) symbols of actual repetition immediately after frequency hopping are determined to be symbols in which no PUSCH is transmitted.

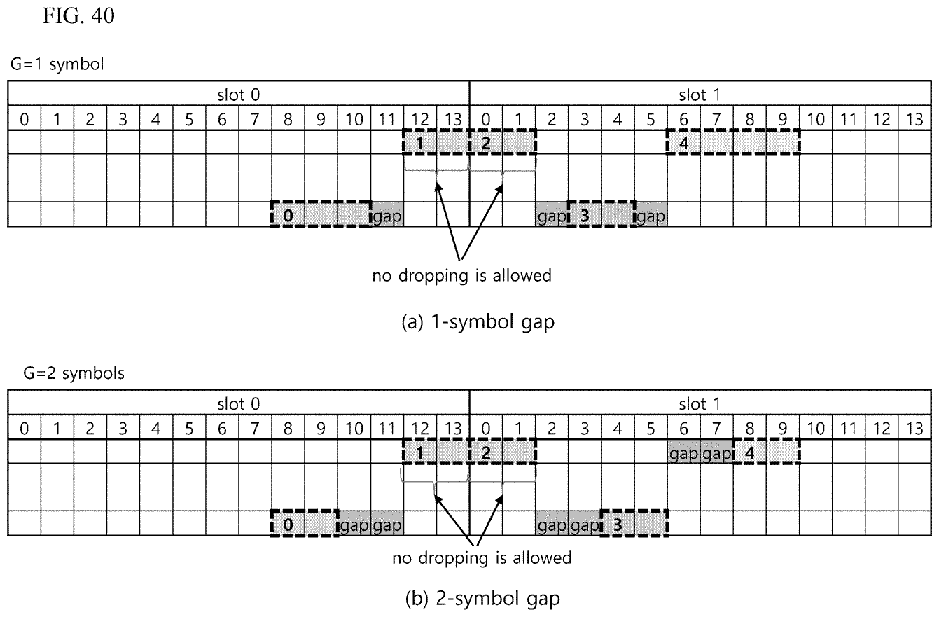

The sixth embodiment of PUSCH repetition type B of the present disclosure is as shown in FIG. 40.

FIG. 40 shows diagrams illustrating arrangement of gap symbols so that an orphan symbol does not occur in type-B PUSCH repetition according to an embodiment of the present disclosure.

According to a first method, a UE determines a symbol in which no PUSCH is transmitted, as follows. First, the UE makes an assumption of G=0 (without considering a gap) and obtains actual repetition. Here, the obtained actual repetition is as shown in FIG. 34B. Here, the obtained actual repetition is an intermediate procedure and is, for convenience, referred to as intermediate actual repetition, and 5 actually transmitted actual repetition according to a symbol in which no PUSCH is to be transmitted is obtained as follows.

According to FIG. 34B, there are five intermediate actual repetitions, and indices thereof are 0, 1, 2, 3, and 4. Frequency hopping occurs between intermediate actual repetitions 0 and 1, frequency hopping occurs between intermediate actual repetitions 2 and 3, and frequency hopping occurs between intermediate actual repetitions 3 and 4. First, a gap for frequency hopping that is most advanced in time is determined. Intermediate actual repetition 0 includes 4 symbols, and intermediate actual repetition 1 includes 2 symbols. Therefore, since intermediate actual repetition 1 including fewer symbols includes 2 symbols, this intermediate actual repetition may no longer include a symbol in which no PUSCH is transmitted (if included, an orphan symbol is generated). Therefore, last G symbols of intermediate actual repetition 0 including more symbols are determined to be symbols in which no PUSCH is transmitted. A gap for frequency hopping that is next-most advanced in time is determined. Intermediate actual repetition 2 includes 2 symbols, and intermediate actual repetition 3 includes 4 symbols. Since intermediate actual repetition 2 including fewer symbols includes 2 symbols, this intermediate actual repetition may no longer include a symbol in which no PUSCH is transmitted (if included, an orphan symbol is generated). Therefore, last G symbols of intermediate actual repetition 3 including more symbols are determined to be symbols in which no PUSCH is transmitted. Finally, a gap for latest frequency hopping in time is determined. Intermediate actual repetition 3 includes 3 symbols (when G=1 in FIG. 40A) or 2 symbols (when G=2 in FIG. 40B), and intermediate actual repetition 4 includes 4 symbols. If intermediate actual repetition 3 includes 3 symbols (when G=1 in FIG. 40A), a last G=1 symbol of intermediate actual repetition 3 is determined to be a symbol in which no PUSCH is transmitted. If intermediate actual repetition 3 includes 2 symbols (when G=2 in FIG. 40B), first G=2 symbols of intermediate actual repetition 4 are determined to be symbols in which no PUSCH is transmitted.

Referring to FIG. 40, it may be identified that an orphan symbol no longer exists in actual repetition transmitted by the UE.

In the first to sixth embodiments of PUSCH repetition type B of the present disclosure, some or all symbols are determined to be symbols in which no PUSCH is transmitted, in already-obtained nominal repetition or actual repetition. However, in this case, the number of symbols that the UE actually uses for PUSCH transmission is reduced. Therefore, reliability of PUSCH transmission may be reduced. A scheme to solve this is required.

According to a seventh embodiment of PUSCH repetition type B of the present disclosure, the UE may determine nominal repetition in consideration of G symbols. More specifically, in order to determine nominal repetition, the UE is indicated or configured, from a base station, with values of a start symbol index (S) of a first nominal repetition, the number (L) of symbols included in the nominal repetition, and the number (K) of nominal repetitions. The UE obtains a first nominal repetition by combining L symbols starting from a start symbol index (S) of the first nominal repetition. Then, the UE obtains a second nominal repetition by combining L symbols starting from a subsequent symbol. In this way, K nominal repetitions are generated.

If the UE cannot transmit a PUSCH for G symbols between frequency hopping, the UE may determine nominal repetition as follows. The UE obtains a first nominal repetition by combining L symbols starting from a start symbol index (S) of the first nominal repetition. The UE determines G symbols starting from a symbol subsequent to the first nominal repetition, to be symbols in which no PUSCH is transmitted. Then, the UE makes a second nominal repetition by combining L symbols starting from the subsequent symbol. The UE determines G symbols starting from a symbol subsequent to the first nominal repetition, to be symbols in which no PUSCH is transmitted. In this way, K nominal repetitions are generated.

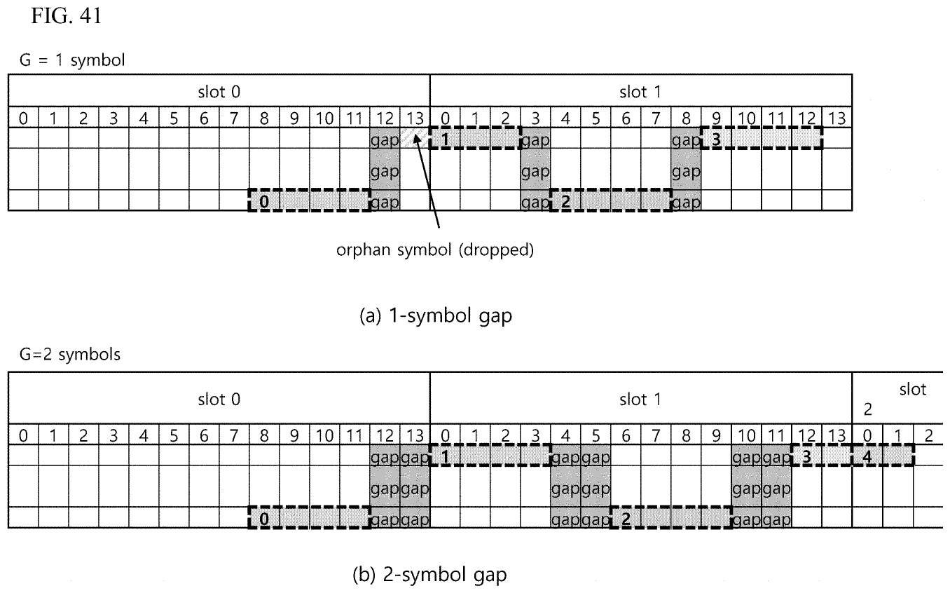

FIG. 41 shows diagrams illustrating adding a gap symbol after nominal repetition in type-B PUSCH repetition according to an embodiment of the present disclosure.

Referring to FIG. 41A, S=8, L=4, K=4, and G=1. A UE obtains a first nominal repetition by combining symbols 8, 9, 10, and 11 of slot 0. The UE determines a subsequent G=1 symbol (symbol 12 of slot 0) to be a symbol in which no PUSCH is transmitted. Then, the UE obtains a second nominal repetition by combining symbol 13 of slot 0 and symbols 0, 1, and 2 of slot 1. The UE determines a subsequent G=1 symbol (symbol 3 of slot 1) to be a symbol in which no PUSCH is transmitted. Then, the UE obtains a third nominal repetition by combining symbols 4, 5, 6, and 7 of slot 1. The UE determines a subsequent G=1 symbol (symbol 8 of slot 1) to be a symbol in which no PUSCH is transmitted. Finally, the UE obtains a fourth nominal repetition by combining symbols 9, 10, 11, and 12 of slot 1. The nominal repetitions obtained in this way may be divided into actual repetitions.

Referring to FIG. 41B, S=8, L=4, K=4, and G=2. The UE generates a first nominal repetition by combining symbols 8, 9, 10, and 11 of slot 0. The UE determines subsequent G=2 symbols (symbols 12 and 13 of slot 0) to be symbols in which no PUSCH is transmitted. Then, the UE obtains a second nominal repetition by combining symbols 0, 1, 2, and 3 of slot 1. The UE determines subsequent G=2 symbols (symbols 4 and 5 of slot 1) to be symbols in which no PUSCH is transmitted. Then, the UE generates a third nominal repetition by combining symbols 6, 7, 8, and 9 of slot 1. The UE determines subsequent G=2 symbols (symbols 10 and 11 of slot 1) to be symbols in which no PUSCH is transmitted. Finally, the UE obtains a fourth nominal repetition by combining symbols 12 and 13 of slot 1 and symbols 0 and 1 of slot 2. The nominal repetitions obtained in this way may be divided into actual repetitions.

In the seventh embodiment of PUSCH repetition type B of the present disclosure, a symbol in which no PUSCH is transmitted is inserted between nominal repetitions. However, some symbols in the nominal repetitions may not be transmitted. For example, invalid UL symbols (a DL symbol, an SSB symbol, a CORESET #0 symbol, and a symbol configured via an RRC signal) are not transmitted. In addition, if there is one consecutive symbol in one slot from among symbols of nominal repetition, the symbol is an orphan symbol so as not to be transmitted. Therefore, a symbol in which no PUSCH is transmitted is not always required to be inserted between nominal repetitions. Hereinafter, an embodiment for solving this problem is disclosed.

In an eighth embodiment of PUSCH repetition type B of the present disclosure, the UE may determine nominal repetition and actual repetition in consideration of G symbols, invalid UL symbols, and orphan symbols. More specifically, if the UE cannot transmit a PUSCH for G symbols between frequency hopping, the UE may determine a first nominal repetition. The UE makes the first nominal repetition by combining L symbols starting from a start symbol index (S) of the first nominal repetition. The UE obtains actual repetition from the first nominal repetition. In addition, the UE determines G symbols subsequent to a last symbol of the actual repetition, to be symbols in which no PUSCH is transmitted. Then, the UE may determine a second nominal repetition by combining L symbols subsequent to the G symbols. The UE obtains actual repetition from the second nominal repetition. The UE determines G symbols subsequent to a last symbol of the obtained actual repetition, to be symbols in which no PUSCH is transmitted. In this way, the UE obtains K nominal repetitions and obtains actual repetition from the K nominal repetitions.

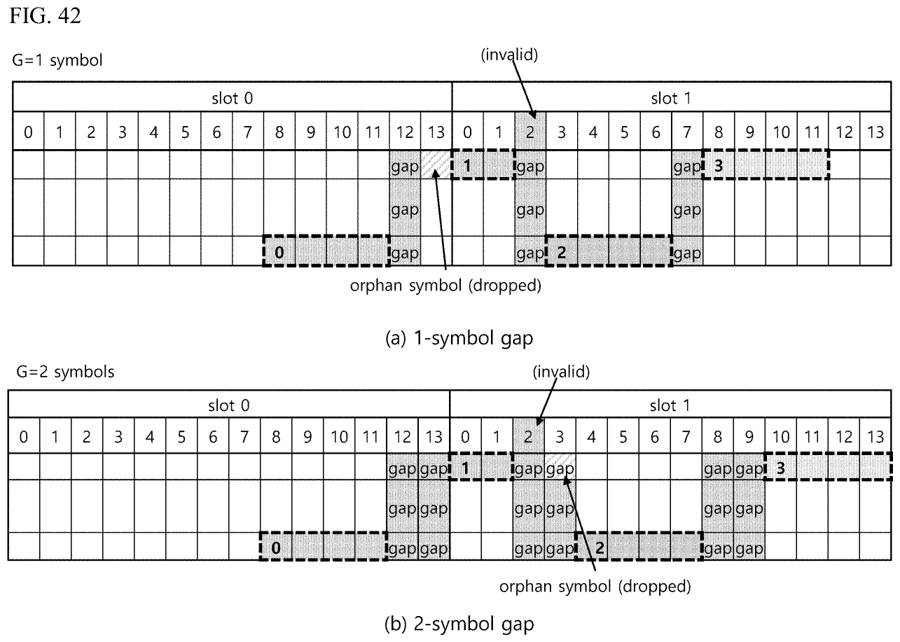

FIG. 42 shows diagrams illustrating a gap symbol in consideration of an invalid UL symbol and an orphan symbol in type-B PUSCH repetition according to an embodiment of the present disclosure.

Referring to FIG. 42A, S=8, L=4, K=4, and G=1. A UE obtains a first nominal repetition by combining symbols 8, 9, 10, and 11 of slot 0. Actual repetition is obtained from the first nominal repetition. This actual repetition includes symbols 8, 9, 10 and 11 of slot 0. The UE determines a subsequent G=1 symbol (symbol 12 of slot 0) to be a symbol in which no PUSCH is transmitted. Then, the UE obtains a second nominal repetition by combining symbol 13 of slot 0 and symbols 0, 1, and 2 of slot 1. Actual repetition is obtained from the second nominal repetition. This actual repetition includes symbols 0 and 1 of slot 1. For reference, symbol 13 of slot 0 is an orphan symbol and is thus excluded from actual repetition, and symbol 2 of slot 1 is an invalid UL symbol and is thus excluded from actual repetition. Therefore, a last symbol of the actual repetition is symbol 1 of slot 1. A G=1 symbol (symbol 2 of slot 1) subsequent to the symbol is determined to be a symbol in which no PUSCH is transmitted. In this way, the UE obtains K=4 nominal repetitions and obtains actual repetition from the K=4 nominal repetitions.

Referring to FIG. 42B, S=8, L=4, K=4, and G=2. The UE obtains a first nominal repetition by combining symbols 8, 9, 10, and 11 of slot 0. Actual repetition is obtained from the first nominal repetition. This actual repetition includes symbols 8, 9, 10 and 11 of slot 0. The UE determines subsequent G=2 symbols (symbols 12 and 13 of slot 0) to be symbols in which no PUSCH is transmitted. Then, the UE obtains a second nominal repetition by combining symbols 0, 1, 2, and 3 of slot 1. Actual repetition is obtained from the second nominal repetition. This actual repetition includes symbols 0 and 1 of slot 1. For reference, symbol 2 of slot 1 is an invalid UL symbol, and is thus excluded from actual repetition. In addition, symbol 3 of slot 1 is an orphan symbol, and is thus excluded from actual repetition. Therefore, a last symbol of the actual repetition is symbol 1 of slot 1. G=2 symbols (symbols 2 and 3 of slot 1) subsequent to the symbol are determined to be symbols in which no PUSCH is transmitted. In this way, the UE obtains K=4 nominal repetitions and obtains actual repetition from the K=4 nominal repetitions.

The above description of the present disclosure has been made by way of example, and those of ordinary skill in the art to which the present disclosure pertains shall understand that the present disclosure may be easily modified into other specific forms without changing the technical spirit or essential features thereof. Therefore, it should be understood that the embodiments described above are illustrative, and are not intended to limit the present disclosure in all respects. For example, each element described in a single form may be implemented in a distributed form, and similarly, elements described in a distributed form may also be implemented in a combined form.

The scope of the present disclosure is indicated by the claims to be described later rather than the detailed description, and all changes or modified forms derived from the meaning and scope of the claims and their equivalent concepts should be interpreted as being included in the scope of the present disclosure.

1-20. (canceled)

21. A user equipment (UE) for use in a 3rd generation partnership project (3GPP)-based wireless communication system, the UE comprising:
a communication module; and
a processor, wherein the processor is configured to:
receive system information block (SIB) including information for cell access, the information being associated with at least:
a first random access channel (RACH) configuration associated with a first uplink bandwidth part (UL BWP) for normal UE, and
a second UL BWP for reduced capability (RedCap) UE; and
transmit a random access (RA) preamble via one of the first and second UL BWPs, based on whether the UE corresponds to the RedCap UE or not,
wherein, if the UE receives a second RACH configuration for the second UL BWP, the second RACH configuration is used for RA preamble transmission in the second UL BWP, and
wherein, if the UE does not receive the second RACH configuration for the second UL BWP, the first RACH configuration for the first UL BWP is used for RA preamble transmission in the second UL BWP.

22. The UE of claim 21, wherein, in association with the RA preamble, a physical downlink control channel (PDCCH) for scheduling a random access response (RAR) is received.

23. The UE of claim 22, wherein, regardless of where the RA preamble is transmitted among the first and second UL BWPs, a same equation is used to obtain a RA-radio network temporary identifier (RA-RNTI) associated with the PDCCH for scheduling the RAR, and
wherein, based on where the RA preamble is transmitted among the first and second UL BWPs, the PDCCH for scheduling the RAR is received via a corresponding one of a plurality of initial DL BWPs.

24. The UE of claim 23, wherein the RA preamble is transmitted on a RACH occasion and, the equation includes:
RA-RNTI=1+s_id+14×t_id+14×80×f_id+14×80×8×ul_carrier_id, where,
s_id represents an index of the first symbol of the RACH occasion,
t_id represents an index of 1^{st} slot of the RACH occasion in a system frame,
f_id represents an index of the RACH occasion in a frequency domain, and
ul_carrier_id represents an UL carrier type where the RA preamble is transmitted.

25. The UE of claim 21, wherein an indicator is further received via the SIB, and the indicator indicates whether the UE is allowed to access the cell or not when the UE is the RedCap UE.

26. A method for use by a user equipment (UE) in a 3^{rd} generation partnership project (3GPP)-based wireless communication system, the method comprising:
receiving system information block (SIB) including information for cell access, the information being associated with at least:
a first random access channel (RACH) configuration associated with a first uplink bandwidth part (UL BWP) for normal UE, and
a second UL BWP for reduced capability (RedCap) UE; and
transmitting a random access (RA) preamble via one of the first and second UL BWPs, based on whether the UE corresponds to the RedCap UE or not,
wherein, if the UE receives a second RACH configuration for the second UL BWP, the second RACH configuration is used for RA preamble transmission in the second UL BWP, and
wherein, if the UE does not receive the second RACH configuration for the second UL BWP, the first RACH configuration for the first UL BWP is used for RA preamble transmission in the second UL BWP.

27. The method of claim 26, wherein, in association with the RA preamble, a physical downlink control channel (PDCCH) for scheduling a random access response (RAR) is received.

28. The method of claim 27, wherein, regardless of where the RA preamble is transmitted among the first and second UL BWPs, a same equation is used to obtain a RA-radio network temporary identifier (RA-RNTI) associated with the PDCCH for scheduling the RAR, and
wherein, based on where the RA preamble is transmitted among the first and second UL BWPs, the PDCCH for scheduling the RAR is received via a corresponding one of a plurality of initial DL BWPs.

29. The method of claim 28, wherein the RA preamble is transmitted on a RACH occasion and, the equation includes:
RA-RNTI=1+s_id+14×t_id+14×80×f_id+14×80×8×ul_carrier_id, where,
s_id represents an index of the first symbol of the RACH occasion,
t_id represents an index of 1^{st} slot of the RACH occasion in a system frame,
f_id represents an index of the RACH occasion in a frequency domain, and
ul_carrier_id represents an UL carrier type where the RA preamble is transmitted.

30. The method of claim 26, wherein an indicator is further received via the SIB, and the indicator indicates whether the UE is allowed to access the cell or not when the UE is the RedCap UE.

31. A base station (BS) for use in a 3^{rd} generation partnership project (3GPP)-based wireless communication system, the BS comprising:
a communication module; and
a processor, wherein the processor is configured to:
transmit system information block (SIB) including information for cell access, the information being associated with at least:
a first random access channel (RACH) configuration associated with a first uplink bandwidth part (UL BWP) for normal UE, and
a second UL BWP for reduced capability (RedCap) UE; and
receive a random access (RA) preamble via one of the first and second UL BWPs,
wherein, if a second RACH configuration for the second UL BWP is broadcast, the second RACH configuration is used for RA preamble reception in the second UL BWP, and
wherein, if the second RACH configuration for the second UL BWP is not broadcast, the first RACH configuration for the first UL BWP is used for RA preamble reception in the second UL BWP.

32. The BS of claim 31, wherein, in association with the RA preamble, a physical downlink control channel (PDCCH) for scheduling a random access response (RAR) is transmitted.

33. The BS of claim 32, wherein, regardless of where the RA preamble is received among the first and second UL BWPs, a same equation is used to obtain a RA-radio network temporary identifier (RA-RNTI) associated with the PDCCH for scheduling the RAR, and
wherein, based on where the RA preamble is received among the first and second UL BWPs, the PDCCH for scheduling the RAR is transmitted via a corresponding one of a plurality of initial DL BWPs.

34. The BS of claim 33, wherein the RA preamble is received on a RACH occasion and, the equation includes:
RA-RNTI=1+s_id+14×t_id+14×80×f_id+14×80×8×ul_carrier_id, where,
s_id represents an index of the first symbol of the RACH occasion,
t_id represents an index of 1^{st} slot of the RACH occasion in a system frame,
f_id represents an index of the RACH occasion in a frequency domain, and
ul_carrier_id represents an UL carrier type where the RA preamble is received.

35. The BS of claim 31, wherein an indicator is further transmitted via the SIB, and the indicator indicates whether a UE is allowed to access the cell or not when the UE is the RedCap UE.

36. A method for use by a base station (BS) in a 3^{rd} generation partnership project (3GPP)-based wireless communication system, the method comprising:
transmitting system information block (SIB) including information for cell access, the information being associated with at least:
a first random access channel (RACH) configuration associated with a first uplink bandwidth part (UL BWP) for normal UE, and
a second UL BWP for reduced capability (RedCap) UE; and
receiving a random access (RA) preamble via one of the first and second UL BWPs,
wherein, if a second RACH configuration for the second UL BWP is broadcast, the second RACH configuration is used for RA preamble reception in the second UL BWP, and
wherein, if the second RACH configuration for the second UL BWP is not broadcast, the first RACH configuration for the first UL BWP is used for RA preamble reception in the second UL BWP.

37. The method of claim 36, wherein, in association with the RA preamble, a physical downlink control channel (PDCCH) for scheduling a random access response (RAR) is transmitted.

38. The method of claim 37, wherein, regardless of where the RA preamble is received among the first and second UL BWPs, a same equation is used to obtain a RA-radio network temporary identifier (RA-RNTI) associated with the PDCCH for scheduling the RAR, and
wherein, based on where the RA preamble is received among the first and second UL BWPs, the PDCCH for scheduling the RAR is transmitted via a corresponding one of a plurality of initial DL BWPs.

39. The method of claim 38, wherein the RA preamble is received on a RACH occasion and, the equation includes:
RA-RNTI=1+s_id+14×t_id+14×80×f_id+14×80×8×ul_carrier_id, where,
s_id represents an index of the first symbol of the RACH occasion,
t_id represents an index of 1^{st} slot of the RACH occasion in a system frame,
f_id represents an index of the RACH occasion in a frequency domain, and
ul_carrier_id represents an UL carrier type where the RA preamble is received.

40. The method of claim 36, wherein an indicator is further transmitted via the SIB, and the indicator indicates whether a UE is allowed to access the cell or not when the UE is the RedCap UE.
